(19) United States
(12) Patent Application Publication
(10) Pub. No.: US 2002/0136405 A1
(43) Pub. Date: Sep. 26, 2002

(54) Data recording device allowing obtaining of license administration information from license region

(75) Inventor: Yoshihiro Hori, Gifu-shi (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co., Ltd., Moriguchi-shi (JP)

(21) Appl. No.: 09/947,547

(22) Filed: Sep. 7, 2001

(30) Foreign Application Priority Data
Mar. 23, 2001 (JP) 2001-085426

(51) Int. Cl. H04L 9/32

(52) U.S. Cl. 380/203

(57) ABSTRACT

A memory includes a license region and a data region. Licenses (license ID, license key Kc, access control information ACm and reproduction time control information ACp) are stored in the license region. The license ID includes a content ID. A license administration file including information other than the license key and others are stored in the data region. When the content ID is externally input, the license including the content ID thus input is read out from the license region, and is externally output via an interface and a terminal. As a result, the license administration information, which can be output from a memory card for display, in the license can be obtained from the license region.

### BACKGROUND OF THE INVENTION

1. Field of the Invention

The present invention relates to a data recording device allowing output of license administration information of encrypted content data obtained by a data distribution system, which can secure a copyright relating to copied information.

2. Description of the Background Art

By virtue of the progress in information communication networks and the like such as the Internet in these few years, each user can now easily access network information through individual-oriented terminals employing a cellular phone or the like.

In such digital information communication network, information is transmitted through digital signals. It is now possible to obtain copied music and video information transmitted via the aforementioned digital information communication network without degradation in the audio quality and picture quality of the copy data, even in the case where an individual user performs the copy.

Thus, there is a possibility of the copyright of the copyright owner being significantly infringed unless some appropriate measures to protect copyrights are taken when any content data subject to copyright protection such as music data and image data is to be transmitted on the digital information communication network.

However, if copyright protection is given top priority so that distribution of content data through the disseminating digital information communication network is suppressed, the copyright owner who can essentially collect a predetermined copyright royalty for copies of a copyrighted work will also incur some disbenefit.

Instead of the distribution over the digital information communication network described above, distribution may be performed via record mediums storing digital data. In connection with the latter case, music data stored in CDs (compact disks) on the market can be freely copied in principle into magneto-optical disks (e.g., MDs) as long as the duplication is only for the personal use. However, a personal user performing digital recording or the like indirectly pays predetermined amounts in prices of the digital recording device itself and the medium as guaranty moneys to a copyright holder.

However, the music data is digital data, which hardly causes deterioration of information when it is copied as digital signals from a CD to an MD. Therefore, for the copyright protection, such structures are employed that the music information cannot be copied as digital data from the recordable MD to another MD.

In view of the above, the public distribution itself of the music data and image data over the digital information communication network is restricted by the public transmission right of the copyright holder, and therefore sufficient measures must be taken for the copyright protection.

For the above case, it is necessary to inhibit unauthorized further duplication of the content data such as copyrighted music data or copyrighted image data, which was once distributed to the public over the digital information communication network.

Such a data distribution system has been proposed that a distribution server holding the encrypted content data distributes the encrypted content data to memory cards attached to terminal devices such as cellular phones via the terminal devices. In this data distribution system, a public encryption key of the memory card, which has been authenticated by an authentication station, and its certificate are sent to the distribution server when requesting the distribution of encrypted content data. After the distribution server determines the reception of the authenticated certificate, the encrypted content data and a license for reproducing the encrypted content data are sent to the memory card. The license includes a license key for decrypting the encrypted content data, content specifying information specifying the encrypted content data, license specifying information specifying the license for decrypting the encrypted content data and control information relating to the access to the license. When distributing the encrypted content data and the license, each of the distribution server and the memory card generate a session key, which is different from those generated in other distribution. The session keys thus generated are exchanged with the public encryption key, and the session keys are commonly used by the distribution server and the memory card.

Finally, the distribution server sends the license, which is encrypted with each public encryption key of the memory card, and is further encrypted with the session key generated by the memory card, as well as the encrypted content data to the memory card. The memory card records the license and the encrypted content data thus received in a memory. The memory card includes a data region and a license region. The encrypted content data is stored in the data region. The license is also stored in the license region. The license region is formed of a tamper resistant module of a high security level. Therefore, the license, which is once stored in the license region, cannot be directly taken out from a portion outside the memory card. Accordingly, the plaintext of content specifying information, license specifying information and control information relating to the access of license are receives from the distribution server, and are stored in the data region so that the information such as content information, license specifying information and restriction information relating to the access of license may be obtained from the outside of the memory card. These informations received from the distribution server are different from the content specifying information, license specifying information and restriction information relating to the access of license within the license region. At the same time, such information is stored that specifies the storage position within the license region, and will be required for reading out the license stored in the license region.

For reproducing the encrypted content data stored in the memory card, the memory card is attached to the cellular phone. The content specifying information, license specifying information and restriction information relating to the access of license, which are stored in the data region in memory of the memory card are read out, the information relating to the access corresponding to the encrypted content data to be reproduced from the content specifying information is referred to. Thereby, it is determined whether the reproduction can be performed or not, and it is decided whether the encrypted content data is to be reproduced or not. When it is decided to reproduce the encrypted content data, the license of the encrypted content data to be reproduced is read out from the license region in accordance with the information specifying the position of storage of the license in the license region. With the license key included in the license thus read, the encrypted content data is decrypted and reproduced.

As described above, the user of the cellular phone can receive the encrypted content data from the distribution server by the cellular phone, and can reproduce the encrypted content data thus received.

However, the content specifying information, license region specifying information, control information relating to the access of license and information relating to the storage position of the license are stored as a file in the data region, and therefore the file thus stored may be broken. If broken, information such as content specifying information and license specifying information cannot be read out from the data region, resulting in the same as that where the license is erased. Accordingly, the encrypted content data cannot be reproduced in spite of the fact that the encrypted content data and the license are stored in the memory card.

### SUMMARY OF THE INVENTION

Accordingly, an object of the invention is to provide a data recording device having a license region storing license administration information, of which output from a memory card and display are permitted, in the license and allowing obtaining of the license administration information from the license region.

According to the invention, a data recording device for recording a license including a license key for decrypting encrypted data and data specifying information for specifying the encrypted data at least, includes a license storing unit subjected to tamper resistant processing disabling direct external access and storing the license; an interface for external transmission; and a control unit, the control unit obtaining the data specifying information and a request for retrieving the license input via the interface, retrieving the license stored in the license storing unit based on the data specifying information, reading out the license including the data specifying information from the license storing unit, selecting unconfidential information with the exception of the license key out of the read license, and externally outputting the selected information via the interface.

Further, according to the invention, a data recording device for recording a license including a license key for decrypting encrypted at least, includes a license storing unit subjected to tamper resistant processing disabling direct external access and storing the license with an entry number; an interface for external transmission; and a control unit, the control unit obtaining an entry number and confirmation demand of the license input via the interface, reading out the license stored in a region designated by the obtained entry number, selecting unconfidential information with exception of the license key out of the read license, and externally outputting the selected information via the interface.

Preferably, the control unit retrieves the license in the license storing unit based on the data specifying information, and externally outputs the entry number corresponding to the region storing the license including the data specifying information when the license including the data specifying information is stored.

Preferably, the control unit retrieves the license in the license storing unit based on the license specifying information, and externally outputs the entry number corresponding to the region storing the license including the license specifying information when the license including the license specifying information is stored.

Further, according to the invention, a data recording device for recording a license including a license key for decrypting encrypted data and license specifying information for specifying the license at least, includes a license storing unit subjected to tamper resistant processing disabling direct external access and storing the license; an interface for external transmission; and a control unit, the control unit obtaining the data specifying information and a request for retrieving the license input via the interface, retrieving the license stored in the license storing unit based on the license specifying information, reading out the license including the license specifying information from the license storing unit, selecting unconfidential information with the exception of the license key out of the read license, and externally outputting the selected information via the interface.

Preferably, the data recording device further includes a data storing unit for storing license administration information including the encrypted data and the data specifying information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a concept of a data distribution system;

FIG. 2 is a schematic view showing a concept of another data distribution system;

FIG. 3 shows characteristics of data, information and others for communication in the data distribution systems shown in FIGS. 1 and 2;

FIG. 4 shows characteristics of data, information and others for communication in the data distribution systems shown in FIGS. 1 and 2;

FIG. 5 is a schematic block diagram showing a structure of a distribution server in the data distribution systems shown in FIGS. 1 and 2;

FIG. 6 is a schematic block diagram showing a structure of a personal computer in the data distribution systems shown in FIGS. 1 and 2;

FIG. 7 is a schematic block diagram showing a structure of a reproduction terminal in the data distribution system shown in FIG. 2;

FIG. 8 is a schematic block diagram showing a structure of a memory card in the data distribution systems shown in FIGS. 1 and 2;

FIG. 9 is a schematic block diagram showing a structure of a license administration device arranged in a personal computer shown in FIG. 6;

FIGS. 10-13 are first to fourth flowcharts showing a distribution operation of a high security level in the data distribution system shown in FIGS. 1 and 2, respectively;

FIGS. 14-17 are first to fourth flowcharts showing the distribution operation of a low security level in the data distribution system shown in FIGS. 1 and 2, respectively;

FIG. 18 is a function block diagram showing a function of software executing ripping;

FIG. 19 is a flowchart showing the ripping operation in the data distribution system shown in FIGS. 1 and 2;

FIGS. 20-23 are first to fourth flowcharts showing a transfer operation for the license of the encrypted content data in the data distribution systems shown in FIGS. 1 and 2, respectively;

FIGS. 24-27 are first to fourth flowcharts showing a check-out operation for the license of the encrypted content data in the data distribution systems shown in FIGS. 1 and 2, respectively;

FIGS. 28-30 are first to third flowcharts showing a check-in operation for the license of the encrypted content data in the data distribution systems shown in FIGS. 1 and 2, respectively;

FIG. 31 shows a structure of a content list file on a hard disk of a personal computer;

FIG. 32 shows a structure of a reproduction list file in a memory card;

FIG. 33 is a flowchart showing an initialization processing of the reproduction operation in a cellular phone;

FIG. 34 is a flowchart showing a reproduction processing of the reproduction operation in the cellular phone;

FIG. 35 is a flowchart showing a license retrieval processing in the cellular phone;

FIG. 36 is a flowchart showing another license retrieval processing in the cellular phone; and

FIG. 37 is a flowchart showing a license confirmation processing in the cellular phone.

### DESCRIPTION OF THE PREFERRED EMBODIMENTS

Embodiments of the invention will now be described with reference to the drawings. The same or similar parts or portions bear the same reference numbers in the figures, and description thereof will not be repeated.

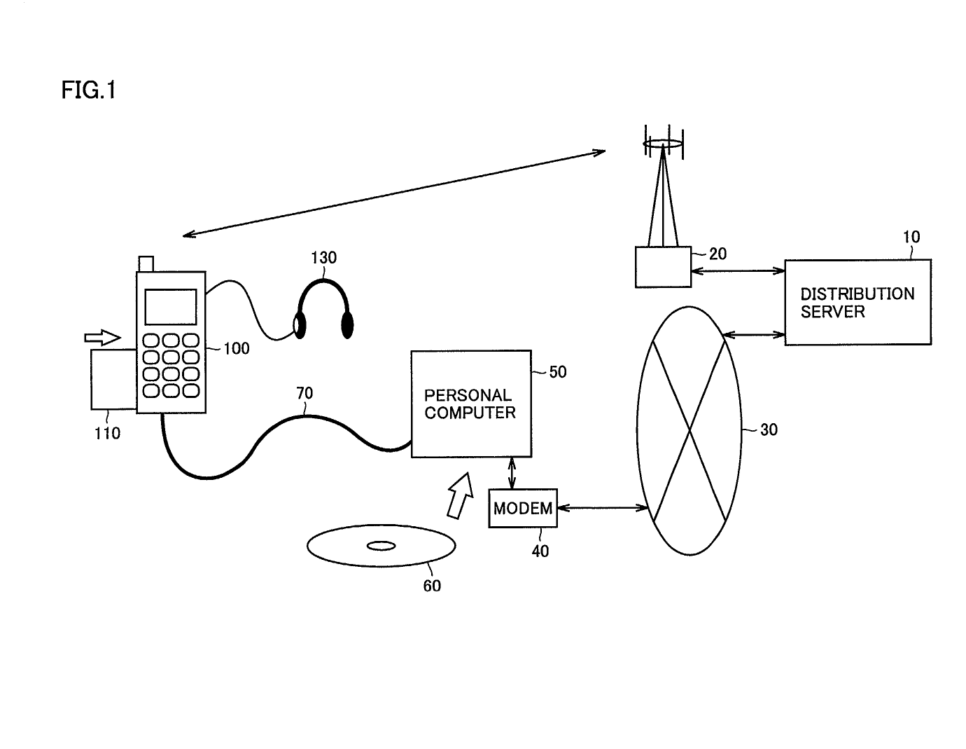

FIG. 1 is a schematic diagram showing a concept of a whole structure of a data distribution system, from which encrypted content data is obtained by a data receiving device (memory card) according to the invention.

Description will now be given by way of example on a data distribution system distributing digital music data to a memory card 110 of each user via a cellular phone network will be described as an example, and a data distribution system distributing digital music data to personal computers on the internet. However, as will become apparent from the following description, the present invention is not limited to such a case. The present invention is applicable to the distribution of other copyrighted materials, i.e., content data such as video data, image data, text data and programs, and further applicable.

Referring to FIG. 1, a distribution carrier 20 relays a distribution request, which is sent from a user over a cellular phone network, to a distribution server 10. Distribution server 10, which administers the copyrighted music data, determines whether memory card 110 on cellular phone 100 of the user requesting the data distribution has proper or legal authentication data or not, and thus whether memory card 110 is a legal memory card or not. If legal, the music data, which will be referred to also as “content data” hereinafter, will be distributed to the legal memory card by distribution carrier 20, i.e., the cellular phone company after being encrypted in a predetermined encryption manner. For this distribution, distribution carrier 20 is supplied from distribution server 10 with the encrypted content data as well as a license including a license key for decrypting the encrypted content data as information, which is required for reproducing the encrypted content data.

Distribution carrier 20 sends the encrypted content data and the license via the cellular phone network and cellular phone 100 to memory card 110 attached to cellular phone 100, which sent the distribution request over its own cellular phone network.

In FIG. 1, memory card 110 is releasably attached to cellular phone 100 of the user. Memory card 110 receives the encrypted content data received by cellular phone 100, applies decryption on the above encryption, and then provides the decrypted data to content reproducing circuit (not shown) in cellular phone 100.

The cellular phone user, for example, can “reproduce” the content data to listen to the music via a headphone 130 or the like connected to cellular phone 100.

By such a structure, any user cannot receive the distribution data from distribution server 10 for reproducing the music without memory card 110.

By taking count of the number of times content data of, for example, one song, is distributed in distribution carrier 20, the copyright royalty fee induced every time a user receives (downloads) content data distribution can be collected by distribution carrier 20 in the form of telephone bills of respective cellular phones. Thus, the royalty fee of the copyright owner can be ensured.

In FIG. 1, distribution server 10 receives over internet network 30 and modem 40 the distribution request from the user of personal computer 50. Thereby, distribution server 10 determines whether personal computer 50 accessing thereto for data distribution uses software provided with the license administration module having proper authentication data or not, and thus whether the legal license administration module is used or not. If the proper license administration module is used, the personal computer is supplied over internet network 30 and model 40 with the encrypted content data, which is prepared by encrypting music data in a predetermined manner, as well as the license. The license administration module of personal computer 50 records the received encrypted content data on a hard disk (HDD) or the like as it is, and also records the received license on the HDD after encrypting it for protection.

Personal computer 50 includes a license administration device (hardware) having the same function as that of memory card 110 relating to the license administration, and thereby can receive the distribution instead of cellular phone 100 equipped with memory card 110. Personal computer 50 receives the encrypted content data and the license from distribution server 10 via modem 40 and over internet network 30. In this operation, the license is directly received by the license administration device for recording from distribution server 10 over an encryption communication path in accordance with a predetermined procedure. The encrypted content data is recorded on the HDD, as it is. The license administration module keeps the security in transmission and administration of the license by hardware, as is also done by memory card 110, and therefore can provide a higher security level than that license administration module holding the security by software. For clearly expressing the security level and license, the level of security, which is kept by hardware such as memory card 110 or a license administration device, will be referred to as a “level 2”, and the license, which requires the security at level 2 when distributed, will be referred to as a “level-2 license”. Likewise, the level of security, which is kept by software such as a license administration module, will be referred to as a “level 1”, and the license, which requires the security at level 1 when distributed, will be referred to as a “level-1 license”. The license administration device and the license administration module will be described later in greater detail.

In FIG. 1, personal computer 50 uses the license administration module to generate the encrypted content data, which is restricted to local use, from the music data obtained from a music CD (Compact Disk) 60 storing the music data as well as a license for reproducing the encrypted content data. This processing is referred to as “ripping”, and corresponds to an operation of obtaining the encrypted content data and the license. The license for local us obtained by the ripping does not provide a high security level due to its nature, and therefore is handled as the level-1 license regardless of the manner of ripping. The ripping will be described later in greater detail.

Further, personal computer 50 is coupled to cellular phone 100 via a USB (Universal Serial Bus) cable 70, and can transmits the encrypted content data and the license to and from memory card 110 on cellular phone 100. However, the security levels of license are handled in different manners, as will be described later in greater detail.

In FIG. 1, personal computer 50 may further has a function of reproducing only the encrypted content data, which has the level-1 license and is directly administered by the license administration module, by using the license administration module. The encrypted content data having the level-2 license can be reproduced by a personal computer, which is provided with a content reproducing circuit ensuring the security by hardware. The specific manner of reproduction by the personal computer will not be described for simplicity reason.

In the data distribution system shown in FIG. 1, personal computer 50 receives the encrypted content data and the license via modem 40 and over internet network 30 from distribution server 10, and also generates the encrypted content data and the license from music data of music CD 60. Memory card 110 attached to cellular phone 100 receives the encrypted content data and the license over the cellular phone network from distribution server 10, and also receives the encrypted content data and the license over the USB cable 70 from personal computer 50.

Memory card 110 attached to cellular phone 100 can save the encrypted content data and the license, which are received from distribution server 10 over the cellular phone network, in personal computer 50.

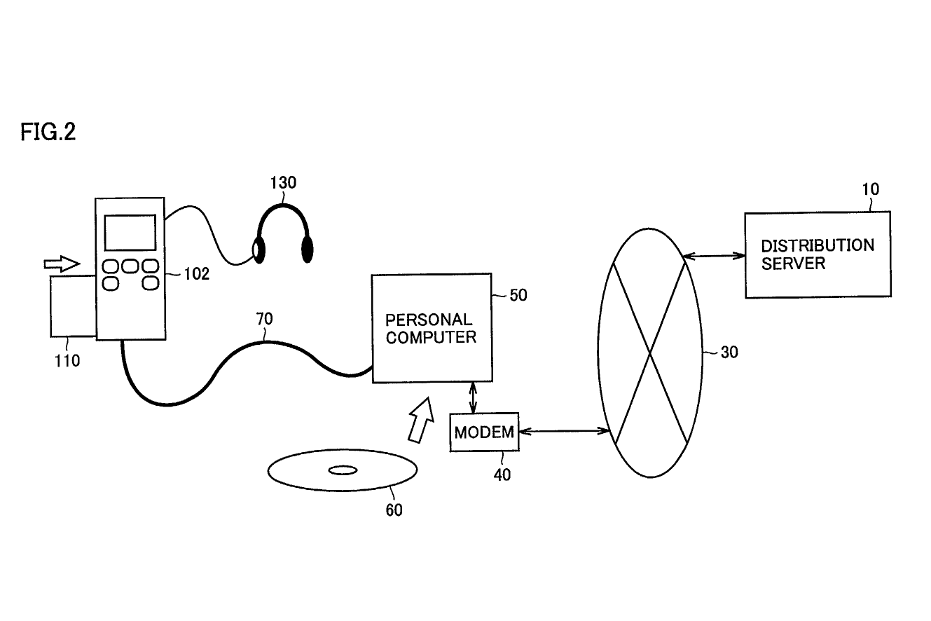

FIG. 2 shows a data distribution system using a reproduction terminal 102, which does not have a function of receiving the encrypted content data and the license from distribution server 10 over the cellular phone network. In the data distribution system shown in FIG. 2, memory card 110 attached to reproduction terminal 102 receives the encrypted content data and the license, which are obtained from distribution server 10 or music CD 60 by personal computer 50. Since personal computer 50 obtains the encrypted content data and the license, even the user of reproduction terminal 102 not having a communication function can receive the encrypted content data.

In the structures shown in FIGS. 1 and 2, the system requires several manners or the like for allowing reproduction of the content data, which is distributed in the encrypted form, on the user side of the cellular phone or the personal computer. First, it requires a manner for distributing the encryption key in a communication system. Second, the manner of encrypting the content data to be distributed is required. Third, it is required to employ the manner or structure of protecting the content data for inhibiting unauthorized copy of the distributed content data.

Embodiments of the invention, which will now be described, particularly relate to structures for enhancing the ability to protect the copyright of the content data in such a manner that can enhance functions for authentication and check of a receiver or a destination of the content data at the time of generation of each of the distribution session and reproduction session, and can prevent from outputting the content data to an unauthenticated record device or data reproduction terminal (the data reproduction terminal capable of content reproduction may also be referred to as the “cellular phone” or “personal computer” hereinafter) as well as the record device or data reproduction terminal, in which the decryption key is broken.

In the following description, transmission of the content data from distribution server 10 to various cellular phones, personal computers and others will be referred to as “distribution” hereinafter.

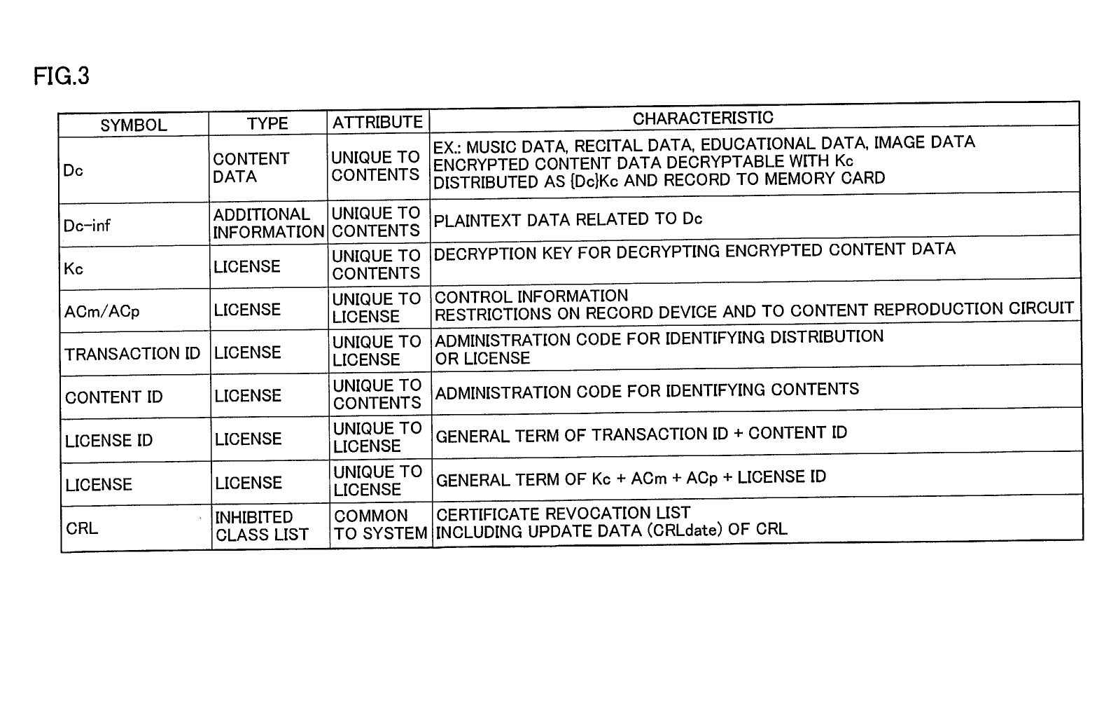

FIG. 3 shows characteristics of data, information and others used for communication in the data distribution systems shown in FIGS. 1 and 2.

First, data distributed from distribution server 10 will be described. Dc indicates the content data such as music data. Content data Dc is encrypted and can be decrypted with a license key Kc. Encrypted content data {Dc}Kc, which can be decrypted with license key Kc, is distributed by distribution server 10 to users of the cellular phones or personal computers while keeping this format.

In the following description, the expression “{Y}X” represents that data Y is encrypted to allow decryption with decryption key X.

Together with the encrypted content data, distribution server 10 distributes additional information Dc-inf, which is plaintext information relating, e.g., to copyright of the content data or access to server. As licenses, license key Kc as well as a transaction ID, which is an administration code for specifying the distribution of the license. The transaction ID is used also for specifying the license which is not distributed, namely, the license generated for the purpose of local use. For distinguishing between the license to be distributed license and that for local use, the transaction ID bear “0” at its leading end for indicating the local use. The transaction ID bearing the number other than “0” at its leading end is used by distribution. The licenses further include a content ID, which is a code for identifying content data Dc, as well as an access control information ACm, which is information relating to restriction on access to the license in the receiving device (memory card or license administration module), reproduction control information ACp, which is control information for reproduction in the data reproduction terminal. More specifically, access control information ACm is the control information for externally outputting the license or license key from the memory card, the license administration module or the license administration device, and includes an allowed reproduction number (the number of times of license key output for reproduction), restriction information relating to the transfer and duplication of the licenses, and the security level of license. Reproduction control information ACp is used for restricting reproduction after the content reproducing circuit receives the encrypted content data for reproduction, and relates to the reproduction time limit, reproduction speed change restriction, reproduction range designation (partial license) and others.

In the following description, the transaction ID and the content ID will be collectively referred to as the license ID, and license key Kc, license ID, access control information ACm and reproduction control information ACp will be collectively referred to as the license.

In the following description, access control information ACm restricts, for simplicity reason, only the two items, i.e., the number of reproduction times (0: no reproduction, 1-254: allowed reproduction number, 255: no limit), which is the control information for restricting the reproduction time(s), and the transfer/duplication flag (0: transfer/duplication are inhibited, 1: only transfer is allowed, 2: transfer/duplication are allowed), which can restrict the transfer and duplication of the license. For the same reason, reproduction control information ACp restricts only the reproduction period (UTC time code), which is the control information specifying the period allowing reproduction.

In the embodiments, a certificate revocation list CRL is operated so that the distribution and reproduction of the content data can be inhibited for each of the classes of the record devices (memory cards or license administration device) or the license administration program (license administration module) or the content reproduction circuit (cellular phones reproducing the content data). In the following description, the symbol CRL may represent the data in the certificate revocation list, if necessary.

The information relating to the certificate revocation list includes certificate revocation data CRL including a list of classes of the recording device, the license administration program and the content reproduction circuit, which are inhibited from the license distribution and the reproduction. This list includes all the devices and programs for performing the administration and storage of the licenses relating to protection of the content data as well as the reproduction.

Certificate revocation list data CRL is administered in distribution server 10. Further, certificate revocation list data CRL is administered and held in the memory card or the license administration device. The certificate revocation list must be updated at appropriate times for updating the data. For the change in data, distribution server 10 determines the date/time of update of the certificate revocation list received from the cellular phone (memory card) or the personal computer (license administration device or license administration module) when distributing the content data and/or the license such as a license key. When it is determined that the date/time of the received certificate revocation list are not updated in view of those in the certificate revocation list CRL held thereby, the latest certificate revocation list is distributed to cellular phone 100 or personal computer 50. For changing the certificate revocation list, such a structure may be employed that CRL, which is differential data reflecting only the change, is generated on the distribution server side, and the change is added to certificate revocation list CRL in the memory card or the license administration device in accordance with the differential data thus generated. Update date/time CRLdate is also recorded in certificate revocation list CRL administered in memory card 110 or the license administration device at the time of updating.

As described above, certificate revocation list CRL is held and operated not only in the distribution server but also in the recording devices (memory card or license administration device) or the license administration program license administration module), which records and administers the license. Thereby, in the case of reproduction as well as the transfer, duplication and check-out of the license, supply of the license key or license to the content reproducing circuit (cellular phone and reproduction terminal), the license administration device or the license administration module operating on the personal computer is inhibited when the decryption key unique to the class, i.e., the decryption key unique to the kind of the content reproducing circuit (cellular phone and reproduction terminal), the recording device or the license administration program is broken. Therefore, the cellular phone and the personal computer cannot reproduce the content data. And, the reproduction terminal, the memory card, the license administration device and the license administration module cannot obtain the license newly.

As described above, certificate revocation list CRL stored in memory card 110 or the license administration device, or certificate revocation list CRL administered by the license administration module is configured to update the data in response to distribution. Administration of certificate revocation list CRL in memory card 110 or the license administration device is recorded independently of the higher level in an tamper resistant module at a high level ensuring security in hardware. Administration of certificate revocation list CRL in the license administration module is recorded on the HDD or the like of personal computer 50, which is protected at least against tampering by the encryption. In other words, it is recorded by the tamper resistant module keeping the security by tamper resistant module of software. Therefore, it is impossible to tamper certificate revocation list CRL from the higher level such as a file system, application program or the like. As a result, the protection of copyright of the data can be enhanced.

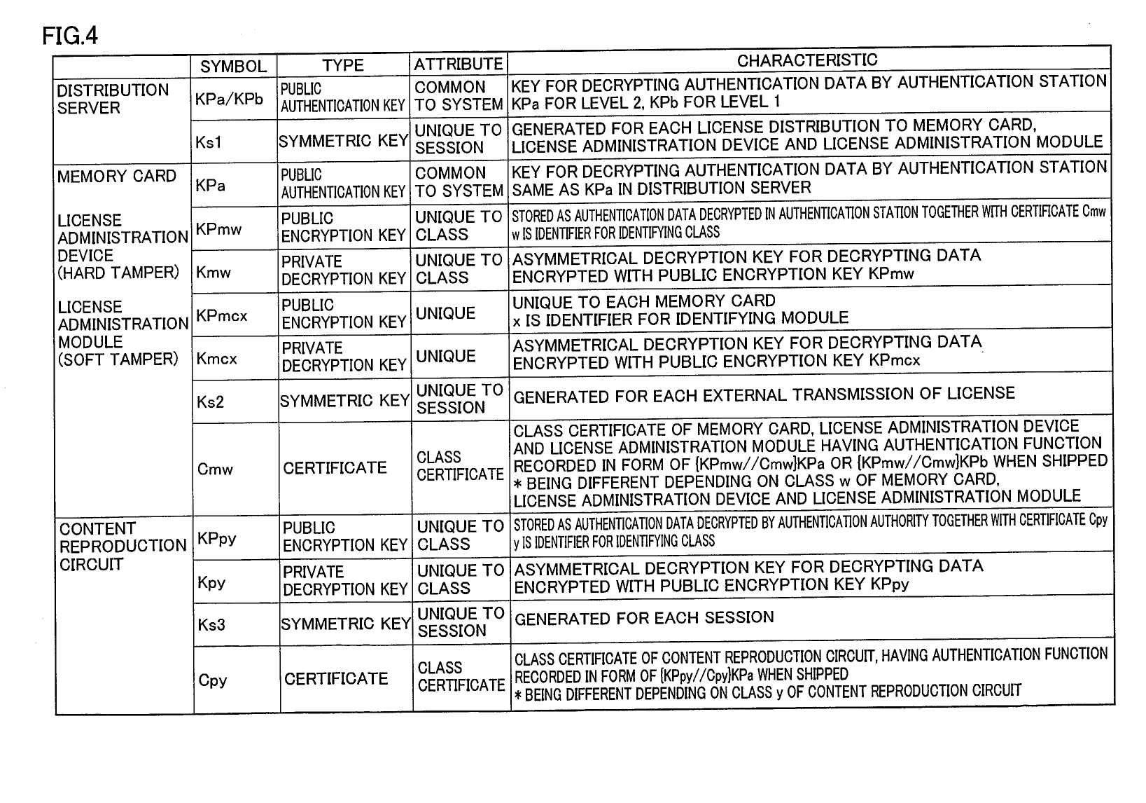

FIG. 4 shows characteristics of data, information and others for authentication, which are used in the data distribution systems shown in FIGS. 1 and 2.

Each of the content reproducing circuit, memory card, license administration device and license administration module is provided with a unique public encryption keys KPpy and KPmw. Public encryption key KPpy can be decrypted with a private decryption key Kpy unique to the content reproducing circuit. Public encryption key KPmw can be decrypted with a private decryption key Kmw unique to the memory card, license administration device and license administration module. These public encryption key and private decryption key have values, which depend on the types of the content reproducing circuit, memory card, license administration device and license administration module. These public encryption key and private decryption key are collectively referred to as class keys. The public encryption key and the private decryption key are referred to as the class public encryption key and the class private decryption key, respectively. The unit, in which the class key is commonly used, is referred to as the class. The class depends on a manufacturer, a kind of the product, a production lot and others.

Cpy is employed as a class certificate of the content reproduction circuit (cellular phone or reproduction terminal). Cmw is employed as a class certificate of the memory card, license administration device and license administration module. These class certificates have information depending on the classes of the content reproduction circuit, memory card, license administration device and license administration module. The tamper resistant module may be broken, or the encryption by the class key may be broken. The class, in which the private decryption key is divulged in this manner, is listed up in the certificate revocation list, and is handled as the object or target, for which license obtaining is inhibited.

The class public encryption key and the class certificate of the content reproducing circuit are recorded as the authentication date {KPpy//Cpy}KPa in the data reproduction circuit at the time of shipment. The class public encryption key and the class certificate of the memory card and the license administration device are recorded as the authentication date {KPmw//Cmw}KPa in the memory card or the license administration device at the time of shipment. The class public encryption key and the class certificate of the license administration module are recorded as the authentication date {KPmw//Cmw}KPb in the license administration module at the time of shipment. As will be described later, KPa and KPb are public authentication keys, which are common to the whole distribution system. KPa is used when the security level is level 2 for tamper resistant module in hardware. KPb is used when the security level is level 1 for tamper resistant module in software.

The keys for administering data processing in memory card 110, license administration device and license administration module and the license administration module include public encryption key KPmcx, which is set for each of the recording devices and administration program such as a memory card, license administration device and license administration module, and also include private decryption key Kmcx, which is independent of the others and allows decryption of data encrypted with public encryption key KPcmx. The public encryption key and the private decryption key, which are unique to each recording device or license administration program, will be collectively referred to as “unique keys”, public encryption key KPmcx will be referred to as a “unique public encryption key” and private decryption key Kmcx will be referred to as a “unique private decryption key”.

As encryption keys for security, symmetric keys Ks1-Ks3 are used. These symmetric keys are generated in distribution server 10, cellular phone 100, memory card 110, license administration device and license administration module every time the content data is distributed or reproduced.

Symmetric keys Ks1-Ks3 are unique symmetric keys, which are generated for each “session”, which is the unit of access or communication between the distribution server and the content reproducing circuit, memory card 110, license administration device or license administration module. These symmetric keys Ks1-Ks3 will be referred to as “session keys”, hereinafter.

These session keys Ks1-Ks3 have values unique to each session, and are administered by distribution server 10, content reproduction circuit, memory card 110, license administration device and license administration module. More specifically, session key Ks1 is generated by distribution server 10. Session key Ks2 is generated by memory card 110, the license administration device and the license administration module. Session key Ks3 is generated in the content reproduction circuit. The level of security can be improved in each session by transferring these session keys and receiving the session key generated by another apparatus to perform encryption using the session keys and transmitting the license key and others.

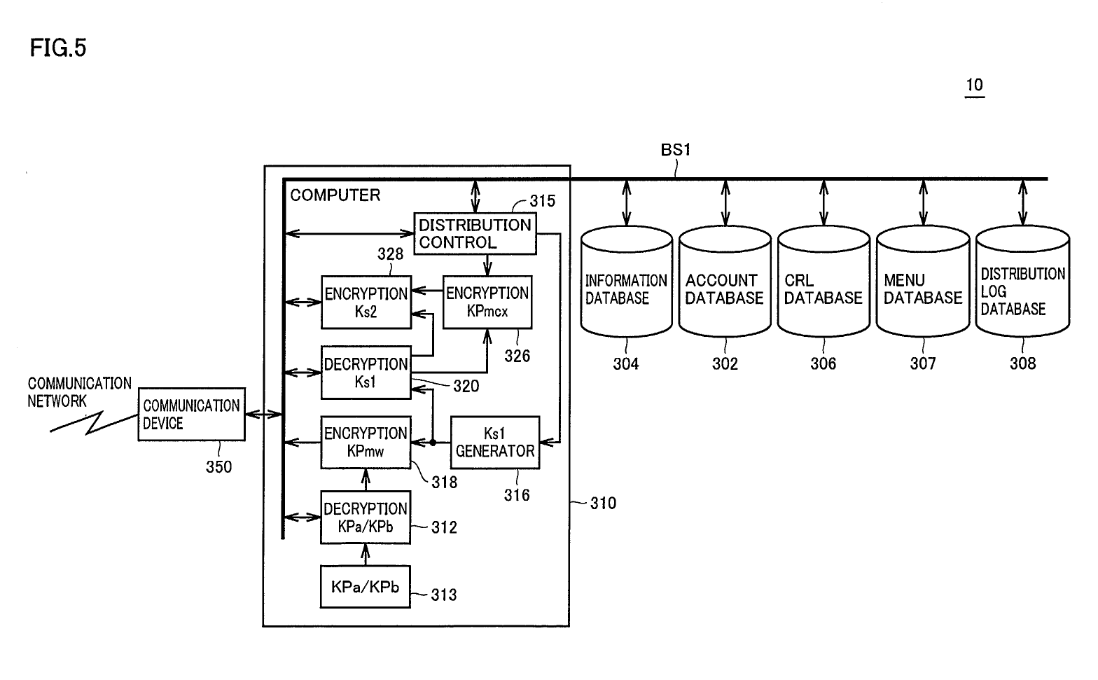

FIG. 5 is a schematic block diagram showing a structure of distribution server 10 shown in FIGS. 1 and 2.

Distribution server 10 includes an information database 304 for storing content data encrypted according to a predetermined scheme as well as distribution data such as a content ID, an account database 302 for storing accounting information according to the start of access to content data for each of the users of the cellular phones and personal computers, a CRL database 306 for administering certificate revocation lists CRL, a menu database 307 for holding the menu of content data held in information database 304, a distribution log database 308 for holding a log relating to distribution of the transaction ID and others specifying the distribution of the content data, license key and others for each distribution of the license, a data processing unit 310 for receiving data via a bus BS1 from information database 304, account database 302, CRL database 306, menu database 307 and distribution log database 308, and performing predetermined processing, and a communication device 350 for transmitting/receiving data between distribution carrier 20 and data processing unit 310 over the communication network.

Data processing unit 310 includes a distribution control unit 315 for controlling an operation of data processing unit 310 in accordance with the data on bus BS1, a session key generator 316 which is controlled by distribution control unit 315 to generate session key Ks1 in the distribution session, an authentication key holding unit 313 holding two kinds of public authentication keys KPa and KPb for decrypting authentication data {KPmw//Cmw}KPa or {KPmw//Cmw}KPb sent for authentication from the memory card or the license administration module, a decryption processing unit 312 which receives authentication data {KPmw//Cmw}KPa or {KPmw//Cmw}KPb sent for authentication from memory card 110, license administration device or license administration module via communication device 350 and bus BS1, and decrypts it with public authentication key KPa or KPb output from authentication key hold unit 313, an encryption processing unit 318 which encrypts session key Ks1 generated by a session key generator 316 with class public encryption key KPmw obtained by decryption processing unit 312, and outputting it onto bus BS1, and a decryption processing unit 320 for receiving and decrypting the data encrypted with session key Ks1.

Data processing unit 310 further includes an encryption processing unit 326 for encrypting license key Kc and access control information ACm, which are obtained from distribution control unit 315, with unique public encryption key KPmcx, which is obtained by decryption processing unit 320 and is unique to each of memory card 110, the license administration module and the license administration module, as well as an encryption processing unit 328 for further encrypting the output of encryption processing unit 326 with a session key Ks2 applied from decryption processing unit 320, and outputting it onto bus BS1.

Operations in the distribution session of distribution server 10 will be described later in greater detail with reference to flowcharts.

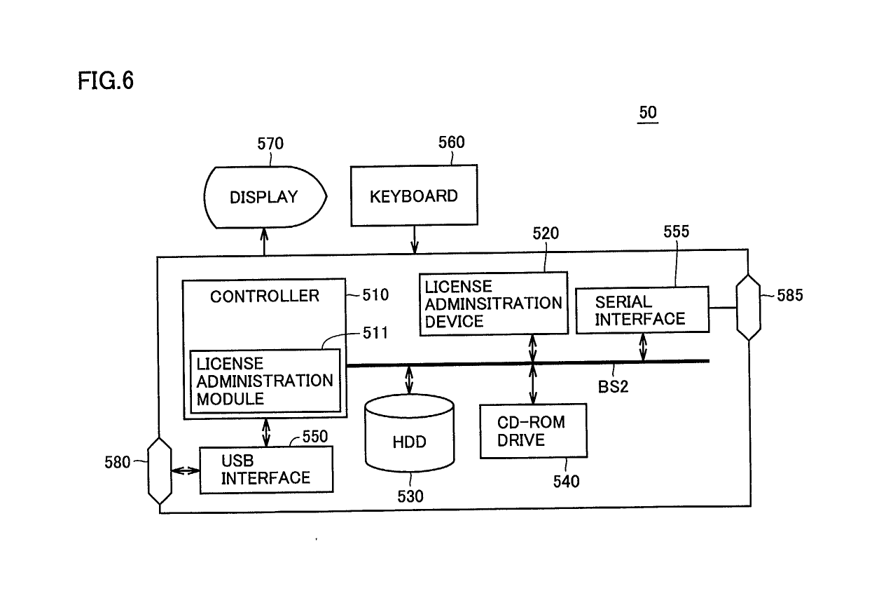

FIG. 6 is a schematic block diagram showing a structure of personal computer 50 shown in FIGS. 1 and 2. Personal computer 50 includes a bus BS2 for data transmission to and from various portions in personal computer 50 and a controller (CPU) 510 for internally controlling the personal computer and executing various programs. Personal computer 50 also includes a hard disk (HDD) 530 and a CD-ROM drive 540, which are large-capacity storage devices connected to bus BS2 for recording and/or storing programs and/or data, as well as a keyboard 560 for entering user's instructions and a display 570 for visually showing various kinds of information to users.

Personal computer 50 further includes a USB interface 550 for controlling transmission of data between controller 510 and a terminal 580 during transmission of the encrypted content data and the license to or from cellular phone 100 or the like, terminal 580 for connecting USB cable 70, a serial interface 555 for controlling data transmission between controller 510 and a terminal 585 during communication of distribution server 10 over internet network 30 and modem 40, and terminal 585 for connection to modem 40 via a cable.

Controller 510 performs the control for sending the encrypted content data and others from distribution server 10 to license administration device 520 or license administration module 511 over internet network 30, and more specifically controls the transmission of data to and from distribution server 10. Also, controller 510 performs the control when the encrypted content data and the license are to be generated by ripping from a music CD 60 via CD-ROM drive 540. Further, personal computer 50 includes license administration device 520, for administering by hardware the licenses used for transmitting various keys to and from distribution server 10 when the encrypted content data and the license are to be received from distribution server 10, and reproducing the distributed encrypted content data as well as license administration module 511, which is a program to be executed by controller 510 for receiving distribution of the encrypted content data and the level-1 license from distribution server 10, and generating a dedicated license by uniquely encrypting the received license.

License administration device 520 transmits the data by hardware when receiving the encrypted content data and the license from distribution server 10, and administers the received license by hardware. Therefore, license administration device 520 can handle the level-2 license requiring a high security level. License administration module 511 transmits the data for receiving the encrypted content data and the license from distribution server 10, and more specifically performs this data transmission by software using a program executed by controller 510. Also, license administration module 511 generates the encrypted content data and the license for local use by ripping from music CD 60. License administration module 511 stores and administers the license thus generated on HDD 530 after protecting it by encryption. Therefore, license administration module 511 handles only the level-1 license, of which security level is lower than license administration device 520. Naturally, the device and others capable of handling the license at the security level 2 can also handle the license at security level 1.

As described above, personal computer 50 is internally provided with license administration module 511 and license administration device 520 for receiving the encrypted content data and the license from distribution server 10 over internet network 30, and CD-ROM drive 540 for obtaining the music data from music CD 60 for ripping.

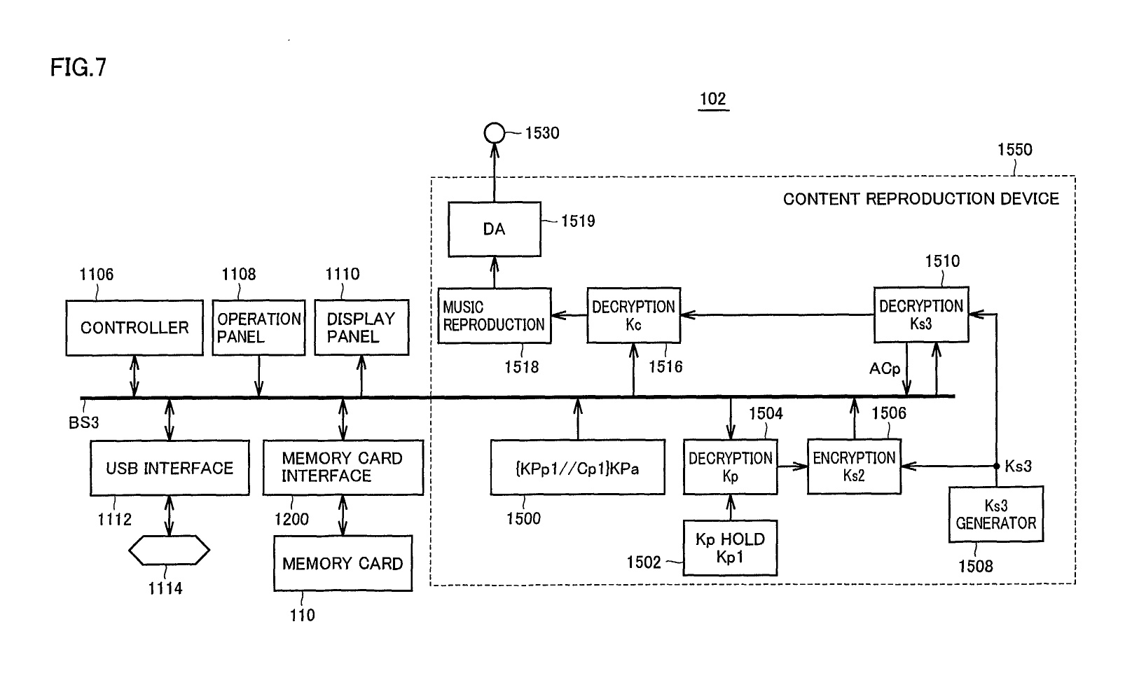

FIG. 7 is a schematic block diagram showing a structure of reproduction terminal 102 shown in FIG. 2.

Reproduction terminal 102 includes a bus BS3 for data transmission to various portions in reproduction terminal 102, a controller 1106 for controlling the operation of reproduction terminal 102 via bus BS3, an operation panel 1108 for externally applying instructions to reproduction terminal 102 and a display panel 1110 for displaying information sent from controller 1106 and others to the user.

Reproduction terminal 102 further includes removable memory card 110 for storing and decrypting the content data (music data) sent from distribution server 10, a memory card interface 1200 for controlling transmission of data between memory card 110 and bus BS3, a USB interface 1112 for controlling data transmission between bus BS3 and a terminal 1114 when receiving the encrypted content data and the license from personal computer 50, and terminal 1114 for connecting USB cable 70.

Reproduction terminal 102 further includes an authentication data hold unit 1500 for holding authentication data {KPp1//Cp1}KPa encrypted into a state, which can authenticates the validity by class public encryption key KPp1 and class certificate Cp1 obtained by decryption with public authentication key KPa. The class y of reproduction terminal 102 is equal to 1 (y=1).

Reproduction terminal 102 further includes a Kp hold unit 1502 for holding Kp1, which is a decryption key unique to the class, and a decryption processing unit 1504, which decrypts the data received from bus BS3 with decryption key Kp1 to obtain session key Ks2 generated by memory card 110.

Reproduction terminal 102 further includes a session key generator 1508 for generating a session key Ks3, e.g., based on a random number for encrypting the data on bus BS3 to be transmitted to and from memory card 110 in the reproduction session, which is performed for reproducing the content data stored in memory card 110, and an encryption processing unit 1506, which encrypts session key Ks3 with session key Ks2 obtained by decryption processing unit 1504, and outputs it onto bus BS3 when receiving license key Kc and reproduction control information ACp from memory card 110 in the reproduction session of the encrypted content data.

Reproduction terminal 102 further includes decryption processing unit 1510 which decrypts the data on bus BS3 with session key Ks3 to output license key Kc and reproduction control information ACp, a decryption processing unit 1516 which receives encrypted content data {Dc}Kc from bus BS3, and decrypts it with license key Kc obtained from decryption processing unit 1510 for outputting the content data, a music reproduction unit 1518 which receives and reproduces the content data sent from decryption processing unit 1516, a D/A converter 1519 which converts digital signals sent from the output of music reproduction unit 1518 into analog signals and a terminal 1530 for outputting the output of D/A converter 1519 to an external output device (not shown) such as headphones.

In FIG. 7, a region surrounded by dotted line provides a content reproduction circuit 1550 for reproducing the music data by decrypting the encrypted content data.

Cellular phone 100 shown in FIG. 1 has a function of receiving distribution of the encrypted content data or the license from distribution server 10 over the cellular phone network. Accordingly, the structure of cellular phone 100 shown in FIG. 1 corresponds to the structure shown in FIG. 7. However, the structure of cellular phone 100 additionally has ordinary structures as the cellular phone such as an antenna for receiving radio signals sent over the cellular phone network, a transmission unit for converting the signals received from the antenna into baseband signals, and sending data sent from the cellular phone to the antenna after modulating it, a microphone, a speaker and an audio encoder-decoder.

Operations in respective sessions of the respective components of cellular phone 100 and reproduction terminal 102 will be described later in greater detail with reference to flowcharts.

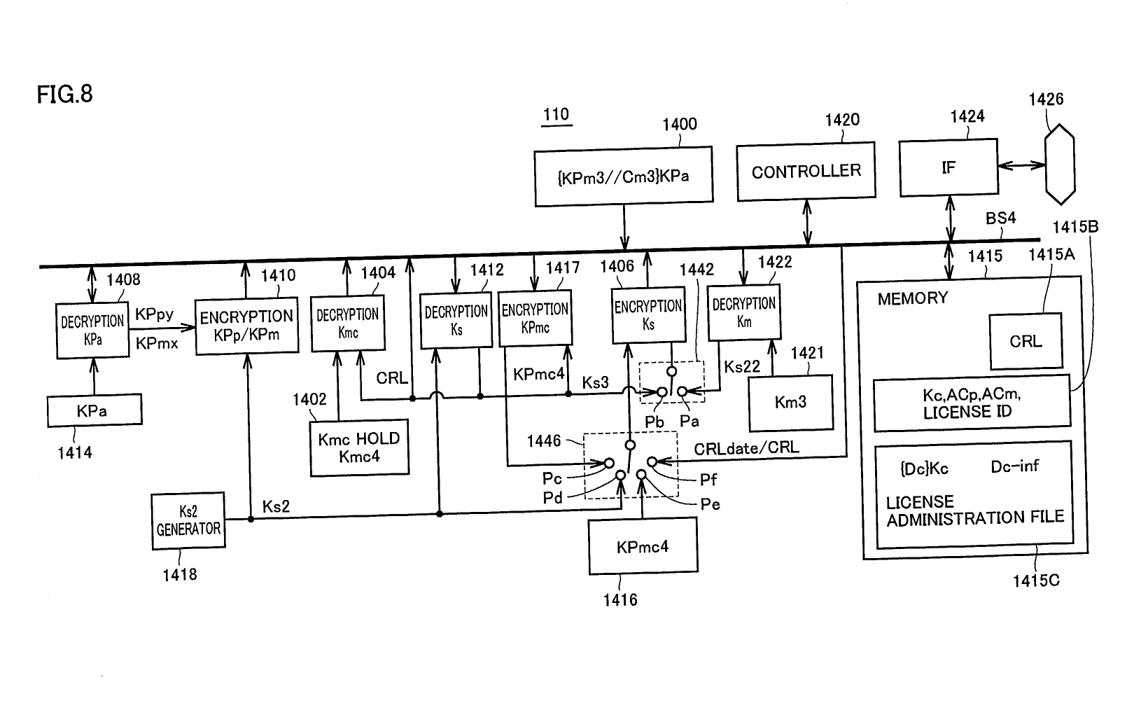

FIG. 8 is a schematic block diagram showing a structure of memory card 110 shown in FIGS. 1 and 2.

As already described, KPmw and Kmw are employed as the class public encryption key and the class private decryption key of the memory card, respectively, and class certificate Cmw in the memory card is also employed. It is assumed that the natural number w is equal to 3 in memory card 110 (w=3). The natural number x for identifying the memory card is equal to 4 (x=4).

Accordingly, memory card 110 includes an authentication data hold unit 1400 for holding authentication data {KPm3//Cm3}KPa, a Kmc hold unit 1402 for holding a unique private decryption key Kmc4, which is a decryption key unique to each memory card, a Km hold unit 1421 for storing a class private decryption key Km3 and a KPmc hold unit 1416 for storing a public encryption key KPmc4, which can be decrypted with unique secret encryption key Kmc4.

Owing to provision of the encryption key of the memory card operating as the record device, the distributed content data and the encrypted license key can be administered on the memory card bases, as will be apparent from the following description.

Memory card 110 further includes an interface 1424 for transmitting signals to and from memory card interface 1200 via a terminal 1426, a bus BS4 for transmitting signals to and from interface 1424, a decryption processing unit 1422 receiving data applied onto bus BS4 via interface 1424, also receiving class private decryption key Km3 from Km hold unit 1421 for outputting session key Ks1 generated in the distribution session by distribution server 10 to a contact Pa, a decryption processing unit 1408 decrypting the data sent from bus BS4 with public authentication key KPa sent from KPa hold unit 1414 to send the result of decryption and the class certificate obtained by the decryption to controller 1420 and send the class public key obtained by the decryption to encryption processing unit 1410, respectively, and an encryption processing unit 1406 decrypting the data selectively applied from a switch 1446 with a key selectively applied from a switch 1442, and outputs it onto bus BS4.

Memory card 110 further includes a session key generator 1418 for generating session key Ks2 in each of the distribution and reproduction sessions, encryption processing unit 1410 decrypting session key Ks2 sent from session key generator 1418 with class public encryption key KPpy or KPmw obtained by decryption processing unit 1408, and sends it onto bus BS4, a decryption processing unit 1412 receiving the data encrypted with session key Ks2 from bus BS4, and decrypts it with session key Ks2 obtained from session key generator 1418, and a decryption processing unit 1417 for encrypting license key Kc and reproduction control information ACp, which are read from memory 1415 in the reproduction session of the encrypted content data, with unique public encryption key KPmcx (x≈4) of other recording device, which is decrypted by decryption processing unit 1412.

Memory card 110 further includes a decryption processing unit 1404 for decrypting the data on bus BS4 with a unique private decryption key Kmc4 of memory card 110, which is paired with unique public encryption key KPmc4, and a memory 1415 for receiving, from bus BS 4, and storing certificate revocation list CRL which is successively updated with data CRLdate for version update in the certificate revocation list, encrypted content data {Dc}Kc, a license (Kc, Acp, ACm and license ID) for reproducing encrypted content data {Dc}Kc, additional information Dc-inf, the reproduction list file of encrypted content data and the license administration file for administering the license. Memory 1415 is formed of, e.g., a semiconductor memory device. Memory 1415 is formed of a CRL region 1415A, a license region 1415B and a data region 1415C. CRL region 1415A is a region for recording certificate revocation list CRL. License region 1415B is used for recording the license. Data region 1415C is used for recording encrypted content data {Dc}Kc, additional information Dc-inf of the encrypted content data, a license administration file for recording information required for license administration for each encrypted content data, and a reproduction list file for recording basic information for accessing the encrypted content data and the license stored in memory card 110. Data region 1415C can be externally and directly accessed. The license administration file and reproduction list file will be described later in greater detail, License region 1415B stores the licenses (license key Kc, reproduction control information ACp, access control information ACm and license ID) in record units, each of which is referred to as “entry” and is dedicated to recording of licenses. For accessing the license, an entry number is used for designating the entry, in which the license is stored or is to be stored.

Memory card 110 further includes a controller 1420, which externally transmits data via bus BS4, and receives reproduction information and others from bus BS4 for controlling operations of memory card 110.

All the structures except for data region 1415C are formed in an tamper resistant module region.

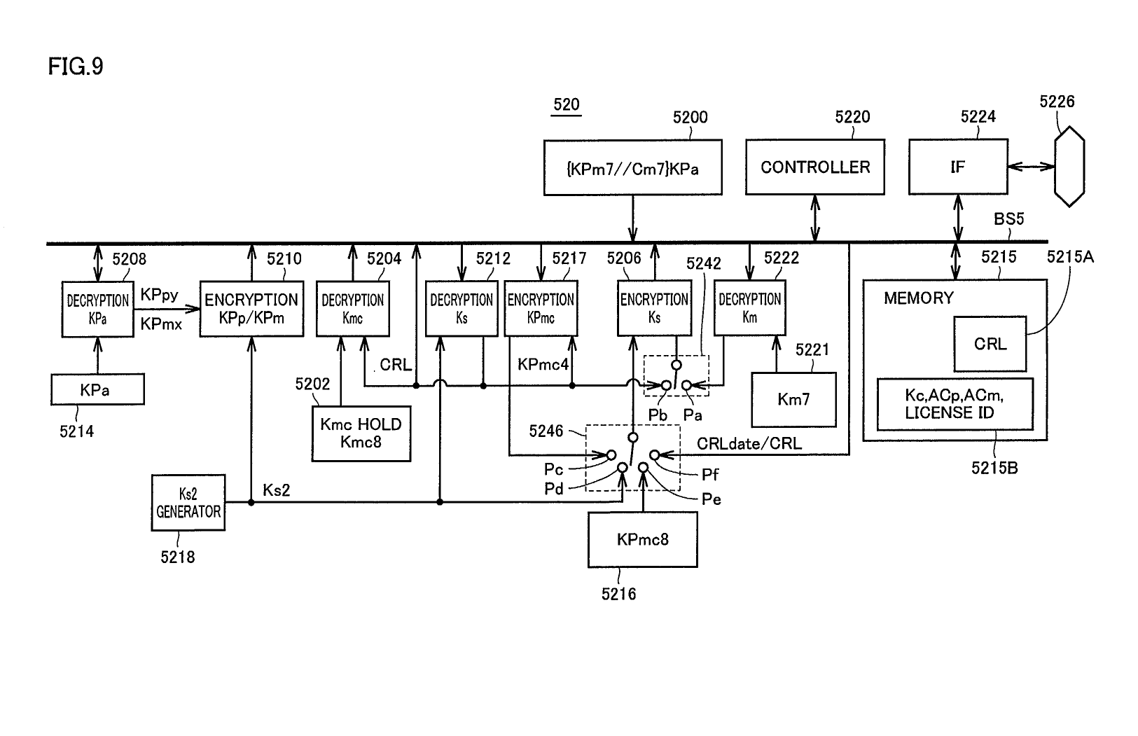

FIG. 9 is a schematic block diagram showing a structure of license administration device 520 arranged within personal computer 50. License administration device 520 has the basically same structure as memory card 110 except for that a region corresponding to data region 1415C in memory card 110 is not required, and an interface 5224 different in function from interface 1424 and a terminal 5226 different in configuration from terminal 1426 are employed. License administration device 520 includes an authentication data hold unit 5200, a Kmc hold unit 5202, a decryption processing unit 5204, an encryption processing unit 5206, decryption processing unit 5208, an encryption processing unit 5210, a decryption processing unit 5212, a KPa hold unit 5214, KPmc hold unit 5216, an encryption processing unit 5217, a session key generator 5218, a controller 5220, a Km hold unit 5221, a decryption processing unit 5222, an interface 5224, a terminal 5226 and switches 5242 and 5246, which are the same as authentication data hold unit 1400, Kmc hold unit 1402, decryption processing unit 1404, encryption processing unit 1406, decryption processing unit 1408, encryption processing unit 1410, decryption processing unit 1412, KPa hold unit 1414, KPmc hold unit 1416, encryption processing unit 1417, session key generator 1418, controller 1420, Km hold unit 1421, decryption processing unit 1422, and switches 1442 and 1446, respectively. However, authentication data hold unit 5200 holds authentication data {KPm7//Cm7}KPa. KPmc hold unit 5216 holds unique public encryption key KPm8. Km hold unit 5221 holds class private decryption key Km7. Kmc hold unit 5202 holds unique private decryption key Kmc8. The natural number, which represents the class of license administration device 520, is equal to 7 (w=7), and the natural number x for identifying license administration device 520 is equal to 8 (x=8).

License administration device 520 includes a memory 5215 for storing certificate revocation list CRL and licenses (Kc, ACp, ACm and license ID) instead of memory 1415 in memory card 110. Memory 5215 is formed of a CRL region 5215A storing certificate revocation list CRL and a license region 5215B storing the licenses.

Description will now be given on operations in respective sessions of the data distribution systems shown in FIGS. 1 and 2.

[Distribution 1]

In the data distribution systems shown in FIGS. 1 and 2, the encrypted content data and the license are distributed from distribution server 10 to license administration device 520 of personal computer 50 in the following manner. This operation will be referred to as “distribution 1”.

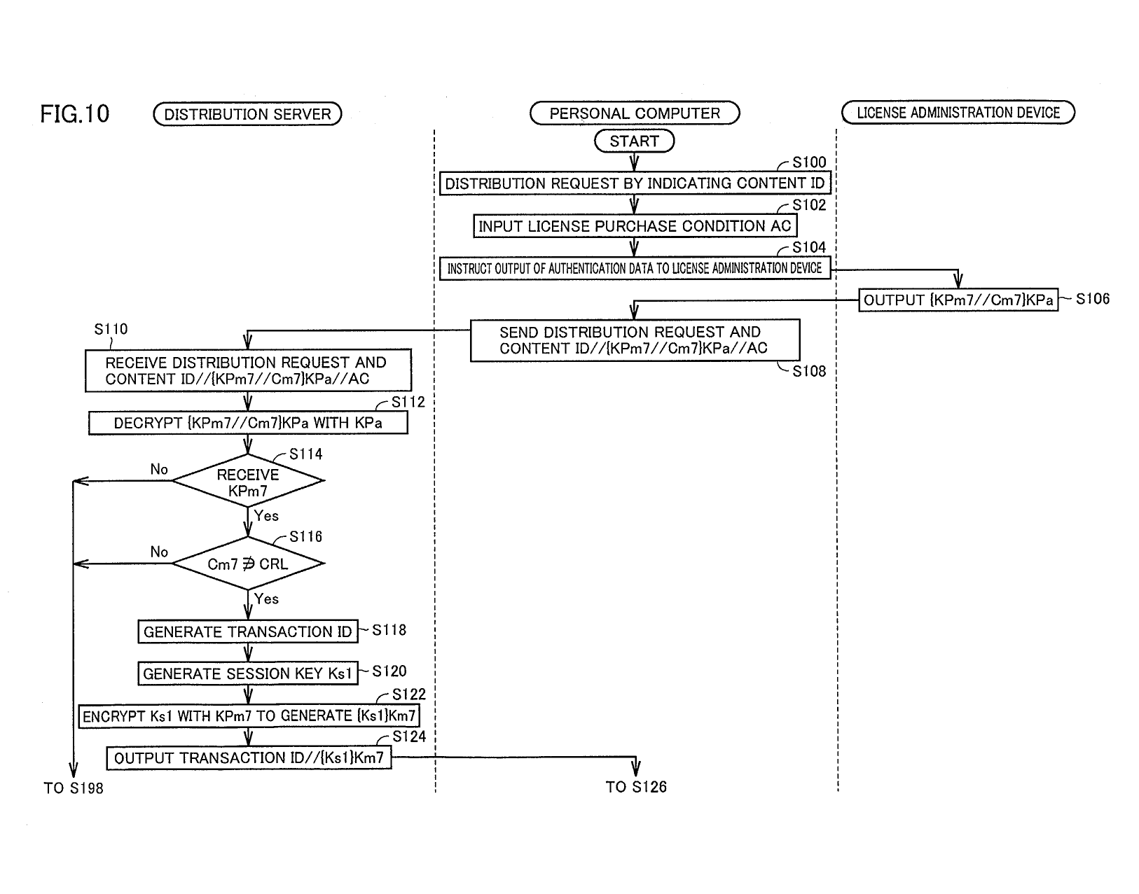

FIGS. 10-13 are first to fourth flowcharts, respectively, which show the distribution operation in the data distribution systems shown in FIGS. 1 and 2, and more specifically, show the distribution (which will be referred to as a “distribution session” hereinafter) to license administration device 520 in personal computer 50 at the time of purchasing the encrypted content data.

Before the processing in FIG. 10, the user connects personal computer 50 to distribution server 10 via modem 40, and thereby obtains the content ID for the intended content, i.e., the content to be purchased.

Referring to FIG. 10, the user of personal computer 50 enters via keyboard 560 the distribution request by designating the content ID (step S100). Through keyboard 560, the user enters purchase conditions AC for purchasing the license of the encrypted content data (step S102). More specifically, access control information ACm and reproduction control information ACp of the encrypted content data are set, and purchase conditions AC are input for purchasing license key Kc for decrypting the selected encrypted content data.

When purchase conditions AC of encrypted content data are input, controller 510 applies an instruction for outputting the authentication data to license administration device 520 (step S104). Controller 5220 of license administration device 520 receives the instruction of outputting the authentication data via terminal 5226, interface 5224 and bus BS5. Controller 5220 reads out authentication data {KPm7//Cm7}KPa from authentication data hold unit 5200 via bus BS5, and outputs authentication data {KPm7//Cm7}KPa via bus BS5, interface 5224 and terminal 5226 (step S106).

In addition to authentication data {KPm7//Cm7}KPa sent from license administration device 520, controller 510 of personal computer 50 sends the content ID, data AC of license purchase conditions and distribution request to distribution server 10 (step S108).

Distribution server 10 receives the distribution request, content ID, authentication data {KPm7//Cm7}KPa and data AC of license purchase conditions from personal computer 50 (step S110), and decryption processing unit 312 decrypts the authentication data output from license administration device 520 with public authentication key KPa (step S112).

Distribution control unit 315 performs authentication processing based on the result of decryption by decryption processing unit 312, and more specifically determines whether it receives the authentication data encrypted for the purpose of verifying its authenticity or validity by a legal system or body or not (step S114). When it is determined that authentication data is the valid data, distribution control unit 315 approves and accepts class public encryption key KPm7 and class certificate Cm7. The operation moves to a step S116. When distribution control unit 315 determines that it is not the valid authentication data, the data is not approved, and the processing ends without accepting class public secret key KPm7 and class certificate Cm7 (step S198).

When class public encryption key KPm7 and class certificate Cm7 are accepted as a result of authentication, distribution control unit 315 then refers to CRL database 306 to determine whether class certificate Cm7 of license administration device 520 is listed up in the certificate revocation list CRL. If this class certificate Cm7 is listed up in the certificate revocation list CRL, the distribution session ends (step S198).

If the class certificate of license administration device 520 is not listed in certificate revocation list CRL, next processing starts (step S116).

When it is determined from the result of authentication that the access is made from personal computer 50 provided with license administration device 520 having valid authentication data, and the class certificate is not listed in the certificate revocation list CRL, distribution server 10 generates by distribution control unit 315 the transaction ID, which is the administration code for specifying the distribution (step S118). Session key generator 316 generates session key Ks1 for distribution (step S120). Session key Ks1 is encrypted by encryption processing unit 318 with class public encryption key KPm7 corresponding to license administration device 520 and obtained by decryption processing unit 312 (step S122).

The transaction ID and encrypted session key Ks1 are externally output as transaction ID//{Ks1}Km7 via bus BS1 and communication device 350.

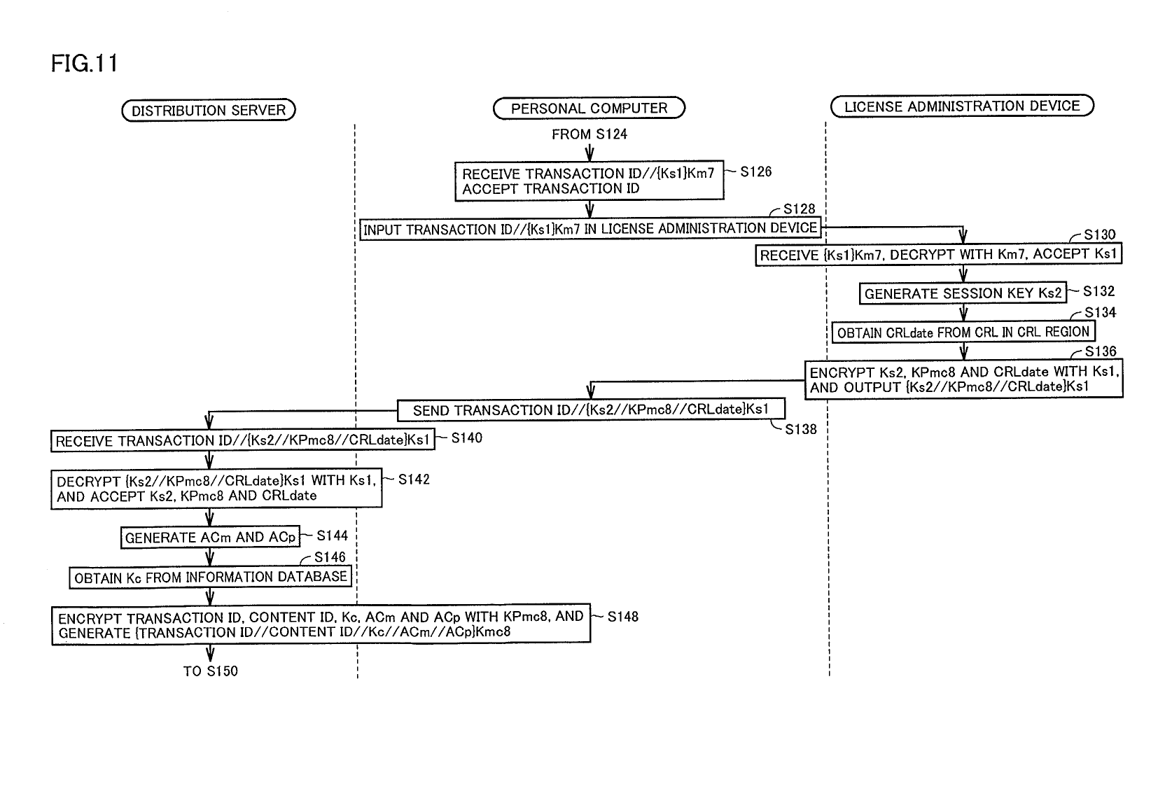

Referring to FIG. 11, when personal computer 50 receives transaction ID//{Ks1}Km7 (step S126), controller 510 inputs transaction ID//{Ks1}Km7 to license administration device 520 (step S128). In license administration device 520, thereby, decryption processing unit 5222 decrypts the received data, which is applied to bus BS5 via terminal 5226 and interface 5224, with class private decryption key Km7, which is unique to license administration device 520 held in Km hold unit 5221, so that session key Ks1 is decrypted and accepted (step S130).

When confirming the acceptance of session key Ks1 generated by distribution server 10, controller 5220 instructs session key generator 5218 to generate session key Ks2 to be used at the time of distribution operation in license administration device 520. Session key generator 5218 generates session key Ks2 (step S132).

In the distribution session, controller 5220 extracts update date/time CRLdate from certificate revocation list CRL recorded in memory 5215 of license administration device 520, and outputs it to switch 5246 (step S134).

Encryption processing unit 5206 encrypts session key Ks2, unique public encryption key KPmc8 and update date/time CRLdate of certificate revocation list CRL, which are obtained by successively selecting the contacts of switch 5246, with session key Ks1, which is applied by decryption processing unit 5222 via contact Pa of switch 5242, to generate one data row, and outputs this data row, i.e., encrypted data {Ks2//KPmc8//CRLdate}Ks1 onto bus BS5 (step S136).

Encrypted data {Ks2//KPmc8//CRLdate}Ks1 output onto bus BS5 is sent to personal computer 50 from bus BS5 via interface 5224 and terminal 5226. Controller 510 of personal computer 50 adds transaction ID to encrypted data {Ks2//KPmc8//CRLdate}Ks1, and sends transaction ID//{Ks2//KPmc8//CRLdate}Ks1 to distribution server 10 (step S138).

Distribution server 10 receives transaction ID//{Ks2//KPmc8//CRLdate}Ks1, decrypts it with session key Ks1 by decryption processing unit 320 and accepts session key Ks2 generated by license administration device 520 and update date/time CRLdate of the certificate revocation list in license administration device 520 (step S142).

Distribution control unit 315 generates access control information ACm and reproduction control information ACp in accordance with content ID and data AC of the license purchase conditions obtained in step S110 (step S144). Distribution control unit 315 further obtains license key Kc for decrypting the encrypted content data from information database 304 (step S146).

Distribution control unit 315 applies the generated licenses, i.e., transaction ID, content ID, license key Kc, reproduction control information ACp and access control information ACm to encryption processing unit 326. Encryption processing unit 326 encrypts the licenses with public encryption key KPmc8, which is unique to license administration device 520 and is obtained by decryption processing unit 320, to generate encrypted content data {transaction ID//content ID//Kc//ACm//ACp}Kmc8 in a step S148.

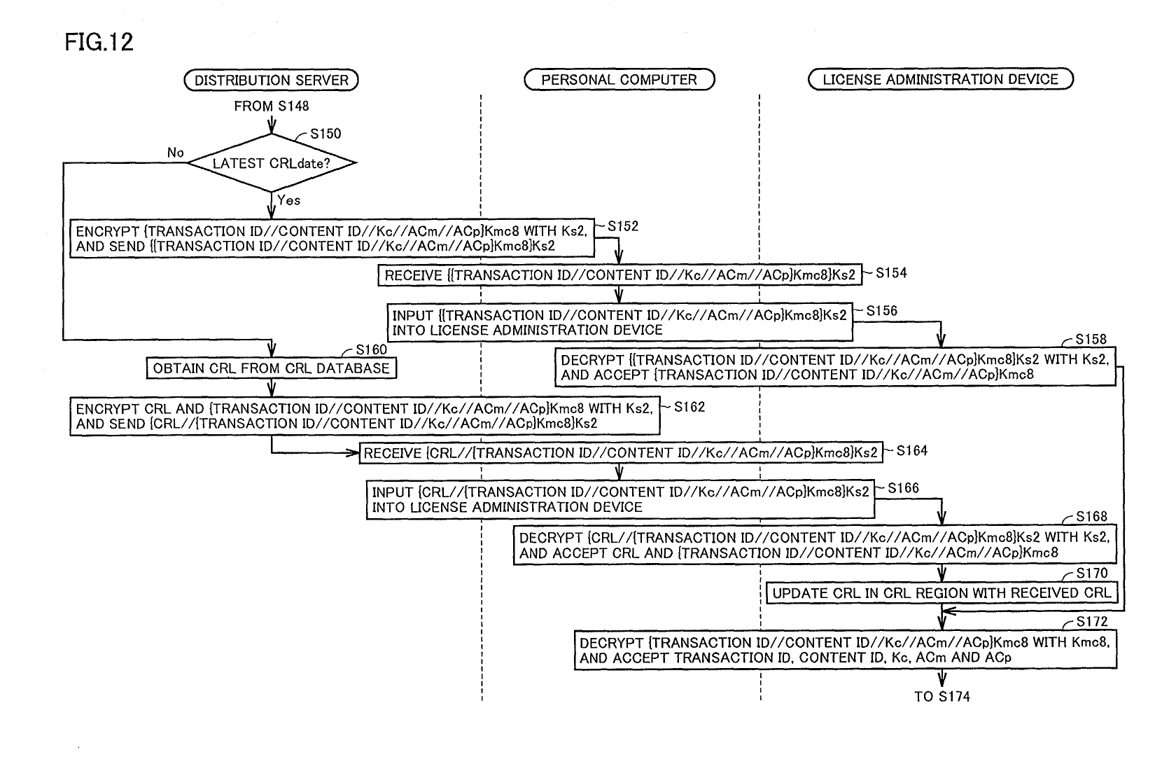

In distribution server 10, as shown in FIG. 12, update date/time CRLdate of the certificate revocation list CRL, which is sent from license administration device 520, is compared with the update date/time of certificate revocation list CRL of distribution server 10 held in CRL database 306, and thereby it is determined whether the certificate revocation list CRL held in license administration device 520 is the latest or not. If it is determined that the certificate revocation list CRL held in license administration device 520 is the latest, the operation moves to a step S152. If the certificate revocation list CRL held in license administration device 520 is not the latest, the operation moves to a step S160 (step S150).

When it is determined that list CRL is the latest, encryption processing unit 328 encrypts the encrypted data {transaction ID//content ID//Kc//ACm//ACp}Kmc8 output from encryption processing unit 326 with session key Ks2 generated by license administration device 520, and outputs encrypted data {{transaction ID//content ID//Kc//ACm//ACp}Kmc8}Ks2 onto bus BS1. Distribution control unit 315 sends encrypted data {{transaction ID//content ID//Kc//ACm//ACp}Kmc8}Ks2 on bus BS1 to personal computer 50 via communication device 350 (step S152).

Controller 510 of personal computer 50 receives encrypted data {{transaction ID//content ID//Kc//ACm//ACp}Kmc8}Ks2 (step S154), and inputs it to license administration device 520 via bus BS2. Decryption processing unit 5212 of license administration device 520 receives encrypted data {{transaction ID//content ID//Kc//ACm//ACp}Kmc8}Ks2 via terminal 5226, interface 5224 and bus BS5, and decrypts it with session key Ks2 generated by session key generator 5218 to accept encrypted data {transaction ID//content ID//Kc//ACm//ACp}Kmc8 (step S158). Thereafter, the operation moves to a step S172.

If it is determined in distribution server 10 that certificate revocation list CRL held in license administration device 520 is not the latest, distribution control unit 315 obtains the latest certificate revocation list CRL from CRL database 306 via bus BS1 (step S160).

Encryption processing unit 328 receives the output of encryption processing unit 326 and the latest certificate revocation list CRL supplied from distribution control unit 315 via bus BS1, and encrypts it with session key Ks2 generated in license administration device 520. Encrypted data {CRL//{transaction ID//content ID//Kc//ACm//ACp}Kmc8}Ks2 output from encryption processing unit 328 is sent to personal computer 50 via bus BS1 and communication device 350 (step S162).

Personal computer 50 receives encrypted data {CRL//{transaction ID//content ID//Kc//ACm//ACp}Kmc8}Ks2 sent thereto (step S164), and inputs it to license administration device 520 (step S166). In license administration device 520, decryption processing unit 5212 decrypts the received data applied onto bus BS5 via terminal 5226 and interface 5224. Decryption processing unit 5212 decrypts the received data on bus BS5 with session key Ks2, which is applied from session key generator 5218, and outputs it onto bus BS5 (step S168).

In this stage, bus BS5 receives encrypted content data {transaction ID//content ID//Kc//ACm//ACp}Kmc8, which can be decrypted with private decryption key Kmc8 held on Kmc hold unit 5202, and the latest certificate revocation list CRL (step S168). In accordance with the instruction from controller 5220, CRL region 5215A in memory 5215 is updated with accepted certificate revocation list CRL (step S170).

The operations in steps S152, S154, S156 and S158 are executed for distributing the licenses to license administration device 520 when certificate revocation list CRL in license administration device 520 is the latest. The operations in steps S160, S162, S164, S166, S168 and S170 are likewise executed for distributing the licenses to license administration device 520 when certificate revocation list CRL in license administration device 520 is not the latest. By these operations, it is determined whether the certificate revocation list CRL of the license administration device 520 obtained by the distribution is the latest or not, and this determination is performed one by one based on update date/time CRLdate of the certificate revocation list sent from license administration device 520. If it is not the latest, the latest certificate revocation list CRL is obtained from CRL database 306, and is distributed to license administration device 520. Thereby, it is possible to prevent provision of the license to the content reproduction circuit and recording device, of which security is broken, for example, private key is leaked out.

After steps S158 or S170, controller 5220 instructs decryption processing unit 5204 to decrypt encrypted data {transaction ID//content ID//Kc//ACm//ACp}Kmc8 with unique private decryption key Kmc8, and licenses (license key Kc, transaction ID, content ID, access control information ACm and reproduction control information ACp) are accepted (step S172).

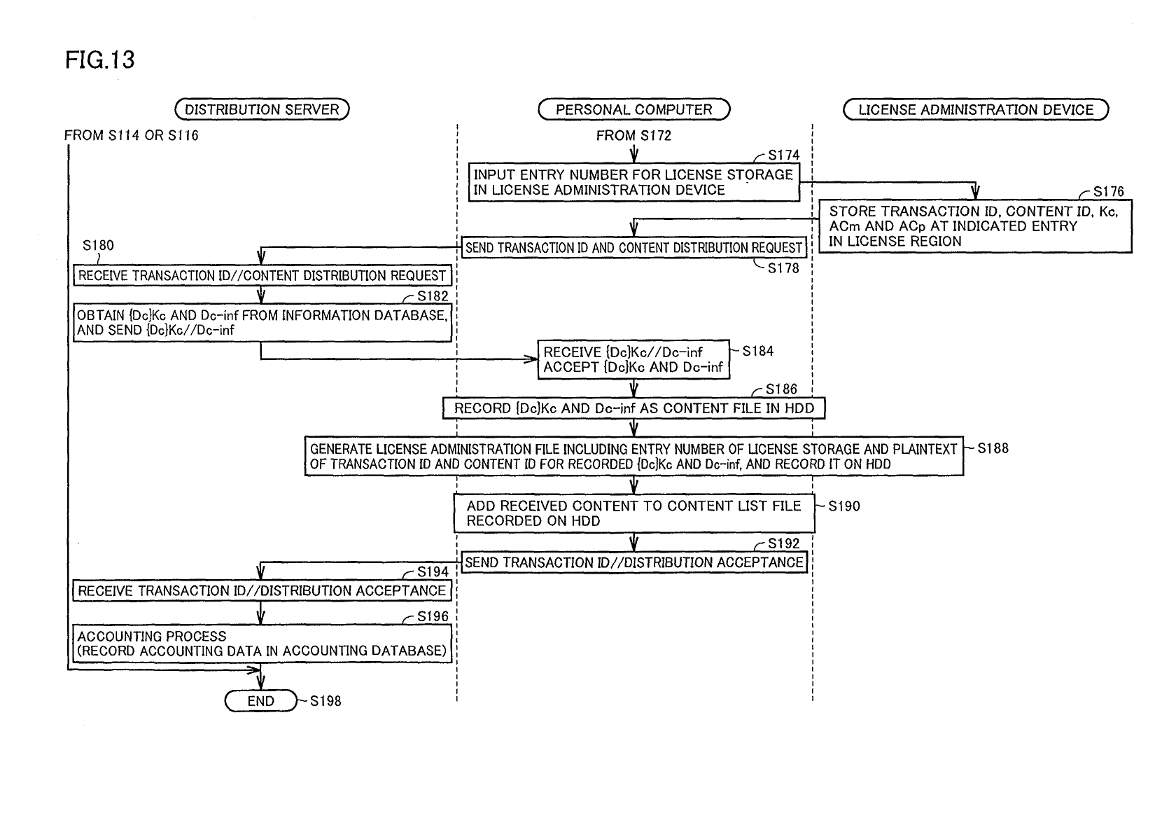

Referring to FIG. 13, controller 510 inputs the entry number indicating the entry for storing the license, which are received by license administration device 520, to license administration device 520 (step S174). Thereby, controller 5220 of license administration device 520 receives the entry number via terminal 5226 and interface 5224, and stores licenses (license key Kc, transaction ID, content ID, access control information ACm and reproduction control information ACp), which are obtained in step S172, at license region 5215B in memory 5215 designated by the received entry number (step S176).

Controller 510 of personal computer 50 sends the transaction ID, which is sent from distribution server 10, and the distribution request of the encrypted content data to distribution server 10 (step S178).

Distribution server 10 receives the transaction ID and the distribution request of the encrypted content data (step S180), obtains encrypted content data {Dc}Kc and additional information Dc-inf from information database 304, and outputs these data and information via bus BS1 and communication device 350 (step S182).

Personal computer 50 receives {Dc}Kc//Dc-inf, and accepts encrypted content data {Dc}Kc and additional information Dc-inf (step S184). Thereby, controller 510 records encrypted content data {Dc}Kc and additional information Dc-inf as one content file on hard disk (HDD) 530 in license administration device 520 via bus BS2 (step S186). Controller 510 generates the license administration file, which includes the entry number of the license stored in license administration device 520 as well as plaintext of transaction ID and content ID, for encrypted content data {Dc}Kc and additional information Dc-inf, and records it on hard disk (HDD) 530 via bus BS2 (step S188). Further, controller 510 adds the accepted content information to the content list file recorded on HDD 530, and more specifically adds names of the recorded content file and license administration file as well as information (title of tune and name of artist) relating to the encrypted content data and extracted from additional information Dc-inf (step S190). Then, controller 5220 sends the transaction ID and distribution acceptance to distribution server 10 (step S192).

When distribution server 10 receives transaction ID//distribution acceptance (step S194), it stores the accounting data in account database 302, and records the transaction ID in distribution log database 308. Then, it executes processing of ending the distribution (step S196). Thereby, the whole processing ends (step S198).

As described above, it is determined that license administration device 520 arranged in personal computer 50 is the device holding the legal or valid authentication data, and at the same time, it is determined that public encryption key KPm7, which is encrypted and sent together with class certificate Cm7, is valid. After determining these facts, the content data can be distributed only in response to the distribution request, which is sent from the license administration device having class certificate Cm7 not listed in the certificate revocation list (i.e., class certificate Cm7 encrypted with public encryption key KPm7 but broken). It is possible to inhibit the distribution to unauthorized license administration device as well as the distribution using the descrambled or broken class key.

The encryption keys generated in distribution server 10 and license administration device 520 are transmitted between them. Each of the distribution server and the memory card executes the encryption with the received encryption key, and sends the encrypted data to the other so that the mutual authentication can be practically performed even when sending and receiving the encrypted data, and it is possible to improve the security in the data distribution system.

When license administration device 520 receives the encrypted content data and licenses from distribution server 10, data is transmitted by hardware between them, and the licenses for reproducing the encrypted content data is stored by hardware so that the security level of this operation is high. By using license administration device 520, therefore, personal computer 50 can receive the encrypted content data and licenses distributed with high security level, and can perform the administration of the level-2 licenses of high security level.

In accordance with the flowcharts shown in FIGS. 10-13, the encrypted content data and the licenses can be distributed to memory card 110 attached to cellular phone 100 over the cellular phone network. This can be performed by using cellular phone 100 and memory card 110 instead of personal computer 50 and license administration device 520, respectively. In this case, the operations in steps S186, S188 and S190 shown in FIG. 13 are performed to record the reproduction list files, corresponding to the content file (encrypted content data {Dc}Kc and additional information Dc-inf), the license administration file and content list file, at data region 1415C in memory 1415 of memory card 110. Operations other than the above are performed in the same manners.

When distributing the encrypted content data and licenses to memory card 110, the encrypted content data and licenses are received and stored by hardware. Therefore, the distribution of the encrypted content data and licenses to memory card 110 can be administered with the level-2 license of high security level, similarly to the distribution of the encrypted content data and licenses to license administration device 520.

[Distribution 2]

In the data distribution systems shown in FIGS. 1 and 2, the encrypted content data and the license are distributed from distribution server 10 to license administration module 511 of personal computer 50 in the following manner. This operation will be referred to as “distribution 2”.

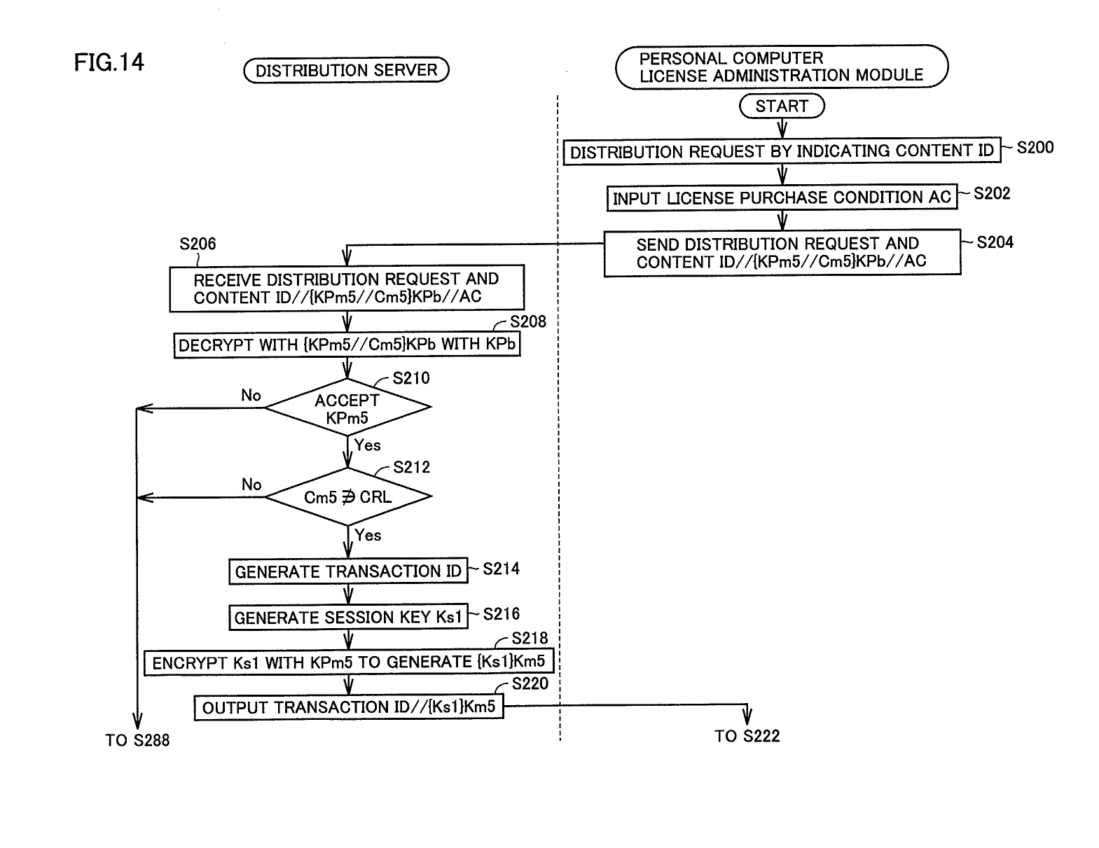

Before the processing in FIG. 14, the user connects personal computer 50 to distribution server 10 via modem 40, and thereby obtains the content ID for the intended content, i.e., the content to be purchased.

FIGS. 14-17 are first to fourth flowcharts, respectively, which show the distribution operation in the data distribution systems shown in FIGS. 1 and 2, and more specifically, show the distribution to license administration module 511 in personal computer 50 at the time of purchasing the encrypted content data. License administration module 511 executes the program to receive the encrypted content data and the license from distribution server 10. In the “distribution 2”, the format of data exchanged over communication path between distribution server 10 and personal computer 50 and the security structure for it are similar to those in the “distribution 1”, but distribution server 10 uses two public authentication keys KPa and KPb. Key KPa is the public authentication key for confirming the authentication data of memory card 110 and license administration device 520 having the security level 2. Key KPb is the public authentication key for confirming the authentication data of license administration module 511 having the security level 1. License administration module 511 is a software module having the substantially same function as license administration device 520. Natural number w representing the class of license administration module 511 is equal to 5 (w=5), and natural number x for identifying license administration module 511 is equal to 6 (x=6). Accordingly, license administration module 511 holds authentication data {KPm5//Cm5}KPb, unique public secret key KPm6, class private decryption key Km5 and unique private decryption key Kmc6.

Referring to FIG. 14, the user of personal computer 50 enters via keyboard 560 the distribution request by designating the content ID (step S200). Through keyboard 560, the user enters purchase conditions AC for purchasing the license of the encrypted content data (step S202). More specifically, access control information ACm and reproduction control information ACp of the encrypted content data are set, and purchase conditions AC are input for purchasing license key Kc for decrypting the selected encrypted content data.

When purchase conditions AC of encrypted content data are input, controller 510 reads out of authentication data {KPm5//Cm5}KPb from license administration module 511, and sends, in addition to authentication data {KPm5//Cm5}KPb, the content ID, data AC of the license purchase conditions and the distribution request to distribution server 10 (step S204).

Distribution server 10 receives from personal computer 50 the distribution request, content ID, authentication data {KPm5//Cm5}KPb and data AC of license purchase conditions (step S206). Distribution control unit 315 determines based on class certificate Cm5 of authentication data {KPm5//Cm5}KPb whether the distribution at level 1 is request or the distribution at level 2 is requested. Authentication data {KPm5//Cm5}KPb is applied from license administration module 511 for requesting the distribution at level 1 so that distribution control unit 315 determines that the distribution at level 1 is requested. Decryption processing unit 312 decrypts received authentication data {KPm5//Cm5}KPb with public authentication key KPb for level 1 (step S208).

Distribution control unit 315 performs authentication processing based on the result of decryption by decryption processing unit 312, and more specifically determines whether received authentication data {KPm5//Cm5}KPb is the authentication data encrypted for the purpose of verifying its authenticity or validity by a legal system or body for the level 1 or not (step S210). When it is determined that authentication data {KPm5//Cm5}KPb is the valid data for level 1, distribution control unit 315 approves and accepts public encryption key KPm5 and certificate Cm5. The operation moves to a step S212. When distribution control unit 315 determines that it is not the valid authentication data for level 1, the data is not approved, and the processing ends without accepting public secret key KPm5 and certificate Cm5 (step S288).

Although description will be given any longer, distribution server 10 can send the license at level 1 directly to license administration device 520 or memory card 110 having the security level of 2 via personal computer 50.

When public encryption key KPm5 and certificate Cm5 are accepted as a result of authentication, distribution control unit 315 then refers to CRL database 306 to determine whether class certificate Cm5 of license administration module 511 is listed up in certificate revocation list CRL. If class certificate Cm5 is listed up in the certificate revocation list, the distribution session ends (step S288).

If the class certificate of license administration module 511 is not listed in the certificate revocation list, next processing starts (step S214).

When public encryption key KPm5 and certificate Cm5 are accepted as a result of the authentication, and it is determined that the class certificate is not listed in the certificate revocation list, distribution server 10 generates by distribution control unit 315 the transaction ID, which is the administration code for specifying the distribution (step S214). Session key generator 316 generates session key Ks1 for distribution (step S216). Session key Ks1 is encrypted by encryption processing unit 318 with class public encryption key KPm5 corresponding to license administration module 511 and obtained by decryption processing unit 312 (step S218).

The transaction ID and encrypted session key Ks1 are externally output as transaction ID//{Ks1}Km5 via bus BS1 and communication device 350 (step S220).

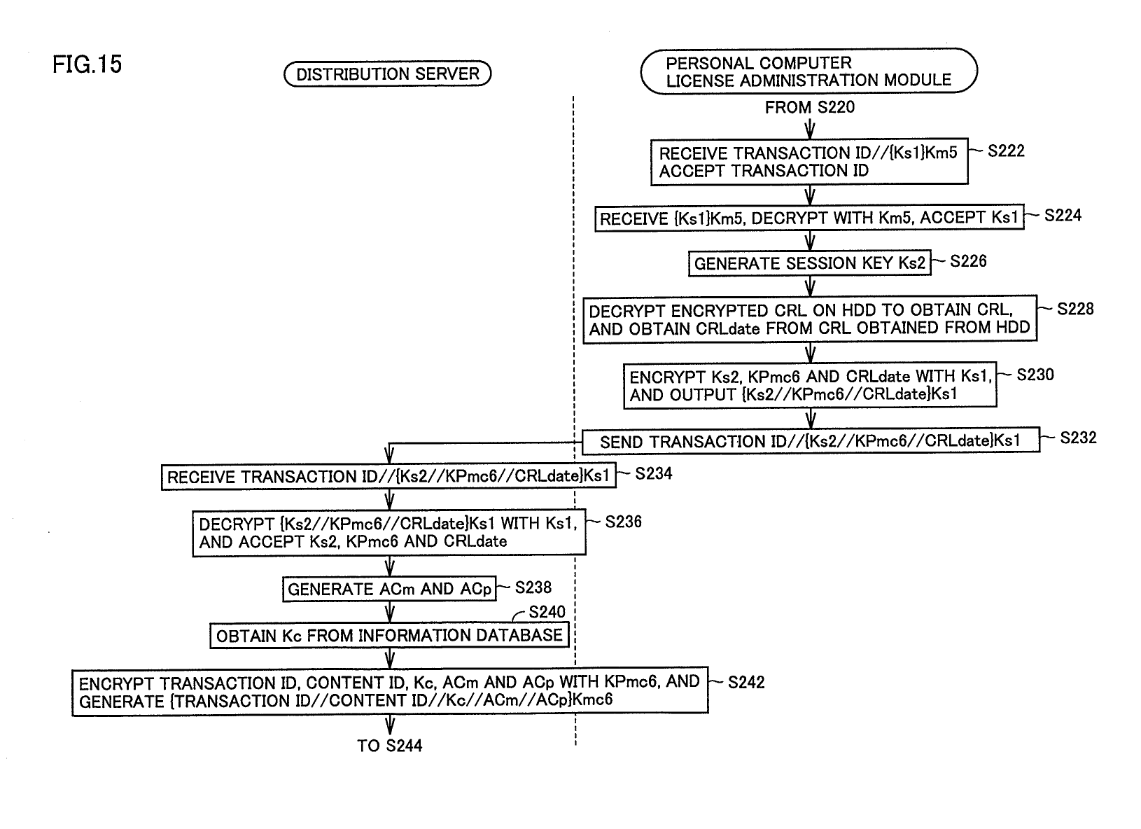

Referring to FIG. 15, when controller 510 of personal computer 50 receives transaction ID//{Ks1}Km5 (step S222), license administration module 511 receives encrypted data{Ks1}Km5, decrypts it with class private decryption key Km5 unique to license administration module 511 and accepts session key Ks1 (step S224).

License administration module 511 generates session key Ks2 when it confirms the acceptance of session key Ks1 generated by distribution server 10 (step S226). Controller 510 reads out encrypted CRL stored on HDD 530 via bus BS2. License administration module 511 decrypts encrypted CRL to obtain certificate revocation list CRL, and obtains update date/time CRLdate of the certificate revocation list from decrypted certificate revocation list CRL (step S228). License administration module 511 further encrypts session key Ks2 generated in license administration module 511 as well as unique public encryption key KPmc6 and update date/time CRLdate of the certificate revocation list with session key Ks1 generated in distribution server 10, and thereby forms one encrypted data row, which is output as the encrypted data {Ks2//KPmc6//CRLdate}Ks1 (step S230).

Controller 510 sends transaction ID//{Ks2//KPmc6//CRLdate}Ks1, which is prepared by adding the transaction ID to encrypted data {Ks2//KPmc6//CRLdate}Ks1, to distribution server 10 (step S232).

Distribution server 10 receives transaction ID//{Ks2//KPmc6//CRLdate}Ks1 (step S234), and executes decryption with session key Ks1 in decryption processing unit 320. Thereby, distribution server 10 accepts session key Ks2 generated by license administration module 511, unique public encryption key KPmc6 unique to license administration module 511 and update date/time CRLdate of the certificate revocation list in license administration module 511 (step S236).

Distribution control unit 315 generates access control information ACm and reproduction control information ACp in accordance with the content ID and data AC of license purchase conditions, which are obtained in step S206 (step S238). Further, license key Kc for decrypting encrypted content data {Dc}Kc is obtained from information database 304 (step S240).

Distribution control unit 315 applies the generated licenses, i.e., the transaction ID, content ID, license key Kc, reproduction control information ACp and access control information ACm to encryption processing unit 326. Encryption processing unit 326 generates encrypted data {transaction ID//content ID//Kc//ACm//ACp}Kmc6 by encrypting the licenses with public encryption key KPmc6, which is obtained by decryption processing unit 320 and is unique to license administration module 511 (step S242).

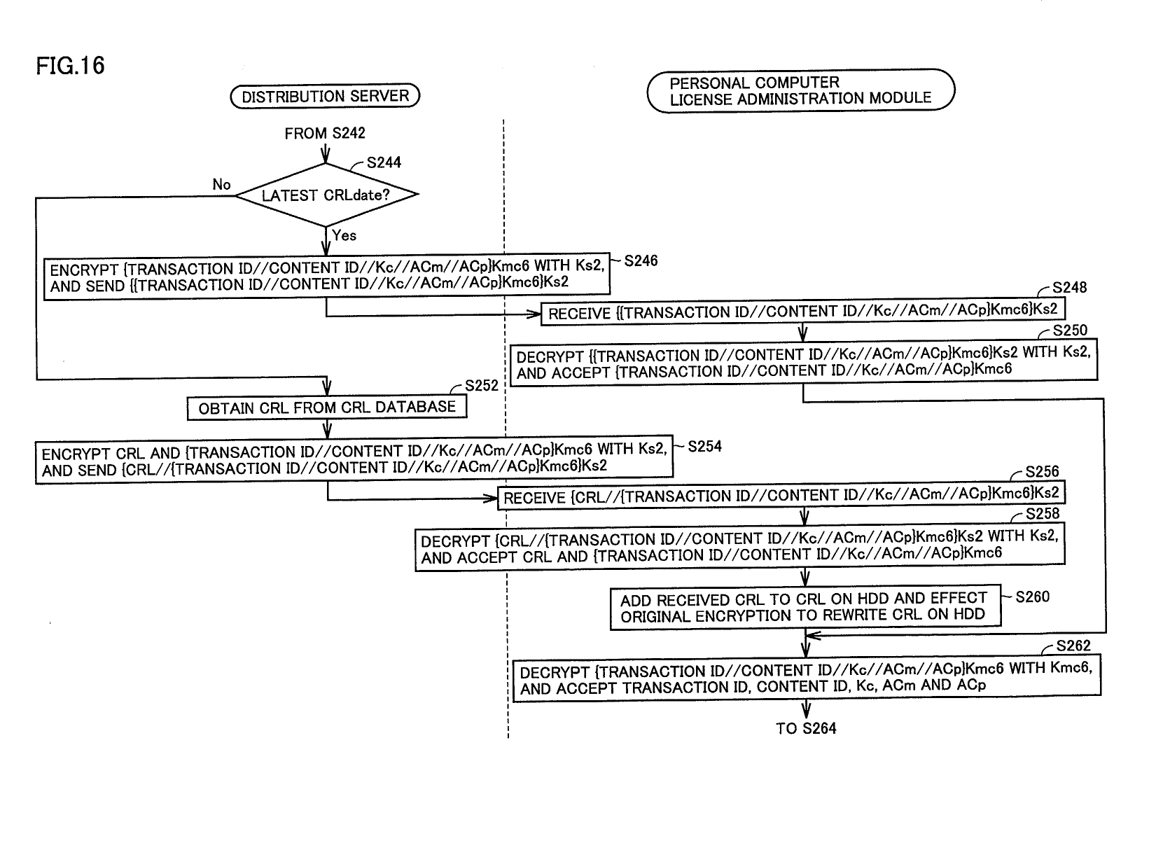

In distribution server 10, as shown in FIG. 16, update date/time CRLdate of the certificate revocation list, which is sent from license administration module 511, is compared with the update date/time of certificate revocation list CRL of distribution server 10 held in CRL database 306, and thereby it is determined whether the certificate revocation list CRL held in license administration module 511 is the latest or not. If it is determined that the certificate revocation list CRL held in license administration module 511 is the latest, the operation moves to a step S246. If the certificate revocation list CRL held in license administration module 511 is not the latest, the operation moves to a step S252 (step S244).

When it is determined that list CRL is the latest, encryption processing unit 328 encrypts the encrypted data {transaction ID//content ID//Kc//ACm//ACp}Kmc6 output from encryption processing unit 326 with session key Ks2 generated by license administration module 511, and outputs encrypted data {{transaction ID//content ID//Kc//ACm//ACp}Kmc6}Ks2 onto bus BS1. Distribution control unit 315 sends encrypted data {{transaction ID//content ID//Kc//ACm//ACp}Kmc6}Ks2 on bus BS1 to personal computer 50 via communication device 350 (step S246).

Controller 510 of personal computer 50 receives encrypted data {{transaction ID//content ID//Kc//ACm//ACp}Kmc6}Ks2 (step S248), and license administration module 511 decrypts encrypted data {{transaction ID//content ID//Kc//ACm//ACp}Kmc6}Ks2 with session key Ks2 to accept encrypted data {transaction ID//content ID//Kc//ACm//ACp}Kmc6 (step S250). Thereafter, the operation moves to step S162.

If it is determined in distribution server 10 that certificate revocation list CRL held in license administration module 511 is not the latest, distribution control unit 315 obtains the latest certificate revocation list CRL from CRL database 306 via bus BS1 (step S252).

Encryption processing unit 328 receives the output of encryption processing unit 326 and certificate revocation list CRL supplied from distribution control unit 315 via bus BS1, and encrypts it with session key Ks2 generated in license administration module 511. Encrypted data {CRL//{transaction ID//content ID//Kc//ACm//ACp}Kmc6}Ks2 output from encryption processing unit 328 is sent to-personal computer 50 via bus BS1 and communication device 350 (step S254).

Personal computer 50 receives encrypted data {CRL//{transaction ID//content ID//Kc//ACm//ACp}Kmc6}Ks2 sent thereto (step S256), and license administration module 511 decrypts the received data with session key Ks2 to accept CRL and encrypted data {transaction ID//content ID//Kc//ACm//ACp}Kmc6 (step S258).

Controller 510 adds CRL thus accepted to certificate revocation list CRL recorded on HDD 530, effects unique encryption and rewrites certificate revocation list CRL on HDD 530 (step S260).

Steps S246, S248 and S250 are provided for distributing license key Kc and others to license administration module 511 when certificate revocation list CRL in license administration module 511 is the latest. Steps S252, S254, S256, S258 and S260 are provided for distributing license key Kc and others to license administration module 511 when certificate revocation list CRL in license administration module 511 is not the latest. As described above, every certificate revocation list CRL sent from license administration module 511 is determined whether it is updated or not. If not updated, the latest certificate revocation list CRL is obtained from CRL database 306, and is sent to license administration module 511. Thereby, it is possible to prevent provision of the license to the recording device and the license administration module, of which security is broken, for example, private key is leaked out.

After step S250 or S260, encrypted license {transaction ID//content ID//Kc//ACm//ACp}Kmc6 is decrypted with private decryption key Kmc6, and the licenses (license key Kc, transaction ID, content ID, access control information ACm and reproduction control information ACp) are accepted (step S262).

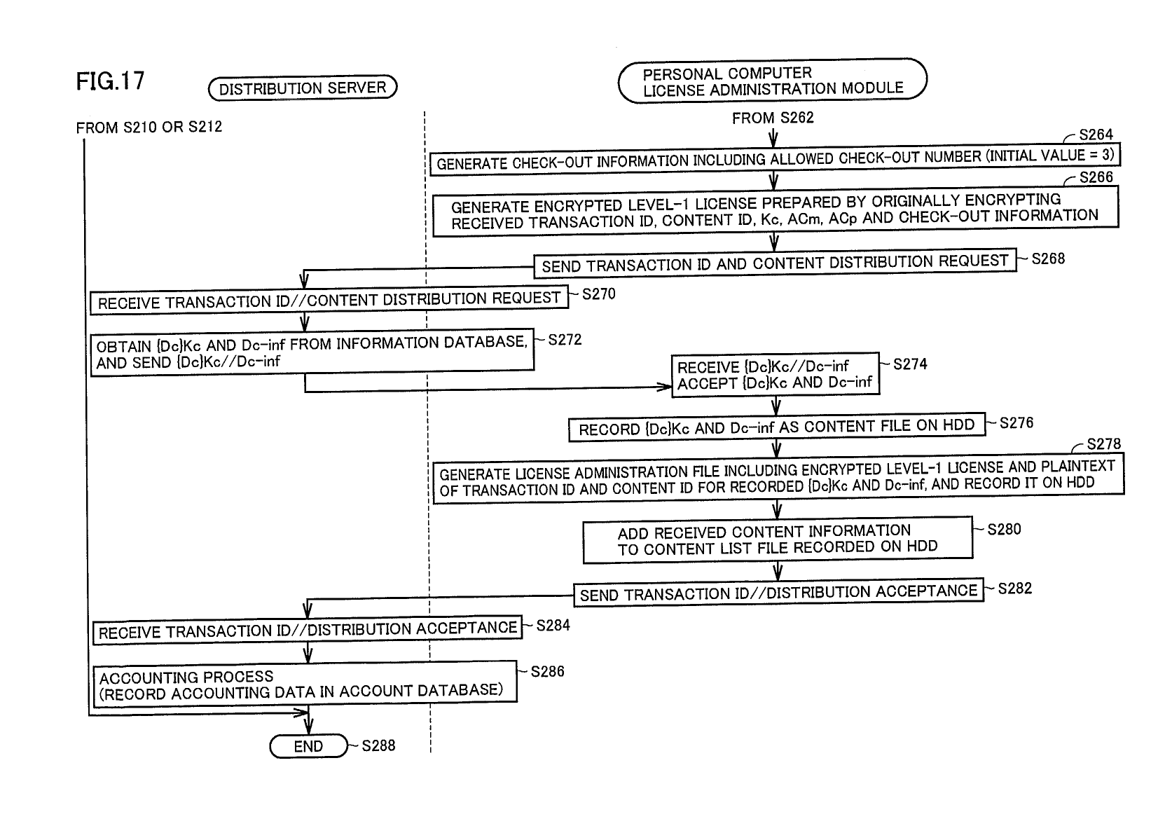

Referring to FIG. 17, license administration module 511 generates check-out information including an allowed check-out number for lending the license received from distribution server 10 to another device (step S264). In this case, the initial value of check-out is set to “3”. Thereby, license administration module 511 generates the encrypted level-1 extended license by effecting unique encryption on received licenses (transaction ID, content ID, license key Kc, access control information ACm and reproduction control information ACp) and the generated check-out information (step S266). In this case, license administration module 511 performs the encryption based on an ID number of controller (CPU) 510 of personal computer 50 and others. Therefore, the encrypted level-1 extended license thus generated is the license unique to personal computer 50, and the encrypted content data and licenses cannot be sent to another device unless the check-out, which will be described later, is used. This is because a security hole is apparently present when administered with the security level 1, and therefore the transfer of license is not allowed.

Controller 510 of personal computer 50 sends the transaction ID, which is sent from distribution server 10, and the distribution request of the encrypted content data to distribution server 10 (step S268).

Distribution server 10 receives the transaction ID and the distribution request of the encrypted content data (step S270), and distribution control unit 315 obtains encrypted content data {Dc}Kc and additional information Dc-inf from information database 304. Distribution server 10 outputs these data and information via bus BS1 and communication device 350 (step S272).

Personal computer 50 receives {Dc}Kc//Dc-inf, and accepts encrypted content data {Dc}Kc and additional information Dc-inf (step S274). Thereby, controller 510 records encrypted content data {Dc}Kc and additional information Dc-inf as one content file on hard disk (HDD) 530 via bus BS2 (step S276). Controller 510 generates the license administration file, which includes the encrypted level-1 extended license generated by license administration module 511 as well as plaintext of transaction ID and content ID, for encrypted content data {Dc}Kc and additional information Dc-inf, and records it on HDD 530 via bus BS2 (step S278). Further, controller 510 adds the accepted content information to the content list file recorded on HDD 530, and more specifically adds names of the recorded content file and license administration file as well as information (title of tune and name of artist) relating to the encrypted content data and extracted from additional information Dc-inf (step S280). Then, controller 510 sends the transaction ID and distribution acceptance to distribution server 10 (step S282).

When distribution server 10 receives transaction ID//distribution acceptance (step S284), it stores the accounting data in account database 302, and records the transaction ID in distribution log database 308. Then, it executes processing of ending the distribution (step S286). Thereby, the whole processing ends (step S288).

As described above, the encryption keys generated in distribution server 10 and license administration module 511 are sent and received, the encryption is executed with the received encryption key by each side, and the encrypted data is sent to the other side. Thereby, the mutual recognition can be performed in effect when sending and receiving the respective encrypted data so that the security in the data distribution system can be improved. Further, certificate revocation list CRL is operated. In these points, the distribution 2 is similar to the distribution for directly distributing the licenses to license administration device 520 or memory card 110.

In personal computer 50, however, license administration module 511 uses the software for transmitting the data, receiving the license from distribution server 10 and administering it. Due to this, the distribution of license by license administration module 511 is performed at a lower security level than the direct distribution of license to license administration device 520 or memory card 110.

[Ripping]

The user of personal computer 50 can obtain the encrypted content data and the license distributed thereto, and further can obtain music data from music CD 60 owned by the user for utilizing it. From the viewpoint of the copyright protection of the copyright holder, digital duplication of music CD 60 cannot be performed freely, but is allowed if it is performed for personal use (i.e., for enjoying the music) by the owner with a tool provided with a copyright protection function. Accordingly, license administration module 511 includes a program executing the ripping function of obtaining music data from music CD 60, and generating the encrypted content data and the license, which can be administered by license administration module 511.

In recent years, some kinds of music CDs contain electronic watermarks written in music data. The watermark describes, as rules of use, the range of use by the user determined by the copyright holder. In the ripping from the music data containing the rules of use written therein, the rules of use must be observed from the viewpoint of copyright protection. It is assumed that the rules of use define the duplication conditions (inhibition of duplication, duplication-allowed generation or allowance of duplication), effective period of duplication, maximum check-out number, edition, reproduction speed, regional code for reproduction, restricted number of reproduction times of duplication and allowed use time. There are conventional music CDs, in which the watermark cannot be detected, and thus the rules of use are not written.

The ripping is performed by obtaining the music data directly from the music CD, and further may be performed by obtaining the music data prepared by changing the analog input of music signals into a digital form. Further, ripping may be performed by obtaining the music data, which is compressed and encoded for reducing the amount of data. Further, the ripping may be performed by taking in, as the input, content data, which is distributed in a distribution system other than the distribution system of the embodiment.

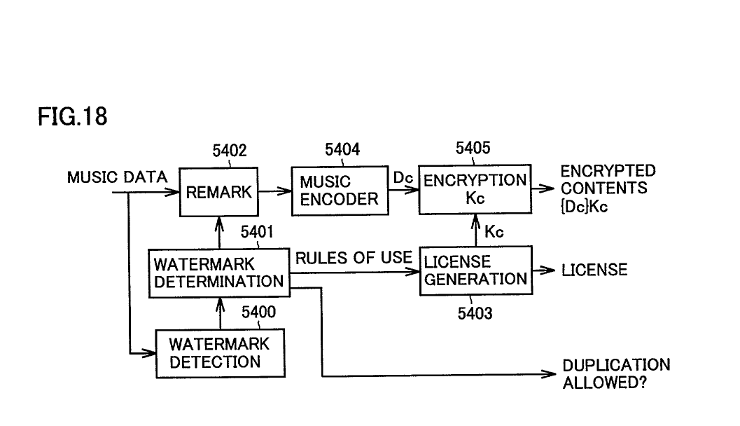

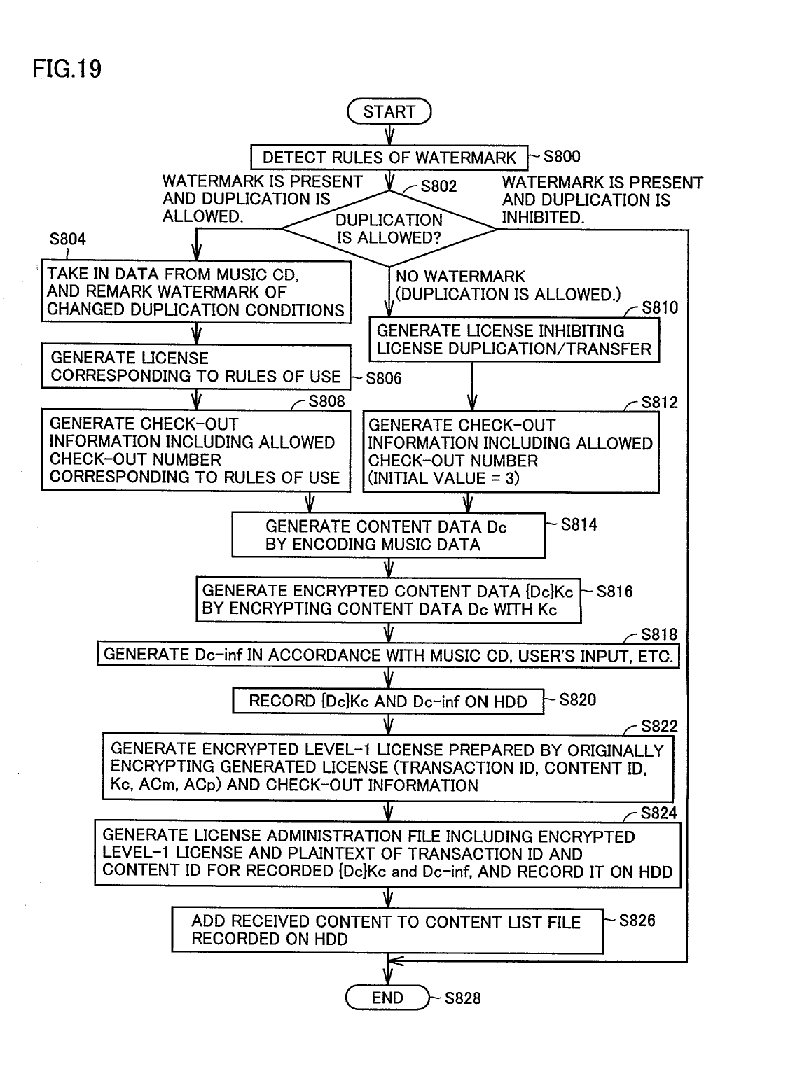

Referring to FIGS. 18 and 19, description will now be given on the operation of obtaining the encrypted content data and the license by ripping from music CD 60 storing music data.

FIG. 18 is a function block diagram showing a function of software for ripping the music data read from a music CD 60 by CD-ROM drive 540 provided in personal computer 50 shown in FIG. 6. The software for ripping the music data includes a watermark detection unit 5400, a watermark determination unit 5401, a remark unit 5402, a license generation unit 5403, a music encoder unit 5404 and an encryption unit 5405.

Watermark detection unit 5400 detects the watermark from the music data obtained from music CD 60, and extracts the rules of use described therein. Watermark determination unit 5401 determines the result of detection by watermark detection unit 5400, and thus determines whether the watermark is detected or not. If detected, watermark determination unit 5401 determines whether the ripping is allowed or not, based on the rules of use described by the watermark. The fact that the ripping is allowed means that there is not rule of use defined in the watermark, or that the rules of use allowing duplication and transfer of the music data recorded on music CD 60 are described by the watermark. The fact that the ripping is not allowed means that the rules of use inhibiting duplication and transfer of the music data recorded on music CD 60 are described by the watermark.

If the rippling is allowed according to the result of determination by watermark determination unit 5401, and the instruction of duplication generation is present (i.e., if the duplication and transfer of the music data are allowed), remark unit 5402 changes the watermark in the music data for another watermark describing changed duplication conditions of music data. However, in the case where the analog signal is supplied for ripping, the encoded music data is input or music data distributed by another distribution system is input, the watermark is necessarily changed regardless of the contents of the rules of use as long as the ripping is allowed. In this case, if there is an instruction relating to the duplication generation, the contents of rules of use are changed. Otherwise, the obtained rules of use are used as they are.

License generation unit 5403 generates the license based on the result of determination by watermark determination unit 5401. Music encoder 5404 encodes the music data bearing the watermark, which is changed by remark unit 5402, into a predetermined format. Encryption unit 5405 encrypts the music data sent from music encoder 5404 with license key Kc included in the license, which are generated by license generation unit 5403.

Referring to FIG. 19, description will now be given on the ripping operation by controller 510 in personal computer 50. When the ripping operation starts, watermark detection unit 5400 detects the rules of use in the watermark based on the data, which is detected from music CD 60 (step S800). Watermark determination unit 5401 performs the determination based on the result of detection by watermark detection unit 5400 and the rules of use recorded in the watermark, and more specifically determines whether the duplication is allowed or not (step S802). In a certain case, the watermark is detected, the rules of use allow duplication, and access control information ACm and reproduction control information ACp in the licenses can comply with the contents of rules of use. In this case, it is determined that the ripping is allowed, and the operation moves to a step S804. In another case, the watermark may be detected, but the rules of use may inhibit duplication, or access control information ACm and reproduction control information ACp in the licenses may not comply with the contents of rules of use. In this case, it is determined that the ripping is inhibited, and the operation moves to a step S828 for ending the ripping operation. If music CD 60 in the drive does not contain the watermark, the operation moves to a step S810.

When it is determined in step S802 that the ripping is allowed, the music data is taken out from music CD 60, and remark unit 5402 changes the watermark included in the music data for a new watermark describing the changed duplication conditions (step S806). If the rules of use of the original watermark allows the duplication to the third generation, the changed watermark allows the duplication to the second generation. License generation unit 5403 generates the license reflecting the rules of use, and thus generates the license allowing the duplication to the second generation (step S806). Thereafter, license generation unit 5403 generates the check-out information including the allowed check-out number reflecting the rules of use (step S808). The allowed check-out number is equal to 3 unless otherwise specified.

In step S802, if the watermark is not detected, license generation unit 5403 generates a license inhibiting the duplication and transfer of the license (step S810). Thereafter, license generation unit 5403 generates check-out information including the allowed check-out number, of which initial value is equal to 3 (step S812).

After step S808 or S812, music encoder 5404 encodes the music data, which bears the changed watermark, in a predetermined format to generate content data Dc (step S814). Encryption processing unit 5405 encrypts the music data sent from music encoder 5404 with license key Kc included in the license, which is generated by license generation unit 5403, to generate encrypted content data {Dc}Kc (step S816). Thereafter, additional information Dc-inf of content data Dc is generated by the information included in music data or entered by the user through keyboard 560 of personal computer 50 (step S818).

Thereby, controller 510 of personal computer 50 obtains encrypted content data {Dc}Kc and additional information Dc-inf via bus BS2, and records them on HDD 530 (step S820). Controller 510 generates the encrypted extended license by effecting unique encryption on received licenses (transaction ID, content ID, license key Kc, access control information ACm and reproduction control information ACp) and the generated check-out information (step S822). Thereafter, controller 510 generates the license administration file, which includes the encrypted extended license and the plaintext of transaction ID and content ID, for the encrypted content data {Dc}Kc and the additional information Dc-inf recorded on HDD 530, and records them on HDD 530 (step S824). Finally, controller 510 adds the file name of the accepted content in the content list file recorded on HDD 530 (step S826). Thereby, the ripping operation ends (step S828).

As described above, the encrypted content data and the license can be obtained also by the ripping from the music CD, and the obtained licenses are protected and administered together with the content distributed from distribution server 10.

[Transfer]

In the data distribution systems shown in FIGS. 1 and 2, the encrypted content data and the license, which are distributed from distribution server 10 to license administration device 520, are sent to memory card 110 attached to cellular phone 100 or reproduction terminal 102. Description will now be given on this operation, which will be referred to as “transfer”.

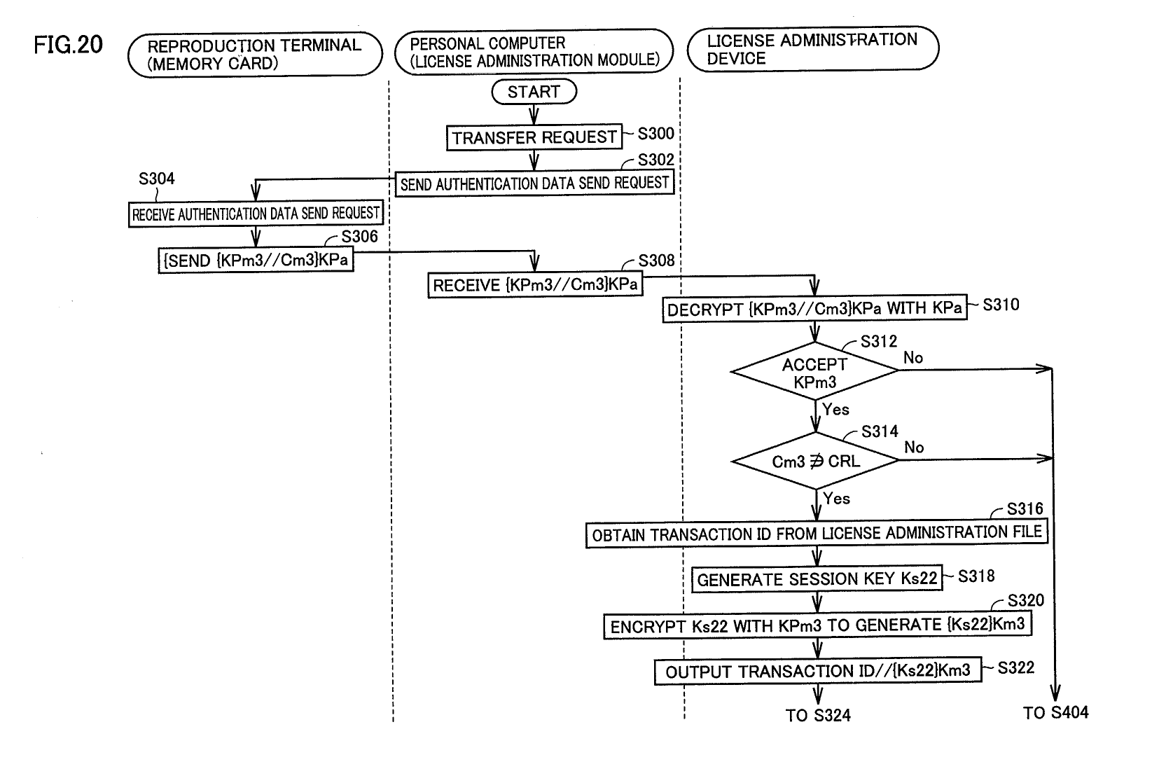

FIGS. 20-23 are first to fourth flowcharts of the transfer operation performed in each of the data distribution systems shown in FIGS. 1 and 2 for transferring the encrypted content data and the license received by license administration device 520 from distribution server 10 to memory card 110 attached to cellular phone 100 or reproduction terminal 102. Since personal computer 50 or reproduction terminal 102 operates merely to relay the data even in the transfer operation, and therefore is not shown in the flowcharts. The following description is given on the case of transfer to memory card 110 attached to reproduction terminal 102 in FIG. 2. However, transfer to memory card 110 attached to cellular phone 100 in FIG. 1 is performed in a similar manner except for that cellular phone 100 functions instead of reproduction terminal 102.

Before the processing shown in FIG. 20, the user of personal computer 50 determines the content to be checked out in accordance with the content list file, and specifies the content file and the license administration file. The following description is based on the premise that the above operation is already performed.

Referring to FIG. 20, when the user enters the transfer request through keyboard 560 of personal computer 50 (step S300), controller 510 sends the send request of the authentication data to reproduction terminal 102 via USB interface 550, terminal 580 and USB cable 70 (step S302). Thereby, controller 1106 of reproduction terminal 102 receives the send request for the authentication data via terminal 1114, USB interface 1112 and bus BS3, and sends the send request for the authentication data to memory card 110 via bus BS3 and memory card interface 1200. Controller 1420 of memory card 110 receives the send request for the authentication data via terminal 1426, interface 1424 and bus BS4 (step S304).

When controller 1420 receives the send request of authentication data, it reads out authentication data {KPm3//Cm3}KPa from authentication data holding unit 1400 via bus BS4, and outputs authentication data {KPm3//Cm3}KPa thus read to reproduction terminal 102 via bus BS4, interface 1424 and terminal 1426. Controller 1106 of reproduction terminal 102 receives authentication data {KPm3//Cm3}KPa via memory card interface 1200 and bus BS3, and sends authentication data {KPm3//Cm3}KPa to personal computer 50 via bus BS3, USB interface 1112, terminal 1114 and USB cable 70 (step S306).

Thereby, controller 510 of personal computer 50 receives authentication data {KPm3//Cm3}KPa via license administration module 511, terminal 580 and USB interface 550 (step S308), and sends authentication data {KPm3//Cm3}KPa thus received to license administration device 520 via bus BS2. Controller 5220 of license administration device 520 receives authentication data {KPm3//Cm3}KPa via a terminal 5226, an interface 5224 and bus BS5, and applies the received authentication data {KPm3//Cm3}KPa to decryption processing unit 5208. Decryption processing unit 5208 decrypts authentication data {KPm3//Cm3}KPa with authentication key KPa sent from KPa hold unit 5214 (step S310). Controller 5220 performs the authentication processing based on the result of decryption by decryption processing unit 5208 for determining whether the decryption is performed correctly or not, and thus whether it receives or not the authentication data, which is encrypted for certifying its validity by a legal system, from legal memory card 110 for authenticating the fact that memory car 110 holds legal class public encryption key KPm3 and class certificate Cm3 (step S312). If it is determined that the authentication data is valid, controller 5220 approves and accepts class public encryption key KPm3 and class certificate Cm3. The operation moves to next processing in a step S314. If the authentication data is not valid, controller 5220 does not approve class public encryption key KPm3 and class certificate Cm3, and the processing ends without accepting these keys (S404).

License administration device 520 holds only public authentication key KPa corresponding to level 2. Therefore, if the request is sent from license administration module 511 having the security level 1, the authentication is failed, and the processing ends so that transfer from level 2 to level 1 is impossible.

When it is determined from the result of authentication that the memory card is legal, controller 5220 then refers to CRL region 5215A to determine whether class certificate Cm3 of memory card 110 is listed up in the certificate revocation list CRL. If this class certificate is listed up in the certificate revocation list, the transfer operation ends (step S404).

If the class certificate of memory card 110 is not listed in the certificate revocation list CRL, next processing starts (step S314).

When it is determined from the result of authentication that the access is made from the reproduction terminal equipped with the memory card having valid authentication data, and the class is not listed in the certificate revocation list CRL, license administration device 520 obtains by controller 5220 the transaction ID, which is the administration code, from license region 5215B in memory 5215 (step S316). Session key generator 5218 generates session key Ks22 for transfer (step S318). Session key Ks22 is encrypted by encryption processing unit 5210 with class public encryption key KPm3 corresponding to memory card 110 and obtained by decryption processing unit 5208 (step S320). Controller 5220 obtains encrypted data {Ks22}Km3 via bus BS5, and outputs the transaction ID//{Ks22}Km3, which is prepared by adding transaction ID obtained from memory 5215 to encrypted data {Ks22}Km3, via bus BS5, interface 5224 and terminal 5226 (step S322).

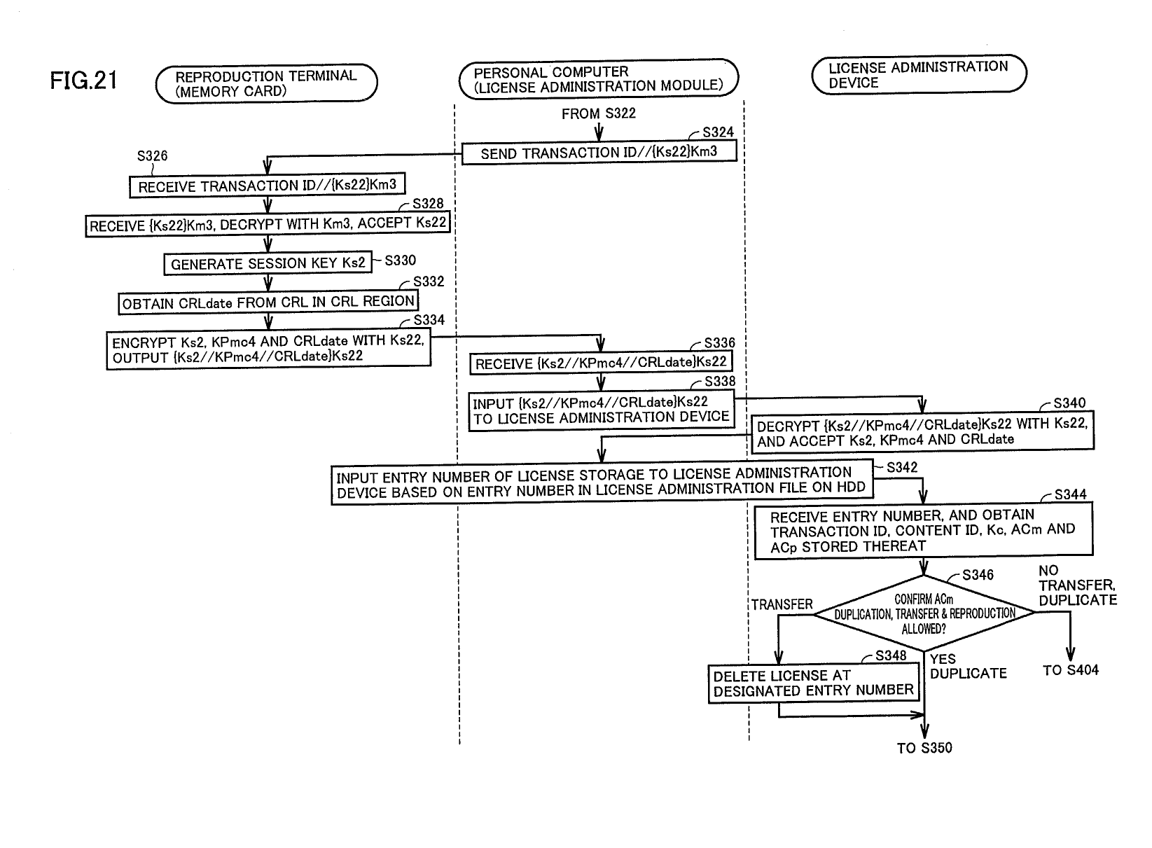

Referring FIG. 21, controller 510 of personal computer 50 receives dummy transaction ID//{Ks22}Km3 via terminal bus BS2 (step S324), and sends transaction ID//{Ks22}Km3 thus received to reproduction terminal 102 via USB interface 550, terminal 580 and USB cable 70 (step S324). Controller 1106 of reproduction terminal 102 receives transaction ID//{Ks22}Km3 via terminal 1114, USB interface 1112 and bus BS3, and sends the received transaction ID//{Ks22}Km3 to memory card 110 via memory card interface 1200. Controller 1420 of memory card 110 receives transaction ID//{Ks22}Km3 via terminal 1426, interface 1424 and bus BS4 (S326). Decryption processing unit 1422 receives encrypted data {Ks22}Km3 from controller 1420 via bus BS4, and decrypts encrypted data {Ks22}Km3 with class private decryption key Km3 sent from Km hold unit 1421. Thereby, decryption processing unit 1422 accepts session key Ks22 (step S328). Session key generator 1418 generates session key Ks2 (step S330). Controller 1420 obtains update date/time CRLdate of the certificate revocation list CRL from CRL region 1415A of memory 1415 via bus BS4, and applies the update date/time CRLdate thus obtained to selector switch 1446 (step S332).

Thereby, encryption processing unit 1406 encrypts session key Ks2, unique public encryption key KPmc4 and update date/time CRLdate of the certificate revocation list, which are obtained by successively selecting the contacts of switch 1446, with session key Ks22, which is decrypted by decryption processing unit 1404, to generate encrypted data {Ks2//KPmc4//CRLdate}Ks22 as one data row. Controller 1420 outputs encrypted data {Ks2//KPmc4//CRLdate}Ks22 to reproduction terminal 102 via bus BS4, interface 1424 and terminal 1426. Controller 1106 of reproduction terminal 102 receives encrypted data {Ks2//KPmc4//CRLdate}Ks22 via memory card interface 1200. Controller 1106 sends it to personal computer 50 via USB interface 1112, terminal 1114 and USB cable 70 (step S334).

Controller 510 of personal computer 50 receives encrypted data {Ks2//KPmc4//CRLdate}Ks22 via terminal 580 and USB interface 550 (step S336), and inputs encrypted data {Ks2//KPmc4//CRLdate}Ks22 thus received to license administration device 520 via bus BS2 (step S338). Controller 5220 of license administration device 520 receives encrypted data {Ks2//KPmc4//CRLdate}Ks22 via terminal 5226, interface 5224 and bus BS5, and applies encrypted data {Ks2//KPmc4//CRLdate}Ks22 thus received to decryption processing unit 5212. Decryption processing unit 5212 decrypts encrypted data {Ks2//KPmc4//CRLdate}Ks22 with session key Ks22 generated by session key generator 5218, and accepts session key Ks2, public encryption key KPmc4 and updates date/time CRLdate of the certificate revocation list (step S340).

Controller 510 of personal computer 50 reads out the entry number of the license included in the license administration file, which is stored in step S324, from HDD 530. Controller 510 inputs the entry number thus read to license administration device 520 via bus BS2 (step S342). Controller 5220 of license administration device 520 receives the entry number via terminal 5226, interface 5224 and bus BS5, and reads out the licenses (transaction ID, content ID, license key Kc, access control information ACm and reproduction control information ACp) from the entry in license region 5215B of memory 5215 designated by the entry number (step S344).

Controller 5220 then determines access control information ACm (step S346). More specifically, based on the access control information ACm thus obtained, controller 5220 first determines whether the license to be transferred to memory card 110 attached to reproduction terminal 102 is the license, by which the encrypted content data cannot be reproduced due to the number of reproduction times. If there is no allowed reproduction time (allowed reproduction times=0), the encrypted content data cannot be reproduced with the license so that it is meaningless to transfer the encrypted content data and the license to memory card 110 attached to reproduction terminal 102. For this reason, the above determination is performed. If the reproduction is allowed, it is determined based on the transfer/duplication flags whether the duplication and transfer of the license are allowed or not.

In step S346, if the encrypted content data cannot be reproduced (reproduction times=0),

or the transfer/duplication flag inhibits the transfer and duplication (=0), it is determined from access control information ACm that the transfer and duplication are impossible. Thereby, the operation moves to step S404, and the transfer operation ends. If it is determined in step S346 that the reproduction content data can be produced (reproduction times≈0), and the transfer/duplication flag is equal to “1”, and thus allows only the transfer, it is determined that the license transfer is to be performed, and controller 510 deletes the license at the designated entry number in license region 5215B of memory 5215 (step S348). The operation moves to a step S350. If the reproduction content data can be produced (reproduction times≈0), and the transfer/duplication flag is equal to “3”, and thus allows the duplication, the operation moves to a step S350 without performing the operation in step S348.

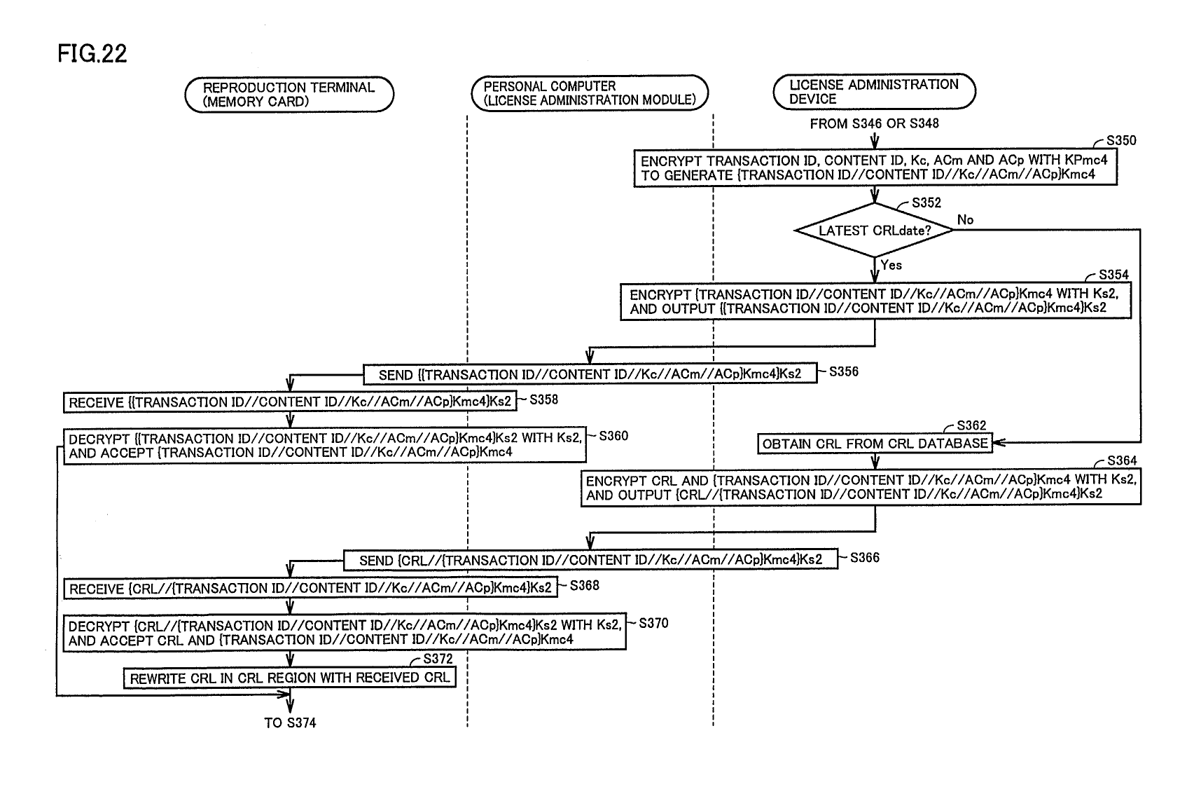

Referring to FIG. 22, encryption processing unit 5217 encrypts the license with public encryption key KPmc4 unique to license administration device 520, which is obtained by decryption processing unit 5212, to generate encrypted data {transaction ID//content ID//Kc//ACm//ACp}Kmc4 (step S350). Comparison is made between update date/time CRLdate of the certificate revocation list sent from memory card 110 and the update data/time of the certificate revocation list held at CRL region 5215A for determining the newer certificate revocation list CRL. If the certificate revocation list of license administration device 520 is not newer than the other, the operation moves to a step S354. If the list of license administration device 520 is newer than the other, the operation moves to a step S362 (step S352).

If it is determined that the certificate revocation list of license administration device 520 is not newer than the other, encryption processing unit 5206 encrypts encrypted data {transaction ID//content ID//Kc//ACm//ACp}Kmc4 with session key Ks2 generated by session key generator 5218, and outputs encrypted data {{transaction ID//content ID//Kc//ACm//ACp}Kmc4}Ks2 onto bus BS5. Controller 5220 sends encrypted data {{transaction ID//content ID//Kc//ACm//ACp}Kmc4}Ks2 on bus BS5 to personal computer 50 via interface 5224 and terminal 5226 (step S354).

Controller 510 of personal computer 50 receives encrypted data {{transaction ID//content ID//Kc//ACm//ACp}Kmc4}Ks2 via bus BS2, and sends it to reproduction terminal 102 via USB interface 550, terminal 580 and USB cable 70 (step S356).

Controller 1106 of reproduction terminal 102 receives encrypted data {{transaction ID//content ID//Kc//ACm//ACp}Kmc4}Ks2 via terminal 1114, USB interface 1112 and bus BS3, and sends encrypted data {{transaction ID//content ID//Kc//ACm//ACp}Kmc4}Ks2 thus received to memory card 110 via bus BS3 and memory card interface 1200. Controller 1420 of memory card 110 receives encrypted data {{transaction ID//content ID//Kc//ACm//ACp}Kmc4}Ks2 via terminals 1426, interface 1424 and bus BS4 (step S358).

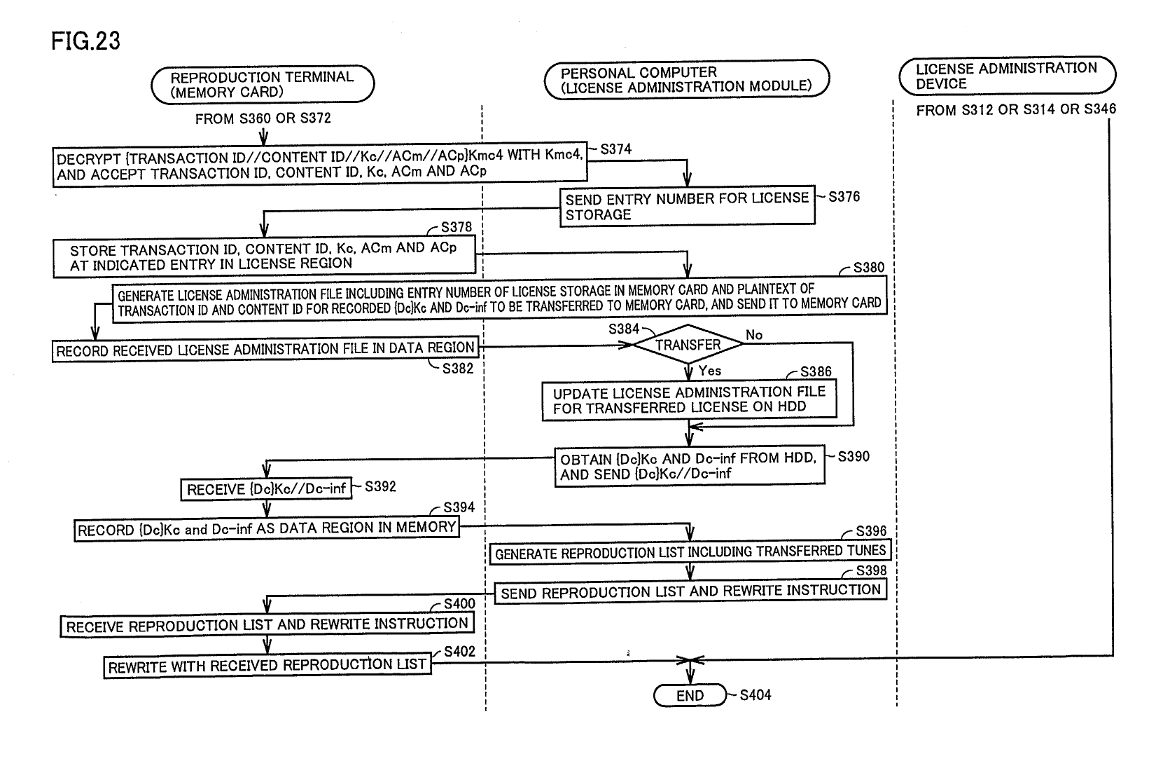

Decryption processing unit 1412 of memory card 110 receives encrypted data {{transaction ID//content ID//Kc//ACm//ACp}Kmc4}Ks2 via bus BS4, and decrypts it with session key Ks2 generated by session key generator 1418 for accepting {transaction ID//content ID//Kc//ACm//ACp}Kmc4 (step S360). Thereafter, the operation moves to step S374 shown in FIG. 23.

If it is determined in step S352 that the certificate revocation list of license administration device 520 is newer than the other, controller 5220 of license administration device 520 obtains data CRL of the certificate revocation list from CRL region 5215A of memory 5215 via bus BS5 (step S362).

Encryption processing unit 5206 receives the output of encryption processing unit 5217 via switch 5246, data CRL of the certificate revocation list obtained by controller 5220 from memory 5215 via bus BS5 and switches 5246 and session key Ks2 via switch 5242 from decryption processing unit 5212, and encrypts them with session key Ks2 generated by session key generator 5218. Encrypted data {CRL//{transaction ID//content ID//Kc//ACm//ACp}Kmc4}Ks2 output from encryption processing unit 5206 is output to personal computer 50 via bus BS5, interface 5224 and terminal 5226 (step S364).

Controller 510 of personal computer 50 receives encrypted data {CRL//{transaction ID//content ID//Kc//ACm//ACp}Kmc4}Ks2, and outputs encrypted data {CRL//{transaction ID//content ID//Kc//ACm//ACp}Kmc4}Ks2 thus received to reproduction terminal 102 via USB interface 550, terminal 580 and USB cable 70 (step S366). Controller 1106 of reproduction terminal 102 receives encrypted data {CRL//{transaction ID//content ID//Kc//ACm//ACp}Kmc4}Ks2 via terminal 1114, USB interface 1112 and bus BS3, and sends encrypted data {CRL//{transaction ID//content ID//Kc//ACm//ACp}Kmc4}Ks2 to memory card 110 via bus BS3 and memory card interface 1200. Thereby, controller 1420 of memory card 110 receives encrypted data {CRL//{transaction ID//content ID//Kc//ACm//ACp}Kmc4}Ks2 via terminal 1426, interface 1424 and bus BS4 (step S368).

In memory card 110, decryption processing unit 1412 decrypts the received data on bus BS4 with session key Ks2 applied from session key generator 1418, and accepts CRL and {transaction ID//content ID//Kc//ACm//ACp}Kmc4 (step S370). Controller 1420 receives data CRL, which is accepted by decryption processing unit 1412, via bus BS4, and rewrites CRL region 1415A of memory 1415 with received data CRL (step S372).

In steps S354, S356, S358 and S360, the operations are performed to move license key Kc and others to memory card 110, and the transfer operations in these steps are performed in the case where certificate revocation list CRL of license administration device 520 on the sending side is not newer than certificate revocation list CRL of memory card 110 on the receiving side. The operations in steps S362, S374, S366, S368, S370 and S372 are performed for moving session key Ks and others to memory card 110 in the case where certificate revocation list CRL of license administration device 520 on the sending side is newer than certificate revocation list CRL of memory card 110 on the receiving side. By these operations, determination is performed one by one based on update date/time CRLdate sent from license administration device 520, and the certificate revocation list CRL, which is as newer as possible, is stored in CRL region 1514A as certificate revocation list CRL of memory card 110. Thereby, it is possible to prevent provision of the license to the content reproduction circuit and recording device, of which security is broken, for example, private key is leaked out.

After steps S360 or S372, as shown in FIG. 23, controller 1420 instructs decryption processing unit 1404 to decrypt encrypted data {transaction ID//content ID//Kc//ACm//ACp}Kmc4 with private decryption key Kmc4, and licenses (license key Kc, transaction ID, content ID, ACm and ACp) are accepted (step S374).

Controller 510 of personal computer 50 sends the entry number for storing the licenses, which are transferred to memory card 110, to reproduction terminal 102 via USB interface 550, terminal 580 and USB cable 70. Thereby, controller 1106 of reproduction terminal 102 receives the entry number via terminal 1114, USB interface 1112 and bus BS3, and sends it to memory card 110 via bus BS3 and memory card interface 1200. Controller 1420 of memory card 110 receives the entry number via terminal 1426 and interface 1424, and stores licenses (license key Kc, transaction ID, content ID, access control information ACm and reproduction control information ACp), which are obtained in step S374, in license region 1415B of memory 1415 designated by the received entry number (step S378).

Controller 510 of personal computer 50 generates the license administration file, which includes the entry number of license stored in memory 1415 of memory card 110, the plaintext of transaction ID and the content ID, for encrypted content data {Dc}Kc to be moved to memory card 110 and additional information Dc-inf, and sends it to memory card 110 (step S380).

Controller 1420 of memory card 110 receives license administration file via reproduction terminal 102, and records the received license administration file in data region 1415C of memory 1415 (step S382).

Controller 510 of personal computer 50 operates in accordance with the determination in step S346 (step S384). If it is determined that the transfer is performed, controller 510 erases the license entry number in the license administration file for the transferred license among the licenses recorded on HDD 530, and updates to “license no” (step S386). Thereafter, controller 510 obtains encrypted content data {Dc}Kc and additional information to be transferred to memory card 110, and sends {Dc}Kc//Dc-inf to memory card 110 (step S390). Controller 1420 of memory card 110 receives {Dc}Kc//Dc-inf via reproduction terminal 102 (step S392), and records {Dc}Kc//Dc-inf, which is received via bus BS4, at data region 1415C in memory 1415 via bus BS4 as the content file (step S394).

Thereby, controller 510 of personal computer 50 prepares the reproduction list additionally including the tunes (step S396), which are transferred to memory card 110, and sends the reproduction list and the instruction of rewriting the reproduction list to memory card 110 (step S398). Controller 1420 of memory card 110 receives the reproduction list file and the rewriting instruction via reproduction terminal 102 (step S400), and rewrites the reproduction list file, which is recorded in data region 1415C of memory 1415, with the received reproduction list file via bus BS4 (step S402). Thereby, the transfer operation ends (step S404).

As described above, it is determined that memory card 110 attached to reproduction terminal 102 is the legal or valid device, and at the same time, it is determined that public encryption key KPm3, which can be encrypted and sent together with class certificate Cm3, is valid. After determining these facts, the content data can be transferred only based on the transfer request to the memory card having class certificate Cm3 not listed in the certificate revocation list (i.e., the memory card not mentioned in the certificate revocation list of class certificates, of which encryption with public encryption key KPm3 is broken). It is possible to inhibit the transfer to unauthorized memory card as well as the transfer using the descrambled or leaked out class key.

The encryption keys generated in the license administration device 520 and the memory card 110 are transmitted between them. Each of the module and the card executes the encryption with the received encryption key, and sends the encrypted data to the other so that the mutual authentication can be practically performed even when sending and receiving the encrypted data, and it is possible to improve the security in the operation of transferring the encrypted content data and the license.

Although the operation has been described as the transfer operation, the operation is executed as the duplication, and the license will be held by license administration device 520 on the sending side as it is, if the content supplier has permitted the duplication of the license. The duplication in this case is the action allowed only in such a case that the content supplier holding the copyright permits the duplication at the time of distribution, and the transfer/duplication flag of access control information ACm is set to the state allowing the transfer and duplication. Therefore, the aforementioned duplication is not the action infringing on the right of the copyright holder. Access control information ACm is a part of license, and the security thereof is ensured so that the copyright is protected.

By using the transfer operation described above, even the user of reproduction terminal 102 not having a function of communicating with distribution server 10 can record the encrypted content data and the license through personal computer 50 in memory card 110. This improves the user convenience.

In the operation described above, the license is transferred from license administration device 520 of personal computer 50 to memory card 110. The transfer of license from memory card 110 to license administration device 520 is performed in accordance with the flowcharts shown in FIGS. 20-23. In FIG. 1, cellular phone 100 receives the distribution to store the encrypted content data and the license in memory card 110, and these data and license can be saved in personal computer 50.

Personal computer 50 can transfer the license, which is received from distribution server 10, to memory card 110 only if it is the license received by license administration device 520 via hardware from distribution server 10. The encrypted content data and the license, which are received by license administration module 511 via software from distribution server 10, cannot be sent to memory card 110 based on the concept of “transfer”. License administration module 511 transmits the authentication data, encryption key and others to and from distribution server 10 by software with a lower security level than license administration device 520 when it receives the encrypted content data and the license. Therefore, the possibility that the encryption is broken in the receiving operation is higher than that in the case of receiving the encrypted content data and the license by license administration device 520. Accordingly, if it were allowed to transfer freely the encrypted content data and the license, which are received and administered with a low security level, based on the concept of “transfer” to memory card 110, which receives and administers the encrypted content data and the license with the same security level as license administration device 520, this would lower the security level in memory card 110. For preventing this, the foregoing manners and operations inhibit the encrypted content data and the license received by license administration module 511 from being sent to memory card 110 based on the concept of “transfer”.

However, if such a system were employed that the encrypted content data and the license, which is received by license administration module 511 and has a low security level, cannot be transferred to memory card 110 at all, this runs counter the spirit of the data distribution system, which is intended to allow free copying of content data while protecting the copyrights, and does not improve the user convenience. Accordingly, based on the concepts of “check-out” and “check-in”, which will be described below, the encrypted content data and the license received by license administration module 511 can be sent to memory card 110.

[Check-Out]

In the data distribution systems shown in FIGS. 1 and 2, the encrypted content data and the license, which is distributed from distribution server 10 to license administration module 511 of personal computer 50, is sent to memory card 110 attached to reproduction terminal 102. Description will now be given on this operation, which will be referred to as “check-out”.

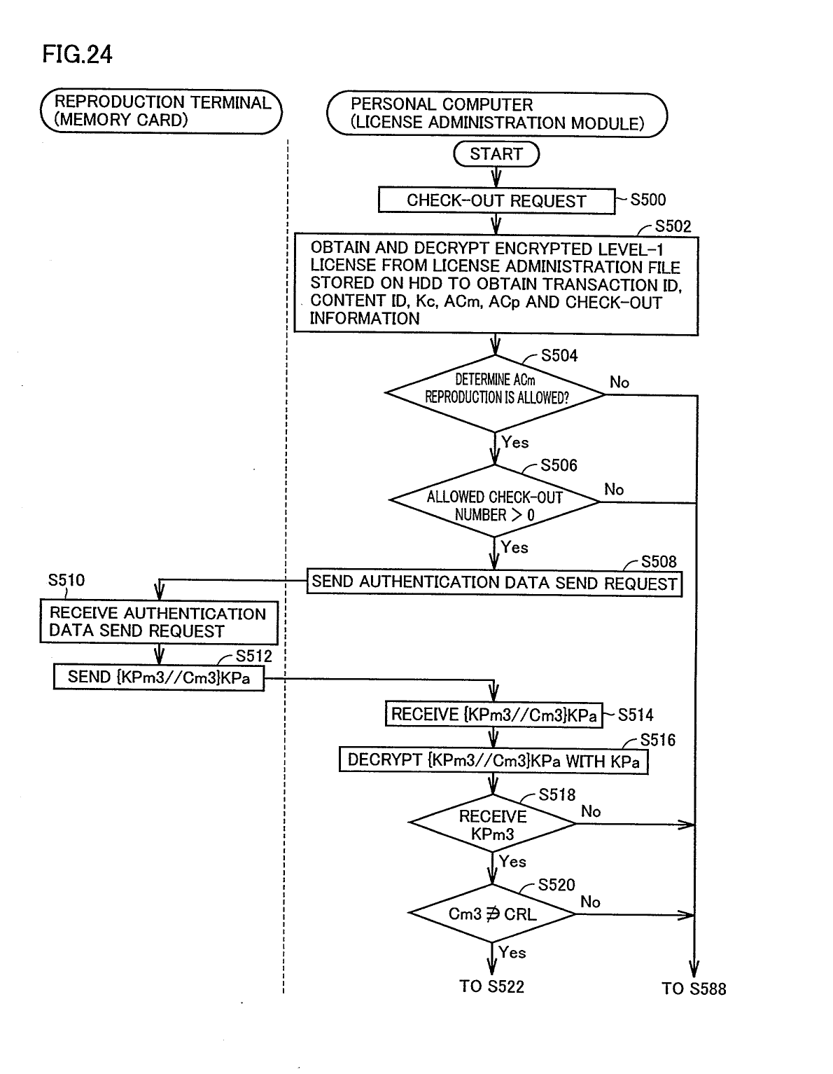

FIGS. 24-27 are first to fourth flowcharts of the check-out operation performed in the data distribution systems shown in FIGS. 1 and 2, respectively. In the check-out operation, the encrypted content data and the license received by license administration module 511 from distribution server 10 are given to memory card 110 attached to reproduction terminal 102 on the condition that these will be returned. Since cellular phone 100 or reproduction terminal 102 operates merely to relay the data even in the check-out, and therefore is not shown in the flowcharts. The following description is given on the case of transfer to memory card 110 attached to reproduction terminal 102 in FIG. 2. However, transfer to memory card 110 attached to cellular phone 100 in FIG. 1 is performed in a similar manner except for that cellular phone 100 functions instead of reproduction terminal 102.

Before the processing shown in FIG. 24, the user of personal computer 50 determines the content to be checked out in accordance with the content list file, and specifies the content file and the license administration file. The following description is based on the premise that the above operation is already performed.

Referring to FIG. 24, when the user enters the check-out request through keyboard 560 of personal computer 50 (step S500), controller 510 obtains the encrypted license data from the license administration file recorded on HDD 530. In this case, the license administration file stores the encrypted level-1 extended license, which is prepared by receiving the encrypted content data and license by license administration module 511 and effecting unique encryption thereon (see step S266 in FIG. 17). License administration module 511 obtains the encrypted level-1 extended license of the encrypted license data to be checked out from the license administration file, and decrypts it to obtain licenses (transaction ID, content ID, license key Kc, access control information ACm and reproduction control information ACp) and check-out information (step S502).

License administration module 511 determines access control information ACm (step S504). More specifically, license administration module 511 determines, based on the obtained access control information ACm, whether the license to be checked out to memory card 110 attached to reproduction terminal 102 does not include the information specified by access correlation information ACm and relating to the reproduction times of the encrypted content data or not, or whether the above license inhibits the reproduction or not. If the reproduction times are restricted, the encrypted content data cannot be reproduced with the checked-out license, and it is meaningless to check out the encrypted content data and the license to memory card 110 attached to reproduction terminal 102.

If the reproduction is restricted in step S504, the operation moves to step S588, and the check-out operation ends. In step S504, if there is no restriction on the reproduction, the operation moves to step S506. License administration module 511 determines whether the allowed check-out number included in the obtained check-out information is larger than 0 or not (step S506). If the allowed check-out number is 0 or less in step S506, there is no license for check-out so that the operation moves to step S588, and the check-out operation ends. If the allowed check-out number is larger than 0 in step S506, license administration module 511 sends the send request of the authentication data via USB interface 550, terminal 580 and USB cable 70 (step S508). Controller 1106 of reproduction terminal 102 receives the send request of the authentication data via terminal 1114, USB interface 1112 and bus BS3, and sends the received request for sending the authentication data to memory card 110 via bus BS3 and memory card interface 1200. Controller 1420 of memory card 110 receives the send request of authentication data via terminal 1426, interface 1424 and bus BS4 (step S510).

When controller 1420 receives the send request of authentication data, it reads out authentication data {KPm3//Cm3}KPa from authentication data hold unit 1400 via bus BS4, and outputs authentication data {KPm3//Cm3}KPa thus read to reproduction terminal 102 via bus BS4, interface 1424 and terminal 1426. Controller 1106 of reproduction terminal 102 receives authentication data {KPm3//Cm3}KPa via memory card interface 1200 and bus BS3, and sends authentication data {KPm3//Cm3}KPa to personal computer 50 via bus BS3, USB interface 1112, terminal 1114 and USB cable 70 (step S512).

Thereby, license administration module 511 of personal computer 50 receives authentication data {KPm3//Cm3}KPa via terminal 580 and USB interface 550 (step S514), and decrypts received authentication data {KPm3//Cm3}KPa with authentication key KPa (step S516). License administration module 511 performs the authentication processing based on the result of decryption for determining whether the decryption is performed correctly or not, and thus whether it receives or not the authentication data, which is encrypted for certifying its validity by a legal system, from the memory card 110 for authenticating the fact that memory card 110 holds legal class public encryption key KPm3 and class certificate Cm3 (step S518). If it is determined that the authentication data is valid, license administration module 511 approves and accepts class public encryption key KPm3 and class certificate Cm3. The operation moves to next processing in a step S520. If the authentication data is not valid, license administration module 511 does not approve class public encryption key KPm3 and class certificate Cm3, and the processing ends without accepting these keys (S588).

Since license administration module 511 holds only pubic authentication key KPb corresponding to level 1, only the check-out with the security level of 1 can be performed.

When it is authenticated that it is the legal memory card, license administration module 511 then refers to HDD 530 to determine whether class certificate Cm3 of memory card 110 is listed up in certificate revocation list CRL or not. If class certificate Cm3 is listed in certificate revocation list CRL, the check-out operation ends (step S588). If class certificate Cm3 is not listed in certificate revocation list CRL, the operation moves to next processing (step S520).

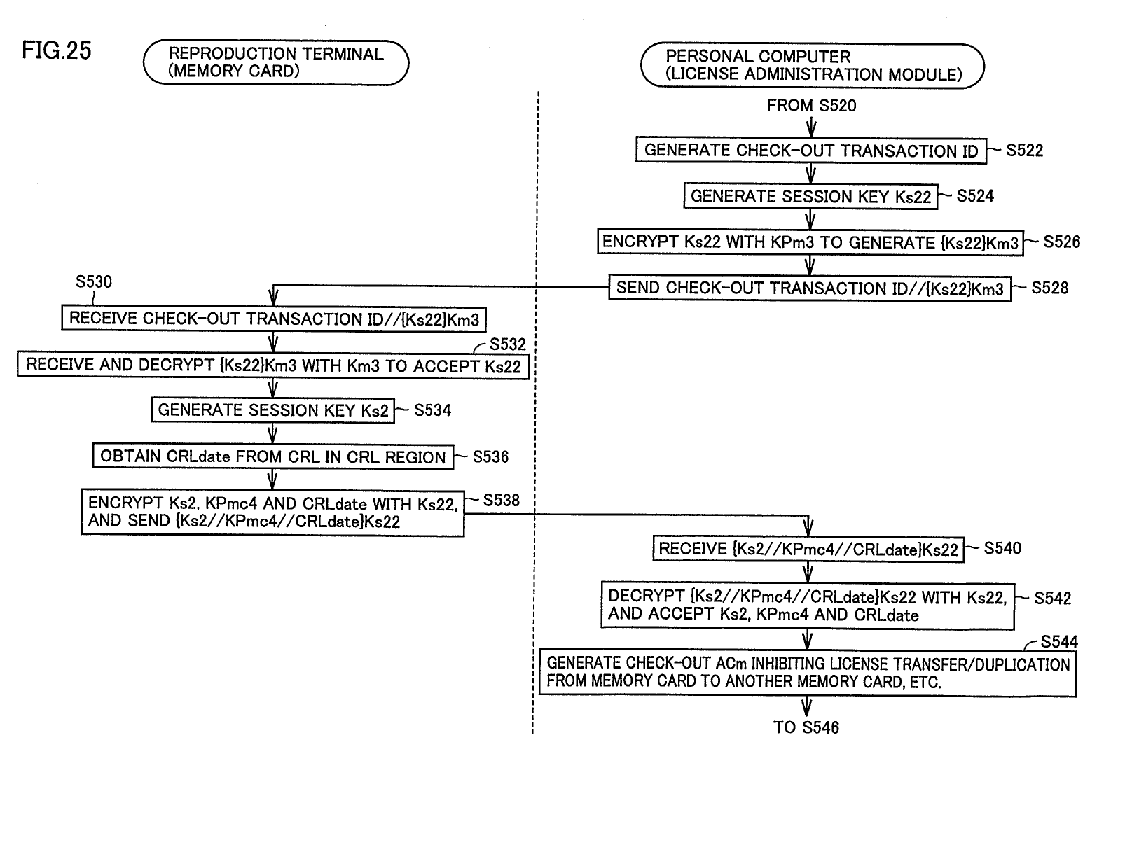

Referring to FIG. 25, if it is determined as a result of the authentication that the access is made from the reproduction terminal provided with the memory card having valid authentication data, and the class is not listed in the certificate revocation list, license administration module 511 generates transaction ID for check-out (i.e., check-out transaction ID), which is the administration code for specifying the checkout (step S522). The check-out transaction ID necessarily takes the value different from all the transaction IDs stored in memory card 110, and is generated as the transaction ID for local use. License administration module 511 generates session key Ks22 for check-out (step S524), and encrypts session key Ks22 thus generated with class public encryption key KPm3 sent from memory card 110 (step S526). License administration module 511 sends check-out transaction ID//{Ks22}Km3, which is prepared by adding check-out transaction ID to encrypted data {Ks22}Km3, to reproduction terminal 102 via USB interface 550, terminal 580 and USB cable 70 (step S528). Thereby, controller 1106 of reproduction terminal 102 receives check-out transaction ID//{Ks22}Km3 via terminal 1114, USB interface 1112 and bus BS3, and sends check-out transaction ID//{Ks22}Km3 thus received to memory card 110 via memory card interface 1200. Controller 1420 of memory card 110 receives transaction ID//{Ks22}Km3 via terminal 1426, interface 1424 and bus BS4 (step S530). Decryption processing unit 1422 receives encrypted data {Ks22}Km3 from controller 1420 via bus BS4, and decrypts encrypted data {Ks22}Km3 with class private decryption key Km3 sent from Km hold unit 1421. Thereby, decryption processing unit 1422 accepts session key Ks22 (step S532). Session key generator 1418 generates session key Ks2 (step S534). Controller 1420 obtains update date/time CRLdate of the certificate revocation list from CRL region 1415A of memory 1415 via bus BS4, and applies the update date/time CRLdate thus obtained to switch 1446 (step S536).

Thereby, encryption processing unit 1406 encrypts session key Ks2, unique public encryption key KPmc4 and update date/time CRLdate, which are obtained by successively selecting the contacts of switch 1446, with session key Ks22 decrypted by decryption processing unit 1422 to generate encrypted data {Ks2//KPmc4//CRLdate}Ks22. Controller 1420 outputs encrypted data {Ks2//KPmc4//CRLdate}Ks22 to reproduction terminal 102 via bus BS4, interface 1424 and terminal 1426. Controller 1106 of reproduction terminal 102 receives encrypted data {Ks2//KPmc4//CRLdate}Ks22 via memory card interface 1200. Controller 1106 sends it to personal computer 50 via USB interface 1112, terminal 1114 and USB cable 70 (step S538).

License administration module 511 of personal computer 50 receives encrypted data {Ks2//KPmc4//CRLdate}Ks22 via terminal 580 and USB interface 550 (step S540), and decrypts encrypted data {Ks2//KPmc4//CRLdate}Ks22 thus received with session key Ks22. Thereby, license administration module 511 receives session key Ks2, unique public encryption key KPmc4 and update date/time CRLdate (step S542). License administration module 511 generates access control information ACm for check-out, which inhibits transfer and duplication of the licenses from the memory card attached to reproduction terminal 102 to another memory card. More specifically, it generates access control information ACm, in which the reproduction times are not restricted (=255), and the transfer/duplication flag is set to 3″ inhibiting the transfer and duplication (step S544).

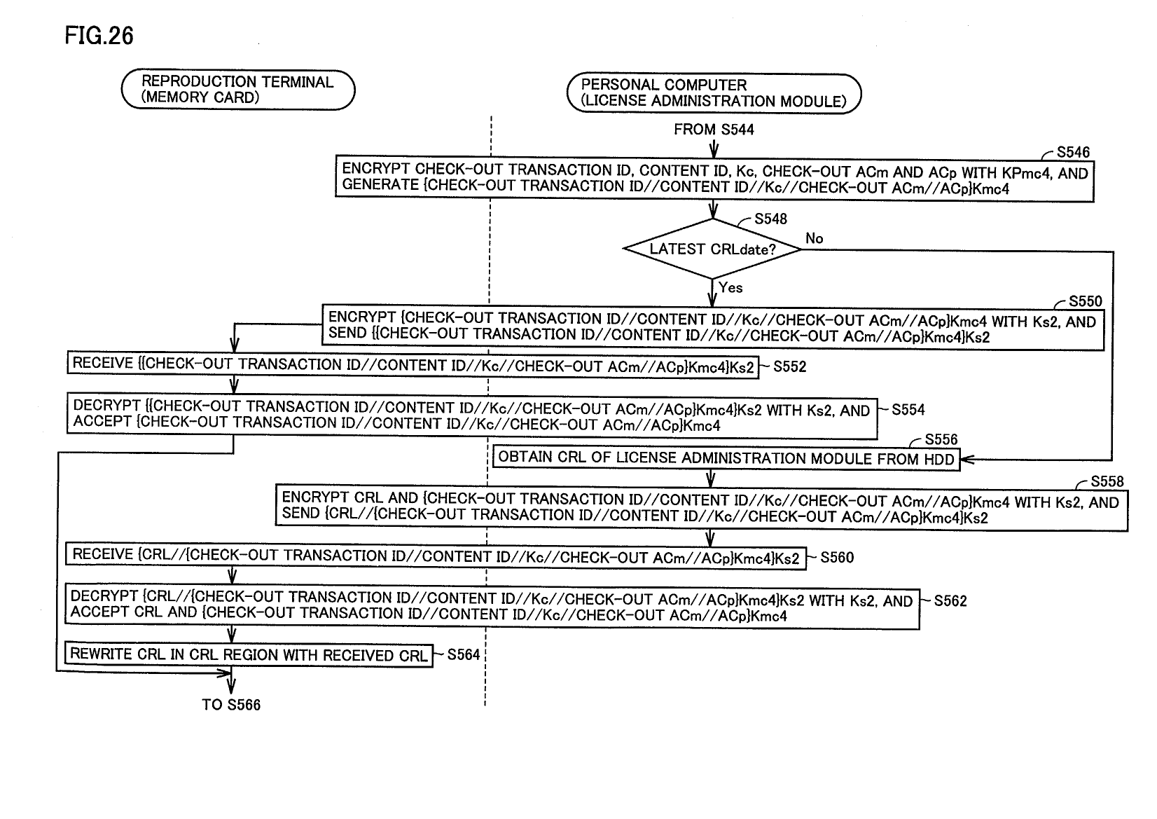

Referring to FIG. 26, license administration module 511 encrypts the license with public encryption key KPmc4 unique to license administration module 511, which is received in step S542, to generate encrypted data {check-out transaction ID//content ID//Kc//check-out ACm//ACp}Kmc4 (step S546). Comparison is made between update date/time CRLdate of the certificate revocation list sent from memory card 110 and the update data/time of the certificate revocation list held on HDD 530 for determining the newer certificate revocation list. If the certificate revocation list of license administration module 511 is not newer than the other, the operation moves to a step S550. If the certificate revocation list CRL of license administration module 511 is newer than the other, the operation moves to a step S556 (step S548).

If it is determined that the certificate revocation list of license administration module 511 is not newer than the other, license administration module 511 encrypts encrypted data {check-out transaction ID//content ID//Kc//check-out ACm//ACp}Kmc4 with session key Ks2, and sends encrypted data {{check-out transaction ID//content ID//Kc//check-out ACm//ACp}Kmc4}Ks2 to reproduction terminal 102 via USB interface 550, terminal 580 and USB cable 70 (step S550).

Controller 1106 of reproduction terminal 102 receives encrypted data {{check-out transaction ID//content ID//Kc//check-out ACm//ACp}Kmc4}Ks2 via terminal 1114, USB interface 1112 and bus BS3, and sends encrypted data {{check-out transaction ID//content ID//Kc//check-out ACm//ACp}Kmc4}Ks2 thus received to memory card 110 via bus BS3 and memory card interface 1200. Controller 1420 of memory card 110 receives encrypted data {{check-out transaction ID//content ID//Kc//check-out ACm//ACp}Kmc4}Ks2 via terminal 1426, interface 1424 and bus BS4 (step S552).

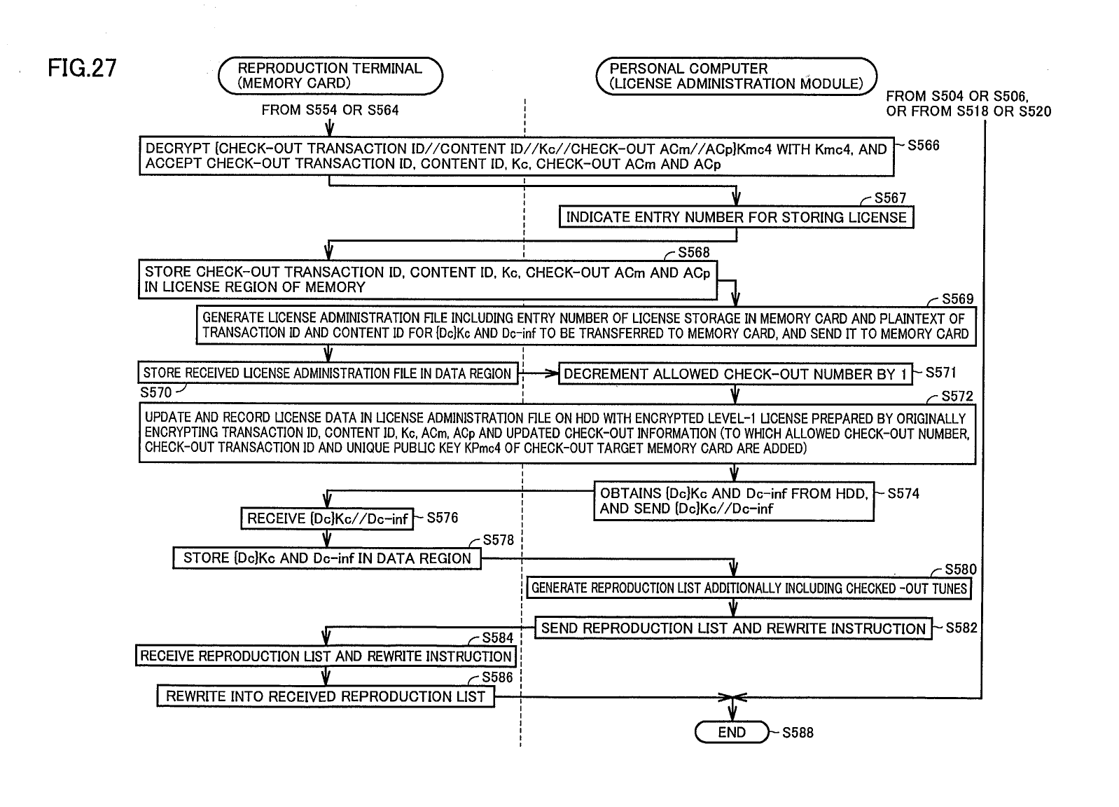

Decryption processing unit 1412 of memory card 110 receives encrypted data {{check-out transaction ID//content ID//Kc//check-out ACm//ACp}Kmc4}Ks2 via bus BS4, and decrypts it with session key Ks2 generated by session key generator 1418 for accepting encrypted data {check-out transaction ID//content ID//Kc//check-out ACm//ACp}Kmc4 (step S554). Thereafter, the operation moves to step S566 shown in FIG. 27.

If it is determined in step S548 that the certificate revocation list of license administration module 511 is newer than the other, license administration module 511 obtains certificate revocation list CRL administered by the license administration module from HDD 530 (step S556).

License administration module 511 encrypts encrypted data {checkout transaction ID//content ID//Kc//check-out ACm//ACp}Kmc4 and data CRL of the certificate revocation list obtained from HDD 530 with session key Ks2, and sends encrypted data {CRL//{check-out transaction ID//content ID//Kc//check-out ACm//ACp}Kmc4}Ks2 to reproduction terminal 102 via USB interface 550, terminal 580 and USB cable 70 (step S558). Controller 1106 of reproduction terminal 102 receives encrypted data {CRL//{check-out transaction ID//content ID//Kc//check-out ACm//ACp}Kmc4}Ks2 via terminal 1114, USB interface 1112 and bus BS3, and outputs encrypted data {CRL//{check-out transaction ID//content ID//Kc//check-out ACm//ACp}Kmc4}Ks2 thus received to memory card 110 via bus BS3 and memory card interface 1200. Thereby, controller 1420 of memory card 110 receives encrypted data {CRL//{check-out transaction ID//content ID//Kc//check-out ACm//ACp}Kmc4}Ks2 via terminal 1426, interface 1424 and bus BS4 (step S560).

In memory card 110, decryption processing unit 1412 decrypts the received data on bus BS4 with session key Ks2 applied from session key generator 1418, and accepts CRL and encrypted data {check-out transaction ID//content ID//Kc//check-out ACm//ACp}Kmc4 (step S562). Controller 1420 receives data CRL, which is accepted by decryption processing unit 1412, via bus BS4, and rewrites CRL region 1415A of memory 1415 with received data CRL (step S564).

In steps S550, S552 and S554, the operations are performed to check out license key Kc and others to memory card 110, and the check-out operations in these steps are performed in the case where certificate revocation list CRL of memory card 110 on the receiving side is newer than certificate revocation list CRL of license administration module 511 on the sending side. The operations in steps S556, 558, 560, 562 and 564 are performed for checking out license key Kc and others to memory card 110 in the case where certificate revocation list CRL of license administration module 511 on the sending side is newer than certificate revocation list CRL of memory card 110 on the receiving side. By these operations, determination is performed one by one based on update date/time CRLdate of the certificate revocation list sent from memory card 110, and the certificate revocation list CRL, which is as newer as possible, is obtained from HDD 530, and is stored in CRL region 1514A as certificate revocation list CRL of memory card 110. Thereby, it is possible to prevent provision of the license to the content reproduction circuit, of which security is broken.

After steps S554 or S564, as shown in FIG. 27, controller 1420 instructs decryption processing unit 1404 to decrypt encrypted data {checkout transaction ID//content ID//Kc//check-out ACm//ACp}Kmc4 with private decryption key Kmc4, and licenses (license key Kc, check-out transaction ID, content ID, check-out ACm and reproduction control information ACp) are accepted (step S556).

Controller 510 of personal computer 50 sends the entry number for storing the licenses, which are moved to memory card 110, to reproduction terminal 102 via USB interface 550, terminal 580 and USB cable 70 (step S567). Thereby, controller 1106 of reproduction terminal 102 receives the entry number via terminal 1114, USB interface 1112 and bus BS3, and stores the received entry number to memory card 110 via memory card interface 1200. Controller 1420 of memory card 110 receives the entry number via terminal 1426, interface 1424 and bus BS4, and stores licenses (license key Kc, check-out transaction ID, content ID, check-out ACm and reproduction control information ACp), which are obtained in step S566, in license region 1415B of memory 1415 designated by the received entry number (step S568).

Controller 510 of personal computer 50 generates the license administration file, which includes the entry number of license stored in memory 1415 of memory card 110, the plaintext of check-out transaction ID and the content ID, for encrypted content data {Dc}Kc to be moved to memory card 110 and additional information Dc-inf, and sends the license administration file thus generated to memory card 110 (step S569).

Controller 1420 of memory card 110 receives license administration file via reproduction terminal 102, and records the received license administration file in data region 1415C of memory 1415 (step S570).

License administration module 511 of personal computer 50 decrements the allowed check-out number by one (step S571), and prepares new encrypted level-1 extended license by effecting unique encryption on the transaction ID, content ID, license key Kc, access control information ACm, reproduction control information ACp and the updated check-out information (to which allowed check-out number, check-out transaction ID and unique public encryption key KPmc4 of memory card 110 of the checkout destination). With the data of the encrypted license thus produced, the license data of the license administration file recorded on HDD 530 is updated (step S572). Unique public key KPmc4 of the check-out destination is stored in an tamper resistant module of the memory card, can be obtained via a communication system using authentication and encryption to ensuring a high security level, and has a unique value independent of those of other memory cards. Therefore, unique public key KPmc4 can be suitably used as identification information for identifying the memory card.

License administration module 511 obtains encrypted content data {Dc}Kc and additional information Dc-inf, which are to be checked out to memory card 110, from HDD 530, and sends {Dc}Kc//Dc-inf to memory card 110 (step S574). Controller 1420 of memory card 110 receives {Dc}Kc//Dc-inf via reproduction terminal 102 (step S576), and records {Dc}Kc//Dc-inf, which is received via bus BS4, as the content file in data region 1415C of memory 1415 (step S578).

Thereby, license administration module 511 of personal computer 50 prepares the reproduction list additionally including the tunes (step S580), which are checked out to memory card 110, and sends the reproduction list and the instruction of rewriting the reproduction list to memory card 110 (step S582). Controller 1420 of memory card 110 receives the reproduction list and the rewriting instruction via reproduction terminal 102 (step S584), and rewrites the reproduction list file, which is recorded in data region 1415C of memory 1415, with the received reproduction list file via bus BS4 (step S586). Thereby, the check-out operation ends (step S588).

As described above, it is determined that memory card 110 attached to reproduction terminal 102 is the legal or valid device, and at the same time, it is determined that public encryption key KPm3, which can be encrypted and sent together with class certificate Cm3, is valid. After determining these facts, the content data can be checked out only based on the check-out request to the memory card having class certificate Cm3 not listed in the certificate revocation list (i.e., the memory card not mentioned in the class certificate revocation list of certificates, of which encryption with public encryption key KPm3 is broken). It is possible to inhibit the check-out to unauthorized memory card as well as the check-out using the descrambled or broken class key.

The encryption keys generated in the license administration module 511 and the memory card 110 are transmitted between them. Each of the module and the card executes the encryption with the received encryption key, and sends the encrypted data to the other so that the mutual authentication can be practically performed even when sending and receiving the encrypted data, and it is possible to improve the security in the operation of checking out the encrypted content data and the license.

By using the check-out operation described above, even the user of reproduction terminal 102 not having a function of communicating with distribution server 10 can receive the encrypted content data and the license, which are received by software of personal computer 50, in memory card 110. This improves the user convenience.

[Check-In]

In the data distribution systems shown in FIGS. 1 and 2, the encrypted content data and the license, which are checked out to memory card 110 from license administration module 511 of personal computer 50, is returned to license administration module 511. Description will now be given on this returning operation, which is referred to as the “check-in”.

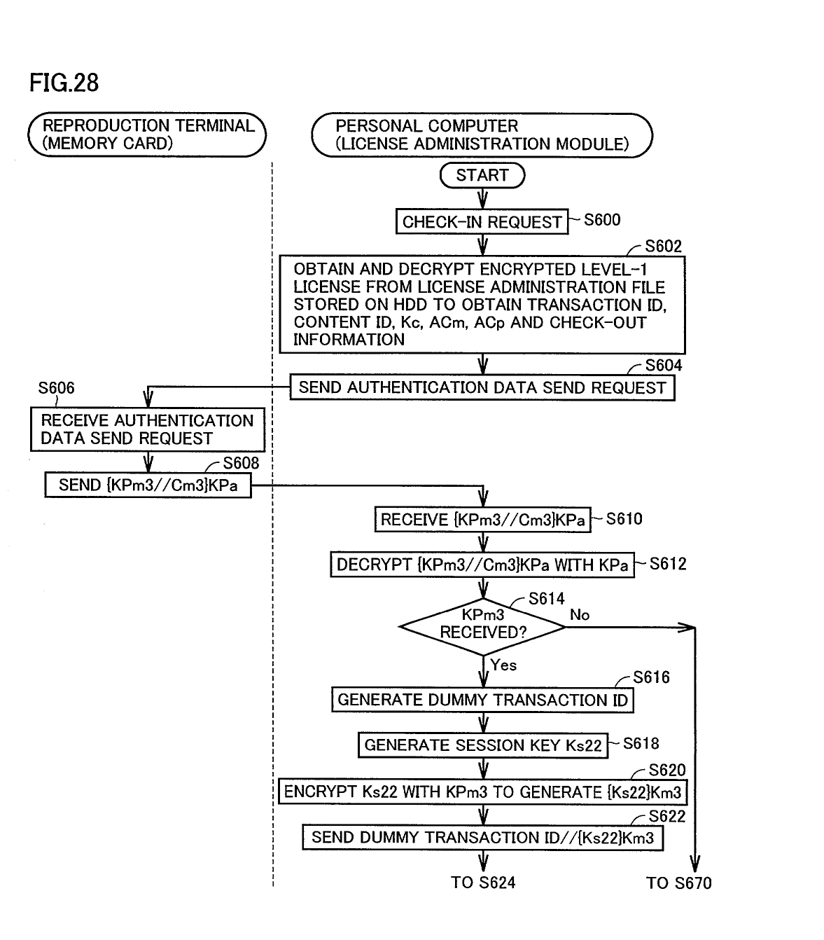

FIGS. 28-30 are first to third flowcharts showing the check-in operation for returning the encrypted content data and the license, which were given to memory card 110 by the check-out operation already described with reference to FIGS. 24-27. Cellular phone 100 and reproduction terminal 102 perform only relaying of data even in the check-in operation. Therefore, cellular phone 100 and reproduction terminal 102 are not shown in the flowcharts. Description will be given on the case where transfer is performed from memory card 110 attached to reproduction terminal 102 shown in FIG. 2. However, the transfer from memory card 110 attached to cellular phone 100 in FIG. 1 can be performed in a similar manner except for that cellular phone 100 functions instead of reproduction terminal 102.

Before the processing shown in FIG. 28, the user of personal computer 50 determines the content, which is to be checked in, in accordance with the content list file, and specifies the content file and the license administration file. The following description is based on the premise that the above operation is already performed.

Referring to FIG. 28, when the user enters the check-in request through keyboard 560 of personal computer 50 (step S600), license administration module 511 obtains the encrypted level-1 extended license data from the license administration file recorded on HDD 530, and decrypts it to obtain licenses (transaction ID, content ID, license key Kc, access control information ACm and reproduction control information ACp) and check-out information (allowed check-out number, check-out transaction ID and unique open encryption key KPmcx) (step S602). License administration module 511 sends the send request of the authentication data to reproduction terminal 102 via USB interface 550, terminal 580 and USB cable 70 (step S604). Thereby, controller 1106 of reproduction terminal 102 receives the send request for the authentication data via terminal 1114, USB interface 1112 and bus BS3, and sends the send request for the authentication data to memory card 110 via bus BS3 and memory card interface 1200. Controller 1420 of memory card 110 receives the send request for the authentication data via terminal 1426, interface 1424 and bus BS4 (step S606).

When controller 1420 receives the send request of authentication data, it reads out authentication data {KPm3//Cm3}KPa from authentication data hold unit 1400 via bus BS4, and outputs authentication data {KPm3//Cm3}KPa thus read to reproduction terminal 102 via bus BS4, interface 1424 and terminal 1426. Controller 1106 of reproduction terminal 102 receives authentication data {KPm3//Cm3}KPa via memory card interface 1200 and bus BS3, and sends authentication data {KPm3//Cm3}KPa to personal computer 50 via bus BS3, USB interface 1112, terminal 1114 and USB cable 70 (step S608).

Thereby, license administration module 511 of personal computer 50 receives authentication data {KPm3//Cm3}KPa via terminal 580 and USB interface 550 (step S610), and decrypts received authentication data {KPm3//Cm3}KPa with authentication key KPa (step S612). License administration module 511 performs the authentication processing based on the result of decryption for determining whether the decryption is performed correctly or not, and thus whether it receives or not the authentication data, which is encrypted for certifying its validity by a legal system, from the memory card 110 for authenticating the fact that memory card 110 holds legal class public encryption key KPm3 and class certificate Cm3 (step S614). If it is determined that the authentication data is valid, license administration module 511 approves and accepts class public encryption key KPm3 and class certificate Cm3. The operation moves to next processing in a step S616. If the authentication data is not valid, license administration module 511 does not approve class public encryption key KPm3 and class certificate Cm3, and the processing ends without accepting these keys (S670).

When it is authenticated that it is the legal memory card, license administration module 511 generates dummy transaction ID (step S616). The dummy transaction ID necessarily takes the value different from all the transaction IDs stored in memory card 110, and is generated as the transaction ID for local use. License administration module 511 generates session key Ks22 for check-in (step S618), and encrypts session key Ks22 thus generated with class public encryption key KPm3 sent from memory card 110 to generate encrypted data {Ks22}Km3 (step S620). License administration module 511 sends dummy transaction ID//{Ks22}Km3, which is prepared by adding dummy transaction ID to encrypted data {Ks22}Km3, to reproduction terminal 102 via USB interface 550, terminal 580 and USB cable 70 (step S622).

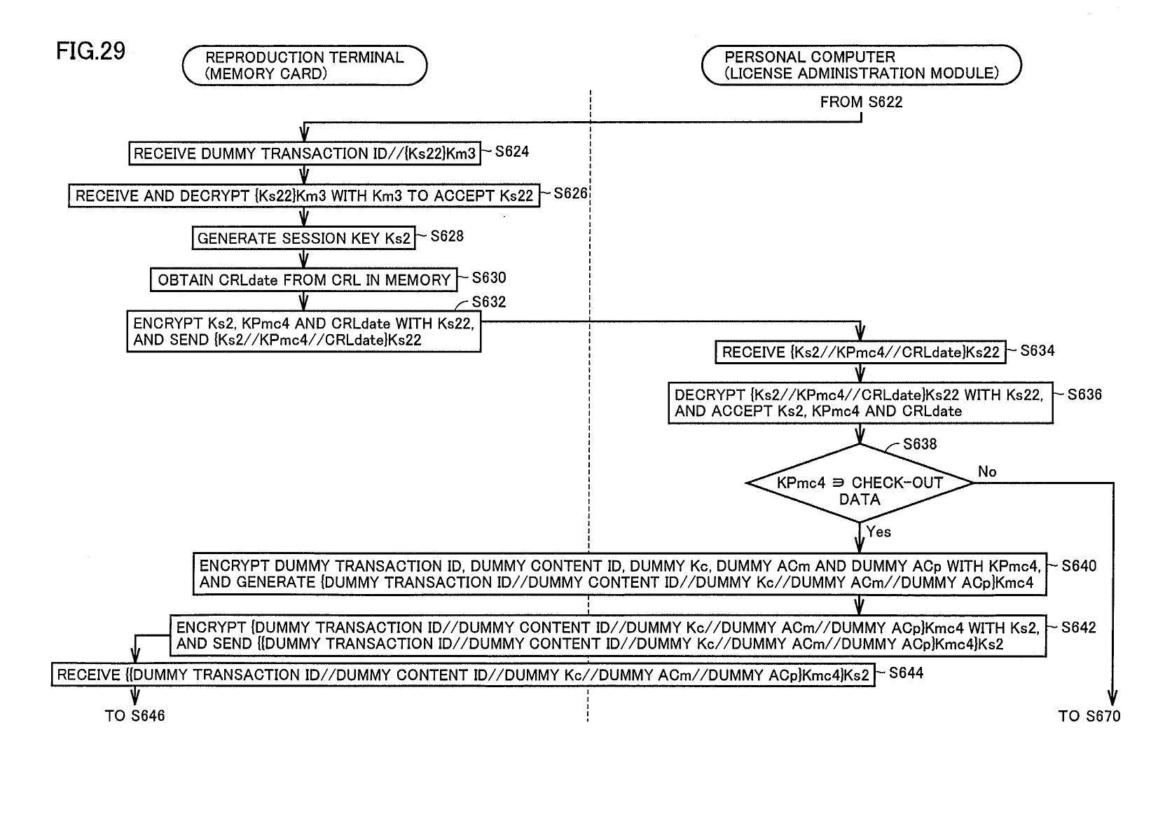

Referring FIG. 29, controller 1106 of reproduction terminal 102 receives dummy transaction ID//{Ks22}Km3 via terminal 1114, USB interface 1112 and bus BS3, and sends dummy transaction ID//{Ks22}Km3 thus received to memory card 110 via memory card interface 1200. Controller 1420 of memory card 110 receives dummy transaction ID//{Ks22}Km3 via terminal 1426, interface 1424 and bus BS4 (step S624). Decryption processing unit 1422 receives encrypted data {Ks22}Km3 from controller 1420 via bus BS4, and decrypts encrypted data {Ks22}Km3 with class private decryption key Km3 sent from Km hold unit 1421. Thereby, decryption processing unit 1422 accepts session key Ks22 (step S626). Session key generator 1418 generates session key Ks2 (step S628). Controller 1420 obtains update date/time CRLdate of the certificate revocation list from CRL region 1415A of memory 1415 via bus BS4, and applies the update date/time CRLdate thus obtained to switch 1446 (step S630).

Thereby, encryption processing unit 1406 encrypts session key Ks2, unique public encryption key KPmc4 and update date/time CRLdate, which are obtained by successively selecting the contacts of switch 1446, with session key Ks22, which is decrypted by decryption processing unit 1422 and is obtained via a contact Pa of switch 1442, to generate encrypted data {Ks2//KPmc4//CRLdate}Ks22 as one data row. Controller 1420 outputs encrypted data {Ks2//KPmc4//CRLdate}Ks22 to reproduction terminal 102 via bus BS4, interface 1424 and terminal 1426. Controller 1106 of reproduction terminal 102 receives encrypted data {Ks2//KPmc4//CRLdate}Ks22 via memory card interface 1200. Controller 1106 sends it to personal computer 50 via USB interface 1112, terminal 1114 and USB cable 70 (step S632).

License administration module 511 of personal computer 50 receives encrypted data {Ks2//KPmc4//CRLdate}Ks22 via terminal 580 and USB interface 550 (step S634), and decrypts encrypted data {Ks2//KPmc4//CRLdate}Ks22 thus received with session key Ks22. Thereby, license administration module 511 receives session key Ks2, unique public encryption key KPmc4 and update date/time CRLdate (step S636).

License administration module 511 determines whether accepted unique public encryption key KPmc4 is included in the check-out information obtained from the license administration file recorded on HDD 530, and thus whether it matches with unique public encryption key KPmcx stored corresponding to check-out transaction ID of the license to be checked in (step S638). Unique public encryption key KPmc4 is included in the check-out information, which is updated at the time of check-out of the encrypted content data and the license (see step S572 in FIG. 27). Therefore, by preparing the check-out information, which includes unique public encryption key KPmc4 corresponding to the destination of check-out such as the encrypted content data, the check-out destination can be easily specified at the time of check-in.

In step S638, if unique public encryption key KPmc4 is not included in the check-out information, the check-in operation ends (step S670). In step S638, if unique public encryption key KPmc4 is included in the checkout information, license administration module 511 encrypts dummy licenses (dummy transaction ID, dummy content ID, dummy Kc, dummy ACm and dummy ACp) including the dummy transaction ID with unique public encryption key KPmc4 to generate encrypted data {dummy transaction ID//dummy content ID//dummy Kc//dummy ACm//dummy ACp}Kmc4 (step S640).

License administration module 511 encrypts encrypted data {dummy transaction ID//dummy content ID//dummy Kc//dummy ACm//dummy ACp}Kmc4 with session key Ks2 to generate encrypted data {{dummy transaction ID//dummy content ID//dummy Kc//dummy ACm//dummy ACp}Kmc4}Ks2, and sends encrypted data {{dummy transaction ID//dummy content ID//dummy Kc//dummy ACm//dummy ACp}Kmc4}Ks2 to reproduction terminal 102 via USB interface 550, terminal 580 and USB cable 70 (step S642).

Controller 1106 of reproduction terminal 102 receives encrypted data {{dummy transaction ID//dummy content ID//dummy Kc//dummy ACm//dummy ACp}Kmc4}Ks2 via terminal 1114, USB interface 1112 and bus BS3. Controller 1106 sends encrypted data {{dummy transaction ID//dummy content ID//dummy Kc//dummy ACm//dummy ACp}Kmc4}Ks2 thus received to memory card 110 via bus BS3 and memory card interface 1200. Controller 1420 of memory card 110 receives encrypted data {{dummy transaction ID//dummy content ID//dummy Kc//dummy ACm//dummy ACp}Kmc4}Ks2 via terminal 1426, interface 1424 and bus BS4 (step S644).

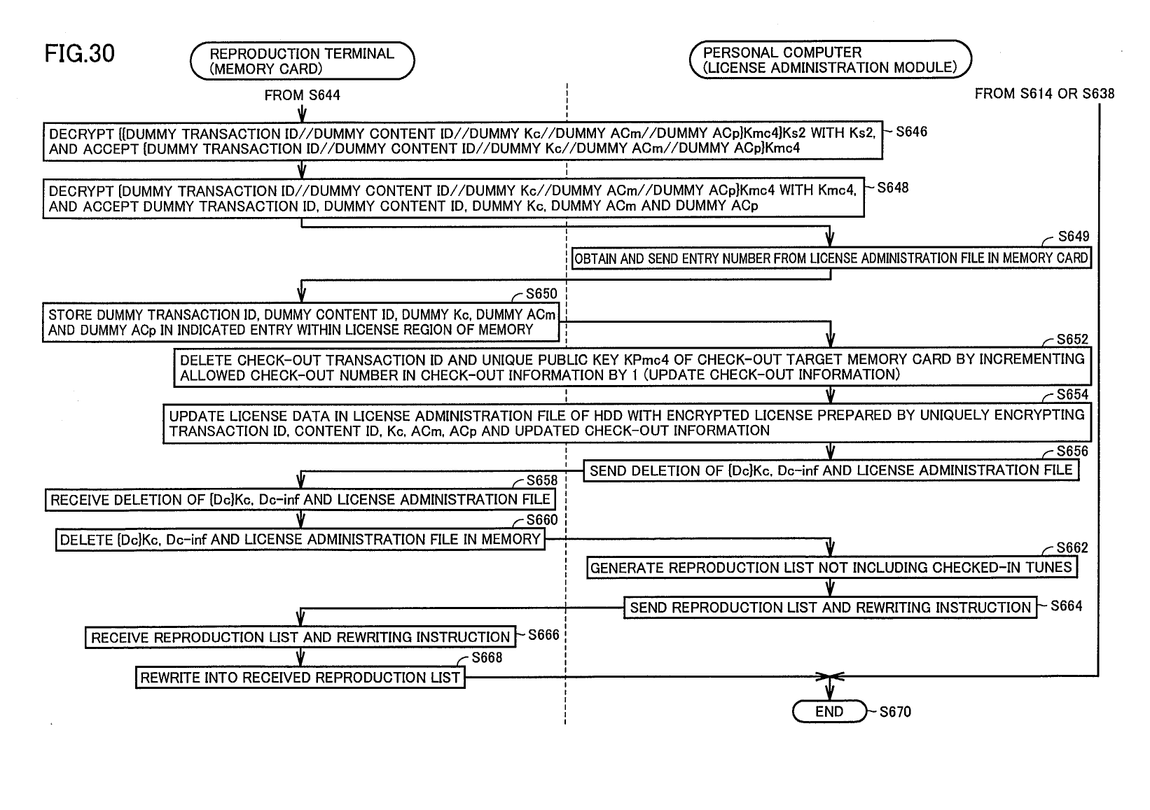

Referring to FIG. 30, decryption processing unit 1412 of memory card 110 receives encrypted data {{dummy transaction ID//dummy content ID//dummy Kc//dummy ACm//dummy ACp}Kmc4}Ks2 via bus BS4, decrypts it with session key Ks2 generated by session key generator 1418, and accepts encrypted data {dummy transaction ID//dummy content ID//dummy Kc//dummy ACm//dummy ACp}Kmc4 (step S646). Decryption processing unit 1404 receives encrypted data {dummy transaction ID//dummy content ID//dummy Kc//dummy ACm//dummy ACp}Kmc4 from decryption processing unit 1412, and decrypts encrypted data {dummy transaction ID//dummy content ID//dummy Kc//dummy ACm//dummy ACp}Kmc4 thus received with unique private decryption key Kmc4 obtained from Kmc hold unit 1402 to accept dummy licenses (dummy transaction ID, dummy content ID, dummy Kc, dummy ACm and dummy ACp) (step S648).

Controller 510 of personal computer 50 obtains entry number from the license administration file, which is recorded in data region 1415C of memory card 110 and corresponds to the license subjected to the check-out, and sends it as the entry number for storing the dummy licenses to reproduction terminal 102 via USB interface 550, terminal 580 and USB cable 70 (step S649). Thereby, controller 1106 of reproduction terminal 102 receives the entry number via terminal 1114, USB interface 1112 and bus BS3, and stores dummy licenses (dummy transaction ID, dummy content ID, dummy Kc, dummy ACm and dummy ACp), which are obtained in step S648, at the designated entry in license region 1415B of memory 1415 (step S650). By overwriting the license of the check-in target with the dummy license, the license checked out to memory card 110 can be erased.

Thereafter, license administration module 511 of personal computer 50 increments the allowed check-out number in the check-out information by one, and updates the check-out information by deleting the check-out transaction ID and the unique public encryption key KPmc4 of the memory card 110 of the check-out destination (step S652). License administration module 511 prepares new encrypted license by effecting unique encryption on the transaction ID, content ID, license key Kc, access control information ACm, reproduction control information ACp and the updated check-out information, and updates the license data in the license administration file recorded on HDD 530 (step S654).

Then, license administration module 511 sends a deletion instruction for deleting the content file (encrypted content data {Dc}Kc and additional information Dc-inf) and the license administration file for the license, which has been checked out and is recorded at data region 1415C in memory 1415 of memory card 110, to reproduction terminal 102 via USB interface 550, terminal 580 and USB cable 70 (step S656). Controller 1106 of reproduction terminal 102 receives the deletion instruction for the content file (encrypted content data {Dc}Kc and additional information Dc-inf) and the license administration file via terminal 1114, USB interface 1112 and bus BS3, and outputs the deletion instruction for the content file (encrypted content data {Dc}Kc and additional information Dc-inf) and the license administration file, which is received via bus BS3 and memory card interface 1200, to memory card 110. Thereby, controller 1420 of memory card 110 receives the deletion instruction of the content file (encrypted content data {Dc}Kc and additional information Dc-inf) and the license administration file via terminal 1426, interface 1424 and bus BS4 (step S658). Controller 1420 deletes the content file (encrypted content data {Dc}Kc and additional information Dc-inf) and the license administration file, which are recorded at data region 1415C in memory 1415 via bus BS4 (step S660).

License administration module 511 of personal computer 50 prepares the reproduction list, from which the tunes subjected to check-in are deleted (step S662), and sends the reproduction list and the instruction for rewriting the reproduction list to memory card 110 (step S664). Controller 1420 of memory card 110 receives the reproduction list file and the rewriting instruction via reproduction terminal 102 (step S662), and rewrites the reproduction list file at data region 1415C in memory 1415 with received reproduction list file via bus BS4 (step S668). Thereby, the check-in operation ends (step S670).

As described above, the encrypted content data and the license are returned from the opposite side, to which the encrypted content data and the license are checked out. Thereby, the license is given from the license administration module of the low security level, which inhibits the transfer thereto, to the memory card of the high security level, and the memory card can receive the license obtained by the license administration module of the low security level. Therefore, The reproduction terminal can reproduce the encrypted content data for the user with the license obtained by the license administration module of the low security level.

The license given to the memory card cannot be output from the memory card to another record device (memory card, license administration device or license administration module) according to specification by access control information ACm, which inhibits the output of the license subjected to check-out. Therefore, the given license does not leak. By check-in (return) of the given license administration module, the right of the given license returns to the original license administration module. Accordingly, the system described above allows neither unauthorized duplication nor the processing at a reduced security level, and can secure the copyright.

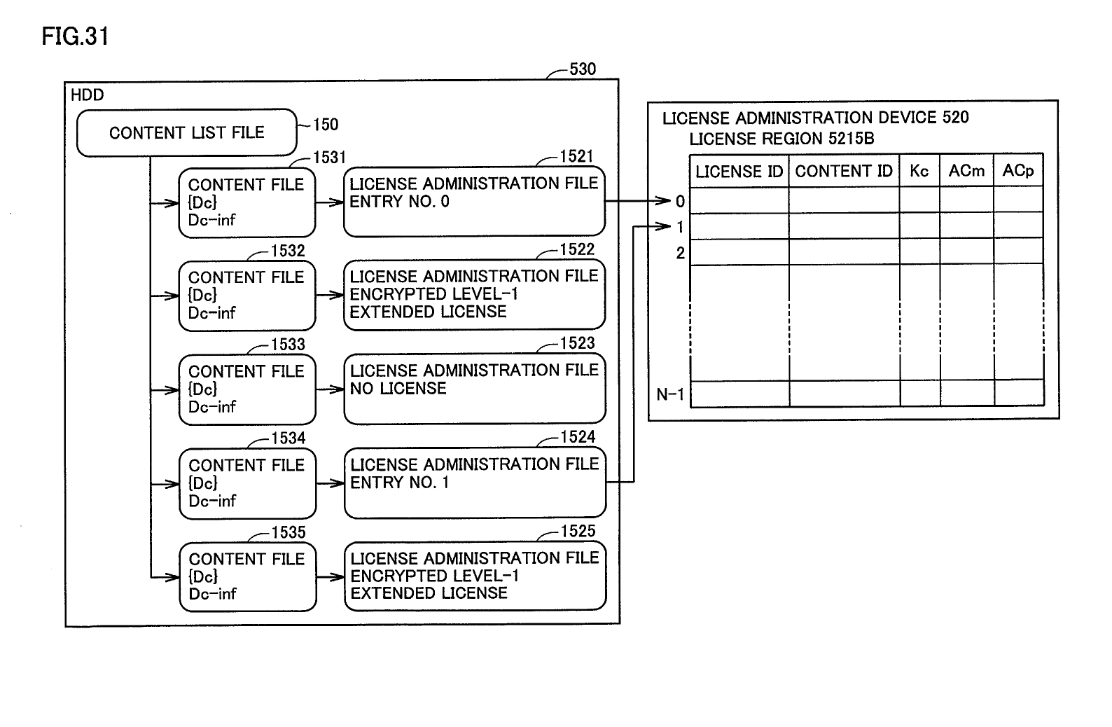

Referring to FIG. 31, description will now be given on the administration of the encrypted content data and the license received by license administration device 520 or license administration module 511 of personal computer 50. HDD 530 of personal computer 50 includes a content list file 150, content files 1531-1535 and license administration files 1521-1525.

Content list file 150 is a data file of owned contents in a list format, and includes information (e.g., title of tune and name of artist) for each content as well as information (file names) representing the content files and license administration files. Information of each content is mentioned by obtaining necessary information from additional information Dc-inf at the time of reception of the content, or is mentioned automatically or in accordance with the instruction by the user. The contents, which include only the content file or license administration file, and thus cannot be reproduced, can be administered in the list.

Content files 1531-1535 are files storing encrypted content data {Dc}Kc and additional information Dc-inf, which are received by license administration module 511 or license administration device 520, and are provided for the respective contents.

License administration files 1521-1525 are recorded corresponding to content files 1531-1535, respectively, and are employed for administering the licenses received by license administration module 511 or license administration device 520. As can be seen from the description already given, it is usually impossible to refer to the licenses, and information other that license key Kc does not cause a problem relating to copyright only if rewriting by the user is merely inhibited. However, if license key Kc and the other information were administered separately or independently of each other when operating the system, this would lower the security level. Accordingly, in the case of receiving the distributed licenses, the transaction ID and content ID, which can be referred to as information of plaintext, as well as copies of matters restricted by access control information ACm and reproduction control information ACp, which can be easily determined from license purchase conditions AC, are recorded in the form of plain text. In the case where license is recorded in administration device 520, the entry number is recorded, and, for the license administered by license administration module 511, the encrypted level-1 extended license license and transfer information) is recorded. The encrypted level-1 extended license is subjected to unique encryption by license administration module 511. The unique encryption is achieved by relating the encryption to information, which can be obtained from personal computer 50, and allows specification of personal computer 50. This information is, e.g., an individual number of the controller (CPU) of each personal computer 50 or a version number of BIOS, which is a startup program of the personal computer. Therefore, the encrypted level-1 license thus generated forms the license unique to personal computer 50, and duplication thereof is meaningless with respect to other devices. License region 5215B in memory 5215 of license administration device 520 is a record region formed of a tamper resistant region storing the license at a high security level (level 2). It includes the entries of N in number for recording the licenses license key Kc, reproduction control information ACp, access control information ACm and license ID). License administration files 1521 and 1524 include entry numbers 0 and 1, respectively. These are received by license administration device 520, are numbers for designating the administration regions of the licenses (License ID, license key Kc, access control information ACm and reproduction control information ACm) in license region 5215B of memory 5215 of license administration device 520, and are files relating to the level-2 license.

When encrypted content data of the file names recorded in content file 1531 is moved to memory card 110 attached to cellular phone 100 or reproduction terminal 102, content file 1531 can be extracted by retrieving content files 1531-1535. Thereby, the address of the license for reproducing the encrypted content data can be determined. Since license administration file 1521 corresponding to content file 1531 includes the entry number of “0”, the license for reproducing the encrypted content data of the file name recorded in content file 1531 is recorded at the region designated by the entry number “0” in license region 5215B of memory 5215 of license administration device 520. Thereby, the entry number “0” is read from license administration file 1521 of content list file 150 recorded on HDD 530, and is input to license administration device 520, whereby the license can be easily taken out from license region 5215B in memory 5215 and transferred to memory card 110. After transferring the license, the license at the designated entry number in license region 5215B of memory 5215 is erased (see steps S354 and S356) so that the “license no” is recorded in license administration file 1523 (see step S386 in FIG. 23).

License administration file 1523 includes “license no”. This results from the transfer of the license received by license administration device 520. Corresponding content file 1533 recorded on HDD 530 still remains thereon. When the license is to be transferred again from memory card 110 to license administration device 520, or to be received again from distribution server 10, only the distributed license can be received.

The license of the encrypted content data received by license administration module 511 is administered by license administration files 1522 and 1525. License administration files 1522 and 1525 includes licenses for reproducing the encrypted content data received by license administration module 511 (see step S278 in FIG. 17). Since license administration module 511 receives the encrypted content data and the license by software as described above, administration thereof is not performed by writing the license into license administration device 520, but by recording it as the file on HDD 530.

Therefore, in the case where the encrypted content data, e.g., of the file name recorded in content file 1533 is to be checked out to memory card 110 attached to reproduction terminal 102, content files 1531-1535 can be retrieved to extract content file 1533, and the check-out information, license and others can be read out from license administration file 1523 corresponding to content file 1533.

According to the invention, as described above, the encrypted content data and the license received by license administration module 511 are administered in the same format as the encrypted content data and the license received by license administration device 520. Thus, the encrypted content data and the license received at different security levels are administered in the unified format. Thereby, even in the case where the encrypted content data and the licenses are received at different security levels, the encrypted content data can be freely reproduced without lowering the respective security levels while protecting the copyrights.

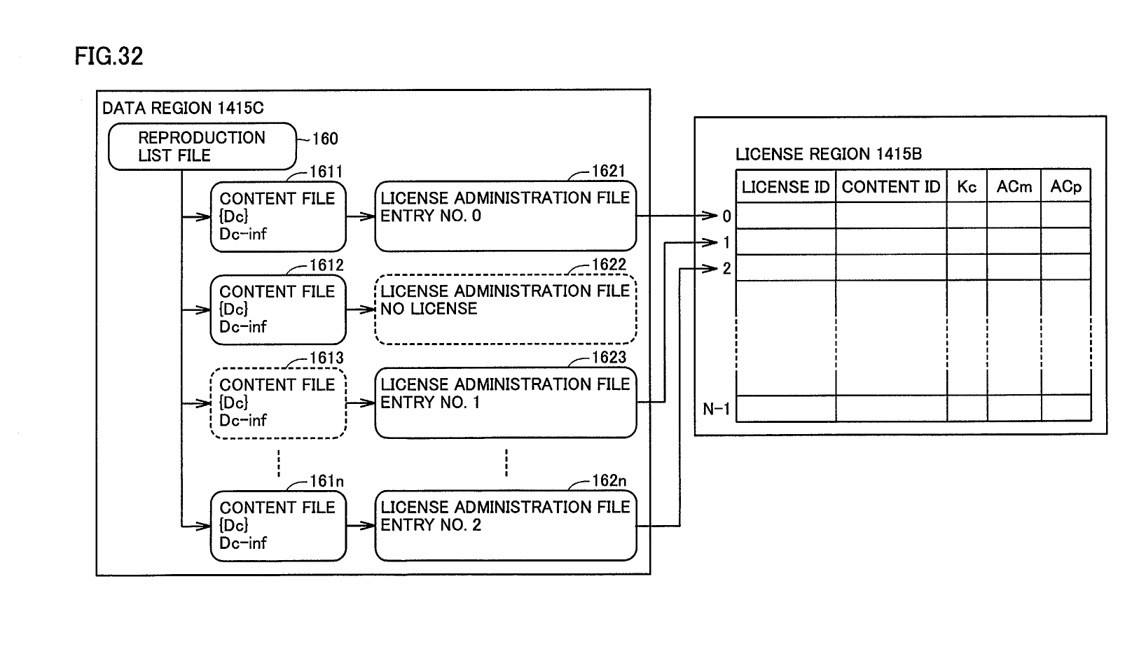

FIG. 32 shows license region 1415B and data region 1415C in memory 1415 of memory card 110. In data region 1415C, there are recorded reproduction list file 160, content files 1611-161n and license administration files 1621-162n. Each of content files 1611-161nincludes encrypted content data {Dc}Kc and additional information Dc-inf recorded as one file. License administration files 1621-162n are recorded corresponding to content files 1611-161n, respectively.

Memory card 110 records the encrypted content data and the license in memory 1415 when it receives the encrypted content data and the license from distribution server 10, or when it receives by “transfer session” or “check-out session” the encrypted content data and the license from personal computer 50. Thus, memory card 110 administers the encrypted content data and the license by hardware (meaning high security level) regardless of the security level.

Accordingly, the license with the high security level of the encrypted content data and the license with the low security level of the encrypted content data are recorded at regions designated by the entry numbers in license region 1415B of memory 1415. The license with the high security level is received by license administration device 520 of personal computer 50 and is sent to memory card 110 by the transfer session. The license with the low security level is received by license administration module 511 and is sent to memory card 110 by the check-out session. By reading the license administration file in reproduction list file 160 recorded at data region 1415C of memory 1415, these entry numbers can be obtained, and the licenses corresponding to the entry numbers thus obtained can be read from license region 1415B.

A license administration file 1622 is depicted by dotted line. This represents that the file is not actually recorded. This represents that content file 1622 is present, but the license is not present so that the reproduction is impossible. This corresponds to the case where the reproduction terminal receives only the encrypted content data from another cellular phone.

A content file 1613 is depicted by dotted line. This represents, e.g., such a case that the reproduction terminal receives the encrypted content data and the license, and sends the encrypted content data thus received only to another cellular phone, and means the fact that the license is present in memory 1415, but the encrypted content data is not present.

As described above, memory card 110 obtains the encrypted content data and the license via the three paths. Via the first path, it directly receives the encrypted content data and the license from distribution server 10. Via the second path, it receives, by transfer, the encrypted content data and the license, which are received by license administration device 520 of personal computer 50 from distribution server 10. Via third path, it receives, by check-out, the encrypted content data and the license, which are received by license administration module 511 of personal computer 50 from distribution server 10, or the encrypted content data and the license, which is obtained by ripping from music CD 60. In a manner shown in FIG. 32, memory card 110 administers the encrypted content data and the licenses, which are received via various paths. License region 1415B is formed of the tamper resistant modules of high security level, and the licenses are administered by the tamper resistant modules of high security level. Information of the licenses other than license key Kc can be read out for display from license region 1415B from the viewpoint of copyright provided that it is not rewritten by the user.

Accordingly, description will now be given on the manner, in which the licenses are read out from license region 1415B, and the information of the licenses thus read other than license key Kc is externally output from memory card 110. The following operation of reading the licenses from license region 1415B is performed in the reproduction session of the encrypted content data.

[Reproduction]

(1) Initialization Processing

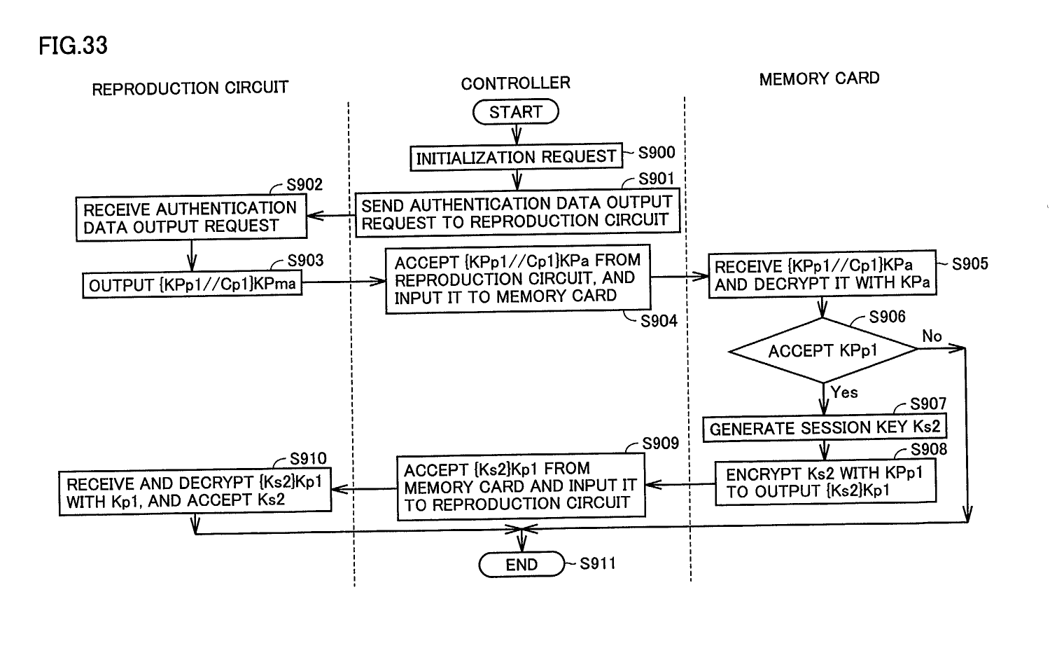

FIG. 33 is a flowchart showing an operation of initialization in the reproduction session, which is executed by reading out the encrypted content data from memory card 110 attached to cellular phone 100 shown in FIG. 1 or reproduction terminal 102 shown in FIG. 2, and reproducing the encrypted content data thus read.

Referring to FIG. 33, when the reproduction starts, the user of cellular phone 100 enters the initialization request to cellular phone 100 via a operation panel 1108 (step S900). Thereby, controller 1106 requests content reproduction circuit 1550 to output the authentication data via bus BS3, and content reproduction circuit 1550 receives the output request of the authentication data (step S902). Authentication data holding unit 1500 outputs authentication data {KPp1//Cp1}KPa (step S903), controller 1106 inputs authentication data {KPp1//Cp1}KPa to memory card 110 via memory card interface 1200 (step S904).

Thereby, memory card 110 accepts authentication data {KPp1//Cp1}KPa. Decryption processing unit 1408 decrypts accepted authentication data {KPp1//Cp1}KPa with public authentication key KPa held in KPa holding unit 1414 (step S905), and controller 1420 performs the authentication based on the result of decryption in decryption processing unit 1408. This authentication is performed for determining whether authentication data {KPp1//Cp1}KPa is the legal authentication data or not (step S906). If it cannot be decrypted, the operation moves to step S911, and the initialization ends. When the authentication data can be decrypted, controller 1420 controls session key generator 1418 to generate session key Ks2 for the reproduction session (step S907). Encryption processing unit 1410 encrypts session key Ks2 generated by session key generator 1418 with public encryption key KPp1 decrypted by decryption processing unit 1408, and outputs encrypted data {Ks2}Kp1 onto bus BS4. Thereby, controller 1420 outputs encrypted data {Ks2}Kp1 to memory card interface 1200 via interface 1424 and terminal 1426 (step S908). Controller 1106 of cellular phone 1106 obtains encrypted data {Ks2}Kp1 via memory card interface 1200. Controller 1106 applies encrypted data {Ks2}Kp1 to decryption processing unit 1504 of content reproduction circuit 1550 via bus BS3 (step S909). Decryption processing unit 1504 decrypts encrypted data {Ks2}Kp1 with private decryption key Kp1, which is paired with public encryption key KPp1 output from Kp holding unit 1502, and accepts session key Ks2 (step S910). Thereby, the initialization ends (step S911). Thus, authentication data {KPp1//Cp1} held by content reproduction circuit 1550 is authenticated in memory card 110, and content reproduction circuit 1550 accepts session key Ks2 generated in memory card 110, whereby the initialization in the reproduction operation ends.

(2) Reproduction Processing

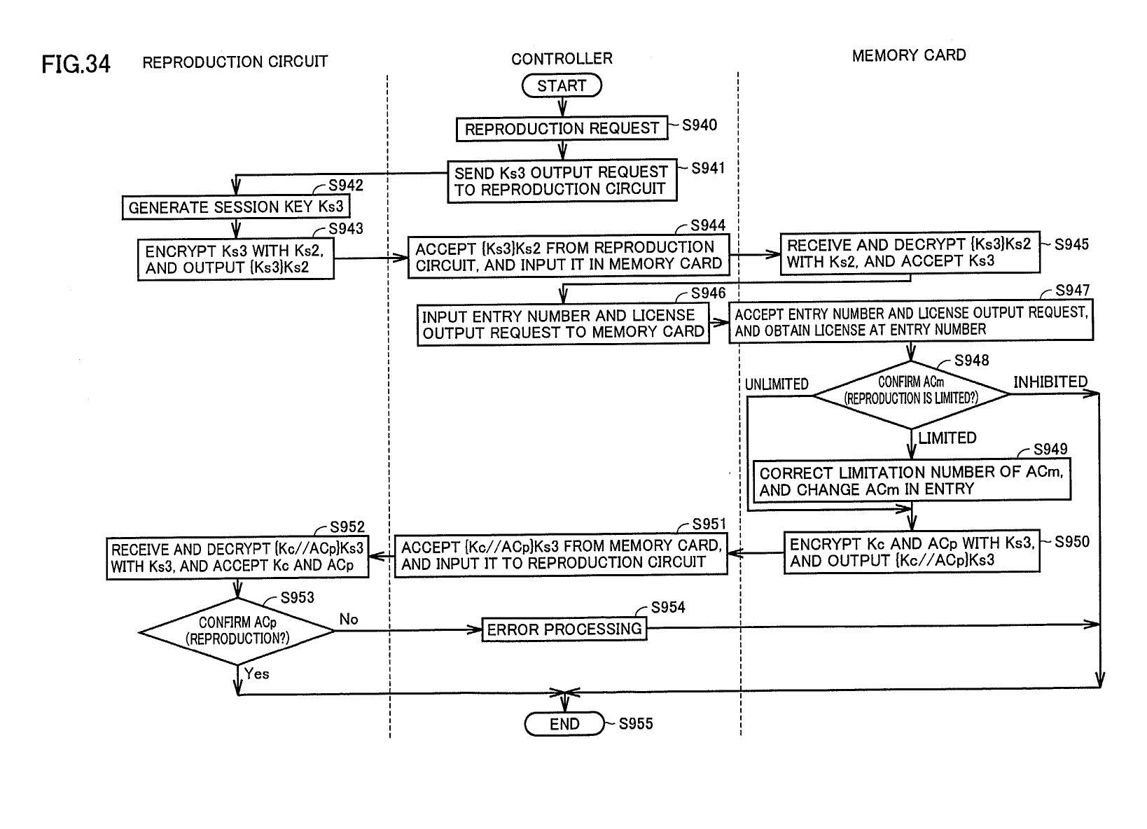

FIG. 34 is a flowchart showing a reproduction processing for decrypting the encrypted content data with the license key, and reproducing it.

Before the processing shown in FIG. 34, the user of cellular phone 100 determines the content (song or tune) to be reproduced in accordance with the reproduction list file, which is recorded at data region 1415C in memory card 110, specifies the content file and obtains the license administration file. The following description is based on the premise that the above operation is already performed.

Referring to FIG. 34, the user inputs the reproduction request through operation panel 1108 of cellular phone 100 (step S940). Thereby, controller 1106 inputs the request for outputting session key Ks3 to content reproduction circuit 1550 via bus BS3 (step S941).

Thereby, session key generator 1508 of content reproduction circuit 1550 generates session key Ks3 in accordance with the acception of session key Ks2 in step S910 shown in FIG. 33 (step S942). Decryption processing unit 1506 encrypts session key Ks3 generated by session key generator 1508 to output encrypted data {Ks3}Ks2 (step S943). Controller 1106 inputs encrypted data {Ks3}Ks2 to memory card 110 via bus BS3 and memory card interface 1200 (step S944).

Thereby, decryption processing unit 1412 of memory card 110 receives encrypted data {Ks3}Ks2 via terminal 1426, interface 1424 and bus BS4. Decryption processing unit 1412 decrypts encrypted data {Ks3}Ks2 with session key Ks2 generated by session key generator 1418, and accepts session key Ks3 generated by cellular phone 100 (step S945).

Controller 1106 of cellular phone 100 obtains the number of entry, where the license is stored, from the license administration file of the reproduction request tune obtained in advance from memory card 110 (step S946), and inputs the obtained entry number and the license output request to memory card 110 via memory card interface 1200 (step S946).

Controller 1420 of memory card 110 accepts the entry number and the license output request, and obtains the license stored at the region designated by the entry number (step S947).

Controller 1420 determines access control information ACm (step S948).

In step S948, access control information ACm, which is the information relating to the restriction on the access to memory 1415, is determined. More specifically, the number of reproduction times is determined. If reproduction is already impossible, the reproduction operation ends. If the reproduction number of access control information ACm is restricted, the reproduction number of access control information ACm is changed (step S949), and then, the processing moves to the next step (step S950). If the reproduction time of access control information ACm does not restrict the reproduction, step 949 is skipped, and the processing moves to the next step (step S950) without changing the reproduction number of access control information ACm.

If it is determined in step S948 that the reproduction can be performed in the current reproduction operation, license key Kc of the reproduction request tune and reproduction control information ACp recorded at license region 1415B in memory 1415 are output onto bus BS4 (step S950).

License key Kc and reproduction control information ACp thus obtained are sent to encryption processing unit 1406 via contact Pf of switch 1446. Encryption processing unit 1406 encrypts license key Kc and reproduction control information ACp received via switch 1446 with session key Ks3, which is received from decryption processing unit 1412 via contact Pb of switch 1442, and outputs encrypted data {Kc//ACp}Ks3 onto bus BS4 (step S950).

Encrypted data {Kc//ACp}Ks3 output onto bus BS4 is sent to cellular phone 100 via interface 1424, terminal 1426 and memory card interface 1200.

In cellular phone 100, decryption processing unit 1510 decrypts encrypted data {Kc//ACp}Ks3 transmitted onto bus BS3 via memory card interface 1200, and license key Kc and reproduction control information ACp are accepted (steps S951 and S9526). Decryption processing unit 1510 transmits license key Kc to decryption processing unit 1516, and outputs reproduction control information ACp onto bus BS3.

Controller 1106 accepts reproduction control information ACp via bus BS3, and determines whether the reproduction is allowed or not (step S953).

If it is determined in step S953 from reproduction control information ACp that the reproduction is not allowed, the reproduction operation ends (step S955) after controller 1106 performs the error processing (step S954).

If it is determined in step S953 that the reproduction is allowed, controller 1106 requests encrypted content data {Dc}Kc to memory card 110 via memory card interface 1200. Thereby, controller 1420 of memory card 110 obtains encrypted content data {Dc}Kc from memory 1415, and outputs it to memory card interface 1200 via bus BS4, interface 1424 and terminal 1426.

Controller 1106 of cellular phone 100 obtains encrypted content data {Dc}Kc via memory card interface 1200, and applies encrypted content data {Dc}Kc to content reproduction circuit 1550 via bus BS3.

Decryption processing unit 1516 of content reproduction circuit 1550 decrypts encrypted content data {Dc}Kc with license key Kc sent from decryption processing unit 1510 to obtain content data Dc.

Content data Dc thus decrypted is output to music reproduction unit 1518. Music reproduction unit 1518 reproduces content data, and D/A converter 1519 converts digital signals into analog signals, and outputs them to terminal 1530. The music data is output from terminal 1530 via the external output device to headphones 130, and is reproduced thereby. Thereby, the reproduction operation ends (step S955).

When the next tune is to be reproduced, the initialization is not required, and the operation starting from reproduction can be performed.

[License Retrieval Processing]

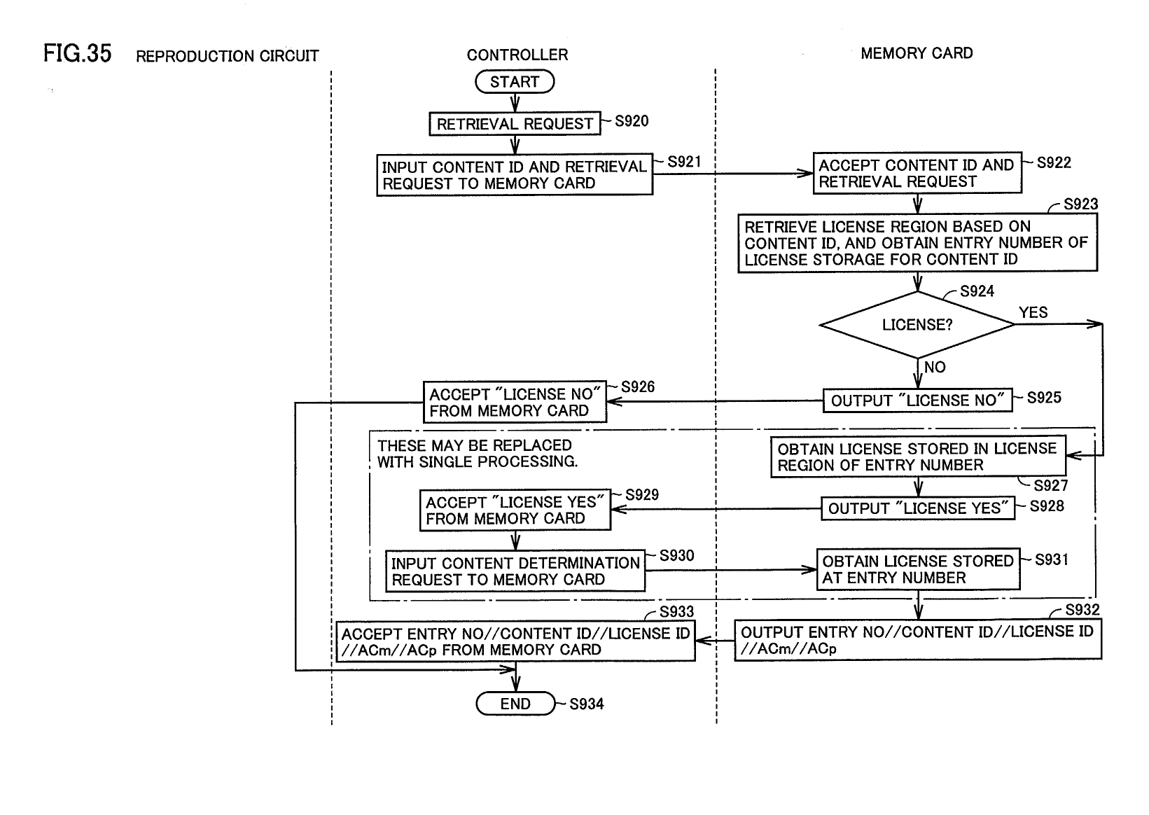

Description will now be given on the retrieval processing for the license stored at license region 1415B in memory card 110. FIG. 35 is a flowchart showing the retrieval processing for the license stored in license region 1415B.

Referring to FIG. 35, when the user enters the retrieval request for the license via operation panel 1108 of cellular phone 100 (step S920), controller 1106 reads the content ID of the encrypted content data to be reproduced from additional information Dc-inf in accordance with the license retrieval request, and inputs the content ID thus read and the license retrieval request to memory card 110 via memory card interface 1200 (step S921).

Thereby, controller 1420 of memory card 110 accepts the retrieval request for the content ID and license via terminal 1426, interface 1424 and bus BS4 (step S922). Controller 1420 retrieves the license region 1415B in memory 1415 based on the accepted content ID, and obtains the number of entry, where the license containing the accepted content ID is stored (step S923).

Thereafter, controller 1420 determines whether the license is present or not (step S924). This determination by controller 1420 is performed based on whether the entry number is read out or not. When the license is not present, controller 1420 outputs “license no” via bus BS4, interface 1424 and terminal 1426 (step S925). Controller 1106 of cellular phone 100 accepts “license no” from memory card 110 via memory card interface 1200 (step S926), and the license retrieval operation ends (step S934).

When it is determined in step S924 that the license is present, controller 1420 obtains the license stored at the region designated by the entry number obtained in step S923 (step S927). Controller 1420 outputs “license yes” via bus BS4, interface 1424 and terminal 1426 (step S928), and controller 1106 of cellular phone 100 accepts “license yes” via memory card interface 1200 (step S929).

Thereby, controller 1106 inputs the request for determining the contents of license to memory card 110 via memory card interface 1200 (step S930). Controller 1420 of memory card 110 accepts the license content determination request via terminal 1426, interface 1424 and bus BS4, and obtains the license stored at the region designated by the entry number obtained in step S923 (step S931). Thus, controller 1420 obtains again the license, which was obtained in step S927, in accordance with the entry number, and thereby determines that no error is present in the contents of the license obtained in step S927.

Controller 1420 selects the license ID, content ID, access control information ACm and reproduction time control information ACp, of which display is allowed, among the read licenses (license ID, content ID, license key Kc, access control information ACm and reproduction time control information ACp), and prepares one data row formed of the IDs and information thus selected as well as the entry number. Thereby, controller 1420 outputs entry number//content ID//license ID//ACm//ACp via bus BS4, interface 1424 and terminal 1426 (step S932). Controller 1106 of cellular phone 100 accepts entry number//content ID//license ID//ACm//ACp via memory card interface 1200 (step S933), and the license retrieval processing ends (step S934). The operations from step S927 to step S931 correspond to the processing of determining the license.

In the manners described above, it is possible to determine based on the content ID whether the license is stored at license region 1415B, and the information, of which display is allowed, within the licenses stored at license region 1415B can be obtained from license region 1415B, and can be output to cellular phone 100.

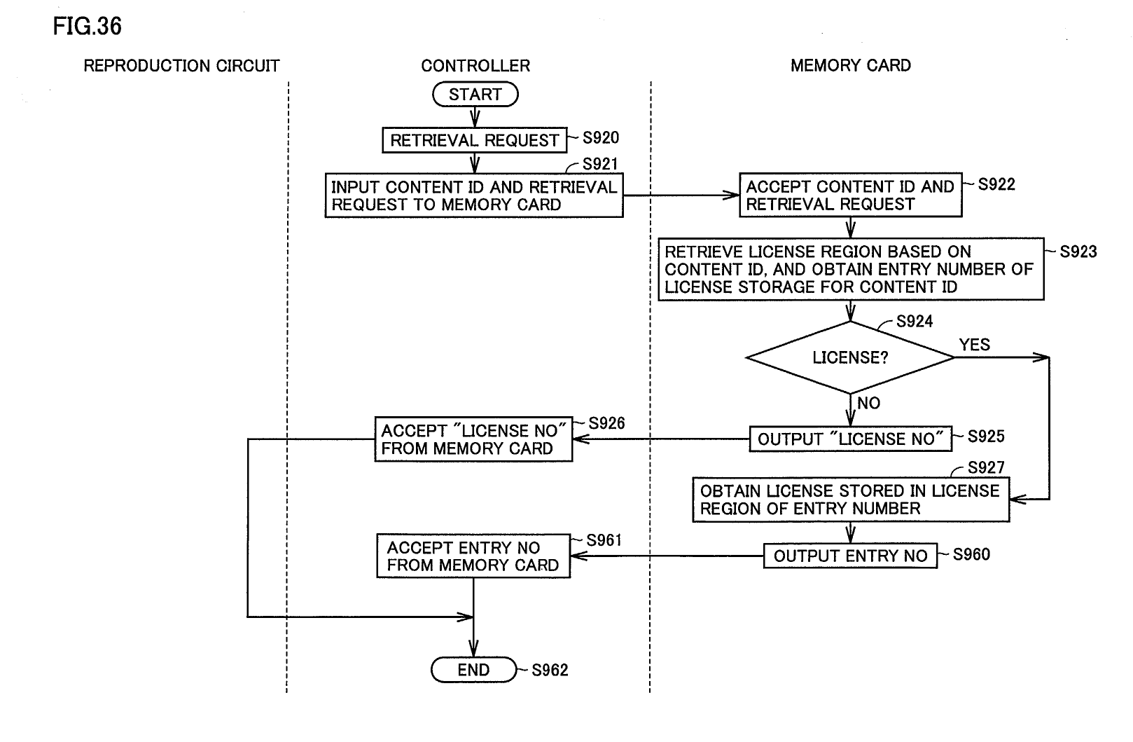

The processing of retrieving the license may be performed in accordance with a flowchart of FIG. 36. The flowchart of FIG. 36 includes steps S960-S962 instead of steps S928-S934 in the flowchart of FIG. 34.

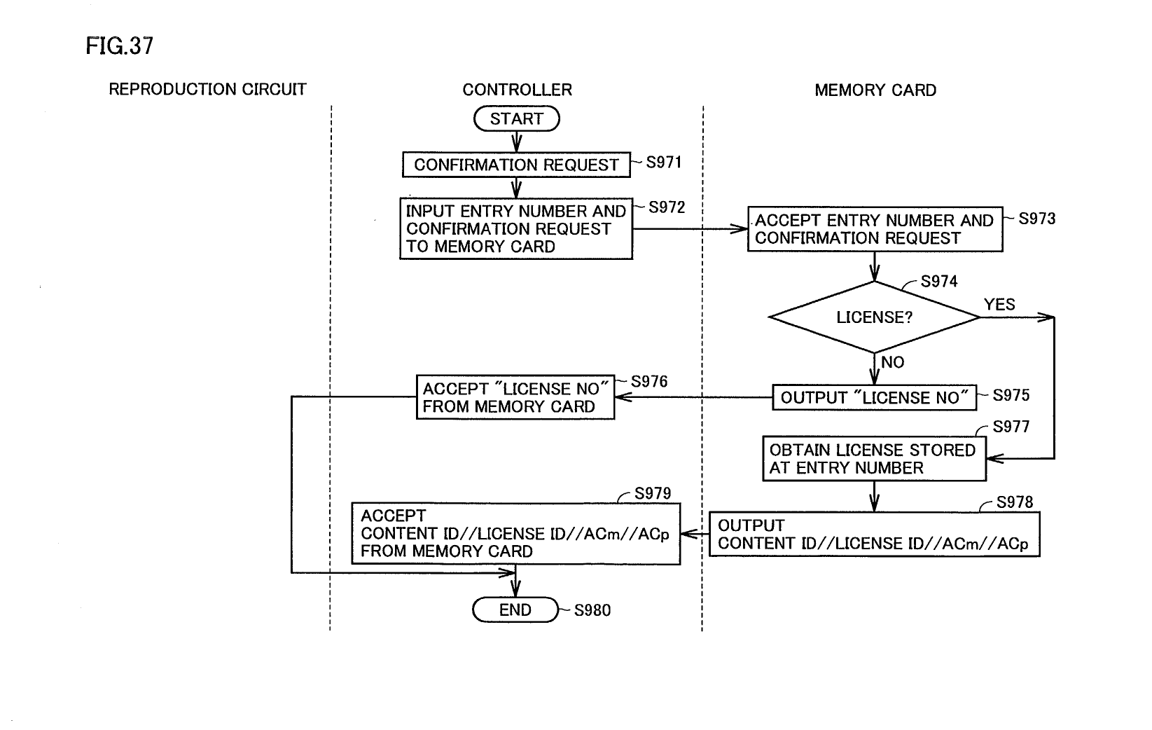

After step S927, as shown in FIG. 36, controller 1420 of memory card 110 outputs the obtained entry number via bus BS4, interface 1424 and terminal 1426 (step S960), and controller 1106 of cellular phone 100 accepts the entry number via memory card interface 1200 (step S961). Thereafter, the license retrieval processing ends (step S962). In this case, if the intended license is present in the retrieved licenses, only the number of entry, where the intended license is stores, is determined. For determining further specific contents of the license, the determination processing is performed. A flowchart of this determination processing is shown in FIG. 37.

Referring to FIG. 37, the processing of determining the license will be described below in greater detail. When the user enters the determination request for the license via operation panel 1108 of cellular phone 100 (step S971), controller 1106 inputs the entry number accepted in step S961 and the license determination request to memory card 110 via memory card interface 1200 (step S972).

Thereby, controller 1420 of memory card 110 accepts the entry number and the determination request for the license via terminal 1426, interface 1424 and bus BS4 (step S973), and determines whether the license is present or not (step S974). Thus, based on whether the entry number is accepted or not, controller 1420 determines whether the license is present or not. If the license is not present, controller 1420 outputs “license no” via bus BS4, interface 1424 and terminal 1426 (step S975). Controller 1106 of cellular phone 100 accepts the “license no” from memory card 110 via memory card interface 1200 (step S976). Thereafter, the license retrieval processing ends (step S980).

When it is determined that the license is present in step S974, controller 1420 obtains the license stored at the region designated by the entry number obtained in step S973 (step S977). Controller 1420 selects the content ID, license ID, access control information ACm and reproduction time control information ACp, of which display is allowed, among the obtained licenses license ID, content ID, license key Kc, access control information ACm and reproduction time control information ACp), and prepares one data row formed of the IDs and information thus selected. Thereby, controller 1420 outputs content ID//license ID//ACm//ACp via bus BS4, interface 1424 and terminal 1426 (step S978). Controller 1106 of cellular phone 100 accepts content ID//license ID//ACm//ACp from memory card 110 via memory card interface 1200 (step S979), and the license retrieval processing ends (step S980).

In the above manners, the entry number indicating the license storage region is output to cellular phone 100 (see step S960 in FIG. 36), whereby cellular phone 100 can detects the fact that the license is stored in license region 1415B, and the contents of license can be determined by inputting again the entry number, which was output to cellular phone 100.

By obtaining the license from license region 1415B in accordance with the flowcharts of FIGS. 34, 35 and 36, it is possible to determine the license administration information included in the license administration file, which is stored in data region 1415C.

The license administration file stored in data region 1415C may be restructured with the information other than license key Kc, which is obtained from license region 1415B in memory card 110 in accordance with the flowchart of FIG. 34, or the flowcharts of FIGS. 36 and 37. In this case, controller 1106 of cellular phone 100 generates new license administration information based on the information other than obtained license key Kc, and the new license administration information thus generated is input to memory card 110 via memory card interface 1200. Controller 1420 of memory card 110 accepts the new license administration information via terminal 1426, interface 1424 and bus BS4, and writes the accepted new license administration information into data region 1415C in memory 1415 for updating the license administration file.

By updating the license administration file for every reproduction of the encrypted content data, the license administration file can be periodically restructured even in the case where the license administration file stored in data region 1415C cannot be used due to breakage or the like.

According to the embodiments of the invention, the memory card retrieves the license stored in the license region with the content ID specifying the encrypted content data, and outputs the information other than license key Kc to the cellular phone. Therefore, the information other than the license key can be obtained from the license region even when the license administration file including the information other than the license key stored in the data region is broken.

Further, the license administration file can be restructured with the information other than the license key read from the license region.

In view of the fact that the content ID is the information obtainable from additional information Dc-inf, which is always paired with encrypted content data {Dc}Kc, similar functions can be achieved by using the license retrieval processing shown in FIG. 35 or the license retrieval processing and license determination processing shown in FIGS. 36 and 37 instead of the operation of the license administration file.

A part of information mentioned in the license administration file (e.g., access control information ACm and reproduction control information ACp) can be directly determined by the license retrieval processing shown in FIG. 35 without mentioning a copy of such information in the license administration file.

Further, the determination can be performed by the license determination processing shown in FIG. 37 only if the entry number of the license administration file is recorded.

The content ID may not be the identification information, which can uniquely specify the license, and a plurality of licenses are recorded in encrypted content data {Dc}Kc and correspond to one content ID. In this case, the retrieval processing for the license according to the flowcharts of FIGS. 35 and 36 may be modified to allow selective designation of the new retrieval or the continuous retrieval. Further, such a manner may be employed that the continuous retrieval is repeated after the new retrieval is performed to determine that there is no license, and the processing in the flowcharts of FIGS. 35 and 36 is repeated. Thereby, all the licenses corresponding to one content ID can be determined.

In connection with the operation of specifying the license, the transaction ID or license ID may be indicated instead of content ID so that the license retrieval processing can be performed.

Although description will has been given on the license retrieval processing and license determination processing. Similar functions can be achieved in license administration device 520 not provided with the data region for storing, e.g., the encrypted content data. In the flowcharts of FIGS. 35, 36 and 37, license administration device 520 and personal computer 50 operate instead of memory card 110 and cellular phone 100, respectively.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data recording device for recording a license including a license key for decrypting encrypted data and data specifying information for specifying said encrypted data at least, comprising:
a license storing unit subjected to tamper resistant processing disabling direct external access and storing the license;
an interface for external transmission; and
a control unit, wherein
said control unit obtains said data specifying information and a request for retrieving the license input via said interface, retrieves the license stored in said license storing unit based on said data specifying information, reads out the license including said data specifying information from said license storing unit, selects unconfidential information with the exception of said license key out of the read license, and externally outputs said selected information via said interface.

2. A data recording device for recording a license including a license key for decrypting encrypted at least, comprising:
a license storing unit subjected to tamper resistant processing disabling direct external access and storing said license with an entry number;
an interface for external transmission; and
a control unit, wherein
said control unit obtains an entry number and confirmation demand of the license input via said interface, reads out the license stored in a region designated by the obtained entry number, selects unconfidential information with exception of said license key out of the read license, and externally outputs said selected information via said interface.

3. The data recording device according to claim 2, wherein
said control unit retrieves the license in said license storing unit based on said data specifying information, and externally outputs the entry number corresponding to the region storing the license including said data specifying information when the license including said data specifying information is stored.

4. The data recording device according to claim 2, wherein
said control unit retrieves the license in said license storing unit based on said license specifying information, and externally outputs the entry number corresponding to the region storing the license including said license specifying information when the license including said license specifying information is stored.

5. A data recording device for recording a license including a license key for decrypting encrypted data and license specifying information for specifying said license at least, comprising:
a license storing unit subjected to tamper resistant processing disabling direct external access and storing the license;
an interface for external transmission; and
a control unit, wherein
said control unit obtains said data specifying information and a request for retrieving the license input via said interface, retrieves the license stored in said license storing unit based on said license specifying information, reads out the license including said license specifying information from said license storing unit, selects unconfidential information with the exception of said license key out of the read license, and externally outputs said selected information via said interface.

6. The data recording device according to claim 1, further comprising:
a data storing unit for storing license administration information including said encrypted data and said data specifying information.

7. The data recording device according to claim 2, further comprising:
a data storing unit for storing license administration information including said encrypted data and said data specifying information.

8. The data recording device according to claim 3, further comprising:
a data storing unit for storing license administration information including said encrypted data and said data specifying information.

9. The data recording device according to claim 4, further comprising:
a data storing unit for storing license administration information including said encrypted data.

10. The data recording device according to claim 5, further comprising:
a data storing unit for storing license administration information including said encrypted data and said data specifying information.
